(19) United States
(12) Patent Application Publication
(10) Pub. No.: US 2025/0056080 A1
(43) Pub. Date: Feb. 13, 2025

(54) CODED MULTISOURCE MEDIA FORMAT (CMMF) INSTANTIATION FOR TRANSPORT OF MEDIA DATA

(71) Applicant: QUALCOMM Incorporated, San Diego, CA (US)

(72) Inventors: Thomas Stockhammer, Bergen (DE); Imed Bouazizi, Celina, TX (US); Aytac Biber, Carlsbad, CA (US)

(21) Appl. No.: 18/796,817

(22) Filed: Aug. 7, 2024

Related U.S. Application Data
(60) Provisional application No. 63/518,302, filed on Aug. 8, 2023.

(51) Int. Cl. H04N 21/2665; H04N 21/434; H04N 21/437; H04N 21/858

(52) U.S. Cl. CPC H04N 21/2665; H04N 21/4348; H04N 21/437; H04N 21/8586

(57) ABSTRACT

An example device for retrieving media data includes a memory configured to store media data; and a processing system including a decoder implemented in circuitry, the processing system being configured to: retrieve a manifest file indicating a plurality of network locations for at least a first segment of media data and a second segment of the media data, each network location among the plurality of network locations being hosted by a separate physical server device; retrieve at least a first portion of the first segment from a first network location of the plurality of network locations; retrieve at least a second portion of the second segment from a second network location of the plurality of network locations; and provide the at least first portion of the first segment and the at least second portion of the second segment to the decoder.

This application claims the benefit of U.S. Provisional Application No. 63/518,302, filed Aug. 8, 2023, the entire contents of which are hereby incorporated by reference.

### TECHNICAL FIELD

This disclosure relates to transport of media data.

### BACKGROUND

Digital video capabilities can be incorporated into a wide range of devices, including digital televisions, digital direct broadcast systems, wireless broadcast systems, personal digital assistants (PDAs), laptop or desktop computers, digital cameras, digital recording devices, digital media players, video gaming devices, video game consoles, cellular or satellite radio telephones, video teleconferencing devices, and the like. Digital video devices implement video compression techniques, such as those described in the standards defined by MPEG-2, MPEG-4, ITU-T H.263 or ITU-T H.264/MPEG-4, Part 10, Advanced Video Coding (AVC), ITU-T H.265 (also referred to as High Efficiency Video Coding (HEVC)), and extensions of such standards, to transmit and receive digital video information more efficiently.

Video compression techniques perform spatial prediction and/or temporal prediction to reduce or remove redundancy inherent in video sequences. For block-based video coding, a video frame or slice may be partitioned into blocks. Each block can be further partitioned. Blocks in an intra-coded (I) frame or slice are encoded using spatial prediction with respect to neighboring blocks. Blocks in an inter-coded (P or B) frame or slice may use spatial prediction with respect to neighboring blocks in the same frame or slice or temporal prediction with respect to other reference frames.

After video data has been encoded, the video data may be packetized for transmission or storage. The video data may be assembled into a video file conforming to any of a variety of standards, such as the International Organization for Standardization (ISO) base media file format and extensions thereof, such as AVC.

### SUMMARY

In general, this disclosure describes techniques for streaming media data. The media data may be encapsulated according to Coded Multisource Media Format (CMMF). CMMF may include techniques for forward error correction (FEC) encoding the media data, such that repair objects can be provided in addition to base media objects, also referred to as application objects. The application objects and repair objects may be stored separately, e.g., on different physical server devices. Thus, a client device may receive an application object from one server and one or more repair objects for the application object from one or more other servers. In this manner, the techniques of this disclosure may support multi-source media streaming.

In one example, a method of retrieving media data includes: retrieving a manifest file indicating a plurality of network locations for at least a first segment of media data and a second segment of the media data, each network location among the plurality of network locations being hosted by a separate physical server device; retrieving at least a first portion of the first segment from a first network location of the plurality of network locations; retrieving at least a second portion of the second segment from a second network location of the plurality of network locations; and providing the at least first portion of the first segment and the at least second portion of the second segment to a decoder.

In another example, a device for retrieving media data includes: a memory configured to store media data; and a processing system including a decoder implemented in circuitry, the processing system being configured to: retrieve a manifest file indicating a plurality of network locations for at least a first segment of media data and a second segment of the media data, each network location among the plurality of network locations being hosted by a separate physical server device; retrieve at least a first portion of the first segment from a first network location of the plurality of network locations; retrieve at least a second portion of the second segment from a second network location of the plurality of network locations; and provide the at least first portion of the first segment and the at least second portion of the second segment to the decoder.

In another example, a method of sending media data includes: forward error correction (FEC) encoding at least a first portion of a first segment to form a first FEC encoded first portion of the first segment and at least a second portion of a second segment to form a second FEC encoded second portion of the second segment; storing the first FEC encoded first portion to a first physical server device; storing the second FEC encoded second portion to a second physical server device; and forming a manifest file indicating that the first FEC encoded first portion is available from the first physical server device and that the second FEC encoded second portion is available from the second physical server device.

In another example, a device for sending media data includes: a memory configured to store media data; and a processing system implemented in circuitry and configured to: forward error correction (FEC) encode at least a first portion of a first segment to form a first FEC encoded first portion of the first segment and at least a second portion of a second segment to form a second FEC encoded second portion of the second segment; store the first FEC encoded first portion to a first physical server device; store the second FEC encoded second portion to a second physical server device; and form a manifest file indicating that the first FEC encoded first portion is available from the first physical server device and that the second FEC encoded second portion is available from the second physical server device.

The details of one or more examples are set forth in the accompanying drawings and the description below. Other features, objects, and advantages will be apparent from the description and drawings, and from the claims.

### BRIEF DESCRIPTION OF DRAWINGS

FIG. 1 is a block diagram illustrating an example system that implements techniques for streaming media data over a network.

FIG. 2 is a block diagram illustrating an example set of components of the retrieval unit of FIG. 1 in greater detail.

FIG. 3 is a conceptual diagram illustrating elements of example multimedia content.

FIG. 4 is a block diagram illustrating elements of an example video file, which may correspond to a segment of a representation, such as one of the segments of FIG. 3.

FIG. 5 is a conceptual diagram illustrating a delivery session model for coded multisource media format (CMMF).

FIG. 6 is a conceptual diagram illustrating an example process for generating transport objects.

FIG. 7 is a conceptual diagram depicting a relationship between source and repair objects.

FIG. 8 is a conceptual diagram illustrating an example super-object generation technique.

FIG. 9 is a conceptual diagram illustrating another example technique for super-object generation.

FIG. 10 is a conceptual diagram illustrating an example CMMF delivery session including a collection of source and repair objects organized in different transport sessions.

FIG. 11 is a conceptual diagram illustrating a CMMF reference architecture.

FIG. 12 is a conceptual diagram illustrating a deployment option for which the CMMF receiver only has access to encoding transport objects via CMMF-R, based on the information in the CMMF-ETI.

FIG. 13 is a conceptual diagram illustrating a deployment option for which the CMMF sender includes several processes in order to create repair objects.

FIG. 14 is a conceptual diagram illustrating an example CMMF encoding process.

FIG. 15 is a conceptual diagram illustrating an example CMMF decoding process.

FIG. 16 is a conceptual diagram illustrating an example of a CMMF receiver and decoder for a single application object.

FIG. 17 is a conceptual diagram illustrating an example CMMF architecture.

FIG. 18 is a conceptual diagram illustrating another example CMMF architecture.

FIG. 19 is a conceptual diagram illustrating another CMMF architecture.

FIG. 20 is a conceptual diagram illustrating an example mapping between transport object identifiers (TOIs) and transport session identifiers (TSIs) and a URL or source data in a file delivery manifest.

FIG. 21 is a flow diagram illustrating an example of static operation according to techniques of this disclosure.

FIG. 22 is a flow diagram illustrating an example of dynamic operation according to techniques of this disclosure.

FIG. 23 is a conceptual diagram illustrating an example FLUTE transmission unit.

FIG. 24 is a conceptual diagram illustrating a ROUTE system including an example ROUTE reception unit and a ROUTE sender.

FIG. 25 is a conceptual diagram illustrating an example FECFRAME protocol stack.

FIGS. 26A-26C are conceptual diagrams illustrating various example FEC packets.

FIGS. 27A-27C are conceptual diagrams illustrating various example Raptor/RaptorQ code formats for FECFRAME.

FIG. 28 is a block diagram illustrating an example set of devices that may perform the techniques of this disclosure.

FIG. 29 is a flowchart illustrating an example method of sending media data according to techniques of this disclosure.

FIG. 30 is a flowchart illustrating an example method of retrieving media data according to techniques of this disclosure.

### DETAILED DESCRIPTION

In general, this disclosure describes techniques related to transporting media data encapsulated according to Coded Multisource Media Format (CMMF). CMMF is an extensible container format designed to facilitate the management and interchange of audio-visual media and metadata in one or more coded representations (encoded with forward error correction (FEC) codes). Multiple FEC codes may be supported, such as xCD-1, Raptor, RaptorQ, and/or Reed-Solomon.

CMMF allows for encoding and packaging of source data without any modification and provides redundant objects that can be jointly used with source data in order to recover the source data at a receiver, despite the receiver having received only parts of the original source data and parts of the redundant objects. This disclosure describes techniques that may be employed within a generic framework for generating repair objects based on existing FEC frameworks and provides a specification for repair object formats, as well as external transport information that is needed by the receiver in order to recover the source object.

CMMF may enable efficient use of multisource, multipath, and/or multi-access connectivity for network or cloud-powered processing and playback applications. CMMF may support signaling and encapsulation of metadata such as: coding type, media information, integrity information, encoder universally unique identifier (UUID), time, or the like.

A media bitstream including media data encapsulated according to CMMF may act as a standard encapsulation format, such that a single container format can be used for a wide variety of content and use cases. For example, this container format may be used to encapsulate still image (picture) data, video data, audio data, and/or extended reality (XR) data, such as augmented reality (AR), mixed reality (MR), and/or virtual reality (VR) data.

CMMF provides a generic container format that supports multimedia (e.g., video and audio streaming, broadcast, XR, video conferencing, and online gaming) delivery through coding the underlying content. This format supports multiple types of codes (including xCD-1, RaptorQ, and Reed-Solomon) and can be optimized for a range of networks and use cases. CMMF supports efficient decentralized multi-source and multi-path content delivery for use cases such as audio and video streaming that require high availability/robustness but also have strict latency and bandwidth constraints. CMMF is designed to operate with existing and future streaming (e.g., HTTP Live Streaming (HLS), MPEG-DASH (Dynamic Adaptive Streaming over HTTP), CMAF, etc.) and network protocols (e.g., HTTP, TCP, UDP, WebRTC, etc.) providing a flexible and extensible framework for managing the delivery of encoded multimedia content.

Standardizing the container format, rather than the code type, enables cooperation within the industry by creating a common interchange format for the distribution and delivery of encoded content. This allows Service Providers (e.g., Mobile Network Operators or media platforms) to distribute media in an encoded format that can be interpreted and decoded by their partners.

CMMF may be used to support multipath audio/video streaming, ultra-low latency XR gaming/teleconferencing, or other such use cases. CMMF streaming may be provided over transmission control protocol (TCP), uniform datagram protocol (UDP), or Web Real-Time Communication Protocol (WebRTC), among other network protocols.

CMMF may be used with transmission frameworks such as File Delivery over Unidirectional Transport (FLUTE), described in T. Paila et al., “FLUTE-File Delivery over Unidirectional Transport,” Network Working Group, RFC 6726, November 2012, available at www.rfc-editor.org/rfc/rfc6726, Real-Time Transport Object Delivery over Unidirectional Transport (ROUTE), described in Zia et al., “Real-Time Transport Object Delivery over Unidirectional Transport (ROUTE),” RFC 9223, April 2022, available at www.rfc-editor.org/rfc/rfc9223, and/or FECFRAME, described in Watson et al., “Raptor Forward Error Correction (FEC) Schemes for FECFRAME,” Internet Engineering Task Force (IETF), RFC 6681, August 2012, available at www.rfc-editor.org/rfc/rfc6681. Network transmission of media data encapsulated according to CMMF may be performed using one or more service layers, such as Multimedia Broadcast Multicast Service (MBMS) or eMBMS Service Layer, Group Communication, 5G Broadcast, ATSC Service Layer, DVB-I Service Layer, or Dynamic Adaptive Streaming over HTTP (DASH). These technologies have been developed based on substantial research. They have been diligently tested and standardized by appropriate standards organizations, such as IETF, 3GPP, ETSI, MPEG, DVB, ATSC, and DASH-IF. For many of these technologies, both open source and proprietary implementations exist.

In the context of CMMF, terms related to media coding, encapsulation, and transport include the following:
Bitstream: A sequence of bits.
Block: A unit of data on which a block-based code is applied.
   In general, coding operations (encoding and decoding) on one block are independent of all coding operations on another block.
Block Coding: Coding technique where the input is first be segmented into a sequence of blocks, or chunks; then encoding and decoding are performed independently on a per-block basis.
Block Size: Number of Source Symbols belonging to a Block.
Byte: 8 bits
Channel: Generic term for any type of communication technology.
   Examples: An Ethernet link, a WiFi network, or a full path between two nodes within a network.
Code Rate: The Code Rate is the ratio between the number of Source Symbols, and the number of Source plus Coded or Repair Symbols.
   The Code Rate may be greater than zero, less than or equal to one. In CMMF, a Code Rate close to one indicates that a small number of Coded or Repair Symbols have been produced during the encoding process, while a Code Rate close to zero indicates a large number of Coded or Repair Symbols.
Coded Symbol, Encoded Symbol, or Repair Symbol: Unit of data that is the result of a coding operation.
Coding or Encoding: Operation that takes Source Symbols as input and produces Coded Symbols as output.
Coding Coefficient: A coefficient chosen from the same Finite Field encoding and decoding operations are performed over. Methods of choosing this coefficient may include: randomly (e.g., LT codes), in a predefined table (e.g., Reed-Solomon, etc.), or using a predefined algorithm plus a seed (e.g., LDPC, RaptorQ, etc.).
Coding Matrix, Generator Matrix, or Coefficient Matrix: Matrix (G) that transforms the set of Input Symbols (X) into a set of Coded or Repair Symbols (Y): Y=X·G. Defining a Generator Matrix is typical with Block Codes. The set of Input Symbols X can consist only of Source Symbols.
Coding Vector or Coefficient Vector: Set of Coding Coefficients used to generate a certain Coded or Repair Symbol through Linear Coding.
   The number of nonzero coefficients in the Coding Vector defines its density.
Decoding: Operation that takes Coded Symbols as input and produces Source Symbols as output.
Encoding: Operation that takes Source Symbols as input and produces Coded Symbols as output.
Encoding Block: see Block.
Encoding Symbol: see Coded Symbol.
Encoding Window or Coding Window: Set of Source Symbols used as input to the coding operations.
   The set of symbols may change over time, as the Coding Window slides over the input Flow.
Encoding Window Size or Coding Window Size: Number of Source Symbols in the current Encoding Window.
   This size may change over the time.
Erasure: Drop or loss of information along a communication path.
Erasure Channel: Communication path where information is either dropped or received without any error.
Finite Field, Galois Field, or Coding Field: Finite Fields, used in Linear Codes, have the desired property of having all elements (except zero) invertible for the + and × operators, and all operations over any elements do not result in an overflow or underflow.
Finite Field Size or Coding Field Size: Number of elements in a Finite Field.
   Example: The binary extension field {0 . . . 2m 1} may have size q=2m.
Flow or Stream: Stream of information (or packets) that are logically grouped.
Input or Source Symbol: Unit of data that is an input to an encoding operation or an output of a decoding operation.
Linear Coding: A process in which a linear combination of a set of source symbols is generated using a given set of coefficients and resulting in a Coded Symbol or Repair Symbol.
Multipath Coding: Coding that enables transmission over multiple routes that have multiple (at least partially) disjoint paths from the source to each given destination.
Multisource Coding: Coding that enables transmission from multiple sources over (at least partially) disjoint paths to each given destination.
Network: Interconnected set of nodes that communicate over a collection of links or channels.
Node: Point of connection in a communication network
Output Symbol: see Coded Symbol
Packet: Unit of data that is sent over a network
Rank or Encoding Rank: Number of linearly independent linearly encoded symbols, or equivalently the number of linearly independent equations of the linear system.
Repair Flow: Flow containing Repair Packets after FEC encoding.
Single-Path Coding: Coding over a route that has a single path from the source to each destination(s). In case of multicast or broadcast traffic, this route is a tree.
Sliding Window Coding: Coding technique that generates Coded or Repair Symbol(s) on the fly, from the set of Source Symbols present in the sliding encoding window at that time. The sliding window may be either of fixed size (Fixed Sliding Window), or of variable size over time (Elastic Sliding Window).
Sliding Window Size, Encoding Window Size, or Coding Window Size: Number of Symbols in the current Window. This size may change over the time.
Source Coding: Process of removing redundant and/or (perceptually) irrelevant information from an information source, i.e., compression of data or media (audio, video).
Source Data, Source File, or Original Data: A unit of data that may be partitioned into blocks where each block is an input to an encoding operation.
Source Flow: Flow of Source information to which coding is to be applied, potentially along with other Source Flows.
Source Node: Node that generates one or more Source Flows.
Source Symbol, Information Symbol, Systematic Symbol: Unit of data originating from the source that is used as input to encoding operations.
Symbol: Unit of data that is manipulated during encoding and decoding operations.
Symbol Size: The size of each symbol on which encode and decode operations are performed.
Systematic Coding: Coding technique where Source Symbols are part of the output Flow generated by an encoder.

The techniques of this disclosure may be applied to video files conforming to video data encapsulated according to any of ISO base media file format, Scalable Video Coding (SVC) file format, Advanced Video Coding (AVC) file format, Third Generation Partnership Project (3GPP) file format, and/or Multiview Video Coding (MVC) file format, or other similar video file formats.

In HTTP streaming, such as Dynamic Adaptive Streaming over HTTP (DASH), frequently used operations include HEAD, GET, and partial GET. The HEAD operation retrieves a header of a file associated with a given uniform resource locator (URL) or uniform resource name (URN), without retrieving a payload associated with the URL or URN. The GET operation retrieves a whole file associated with a given URL or URN. The partial GET operation receives a byte range as an input parameter and retrieves a continuous number of bytes of a file, where the number of bytes correspond to the received byte range. Thus, movie fragments may be provided for HTTP streaming, because a partial GET operation can get one or more individual movie fragments. In a movie fragment, there can be several track fragments of different tracks. In HTTP streaming, a media presentation may be a structured collection of data that is accessible to the client. The client may request and download media data information to present a streaming service to a user.

In the example of streaming 3GPP data using HTTP streaming, there may be multiple representations for video and/or audio data of multimedia content. As explained below, different representations may correspond to different coding characteristics (e.g., different profiles or levels of a video coding standard), different coding standards or extensions of coding standards (such as multiview and/or scalable extensions), or different bitrates. The manifest of such representations may be defined in a Media Presentation Description (MPD) data structure. A media presentation may correspond to a structured collection of data that is accessible to an HTTP streaming client device. The HTTP streaming client device may request and download media data information to present a streaming service to a user of the client device. A media presentation may be described in the MPD data structure, which may include updates of the MPD.

A media presentation may contain a sequence of one or more Periods. Each period may extend until the start of the next Period, or until the end of the media presentation, in the case of the last period. Each period may contain one or more representations for the same media content. A representation may be one of a number of alternative encoded versions of audio, video, timed text, or other such data. The representations may differ by encoding types, e.g., by bitrate, resolution, and/or codec for video data and bitrate, language, and/or codec for audio data. The term representation may be used to refer to a section of encoded audio or video data corresponding to a particular period of the multimedia content and encoded in a particular way.

Representations of a particular period may be assigned to a group indicated by an attribute in the MPD indicative of an adaptation set to which the representations belong. Representations in the same adaptation set are generally considered alternatives to each other, in that a client device can dynamically and seamlessly switch between these representations, e.g., to perform bandwidth adaptation. For example, each representation of video data for a particular period may be assigned to the same adaptation set, such that any of the representations may be selected for decoding to present media data, such as video data or audio data, of the multimedia content for the corresponding period. The media content within one period may be represented by either one representation from group 0, if present, or the combination of at most one representation from each non-zero group, in some examples. Timing data for each representation of a period may be expressed relative to the start time of the period.

A representation may include one or more segments. Each representation may include an initialization segment, or each segment of a representation may be self-initializing. When present, the initialization segment may contain initialization information for accessing the representation. In general, the initialization segment does not contain media data. A segment may be uniquely referenced by an identifier, such as a uniform resource locator (URL), uniform resource name (URN), or uniform resource identifier (URI). The MPD may provide the identifiers for each segment. In some examples, the MPD may also provide byte ranges in the form of a range attribute, which may correspond to the data for a segment within a file accessible by the URL, URN, or URI.

Different representations may be selected for substantially simultaneous retrieval for different types of media data. For example, a client device may select an audio representation, a video representation, and a timed text representation from which to retrieve segments. In some examples, the client device may select particular adaptation sets for performing bandwidth adaptation. That is, the client device may select an adaptation set including video representations, an adaptation set including audio representations, and/or an adaptation set including timed text. Alternatively, the client device may select adaptation sets for certain types of media (e.g., video), and directly select representations for other types of media (e.g., audio and/or timed text).

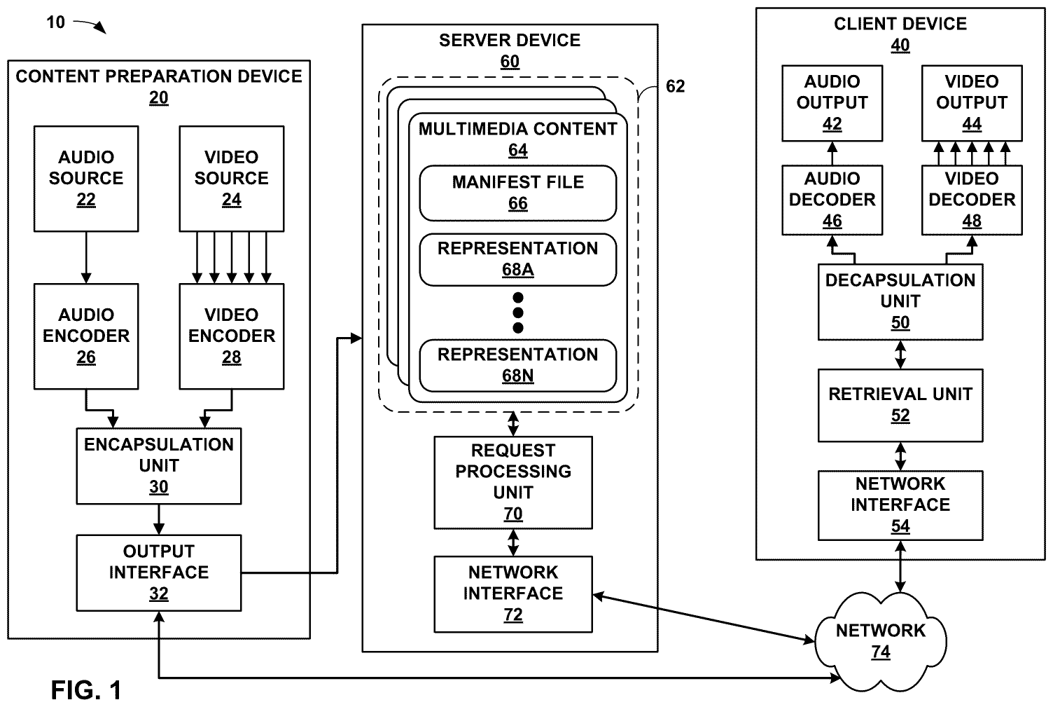

FIG. 1 is a block diagram illustrating an example system 10 that implements techniques for streaming media data over a network. In this example, system 10 includes content preparation device 20, server device 60, and client device 40. Client device 40 and server device 60 are communicatively coupled by network 74, which may comprise the Internet. In some examples, content preparation device 20 and server device 60 may also be coupled by network 74 or another network, or may be directly communicatively coupled. In some examples, content preparation device 20 and server device 60 may comprise the same device.

Content preparation device 20, in the example of FIG. 1, comprises audio source 22 and video source 24. Audio source 22 may comprise, for example, a microphone that produces electrical signals representative of captured audio data to be encoded by audio encoder 26. Alternatively, audio source 22 may comprise a storage medium storing previously recorded audio data, an audio data generator such as a computerized synthesizer, or any other source of audio data. Video source 24 may comprise a video camera that produces video data to be encoded by video encoder 28, a storage medium encoded with previously recorded video data, a video data generation unit such as a computer graphics source, or any other source of video data. Content preparation device 20 is not necessarily communicatively coupled to server device 60 in all examples, but may store multimedia content to a separate medium that is read by server device 60.

Raw audio and video data may comprise analog or digital data. Analog data may be digitized before being encoded by audio encoder 26 and/or video encoder 28. Audio source 22 may obtain audio data from a speaking participant while the speaking participant is speaking, and video source 24 may simultaneously obtain video data of the speaking participant. In other examples, audio source 22 may comprise a computer-readable storage medium comprising stored audio data, and video source 24 may comprise a computer-readable storage medium comprising stored video data. In this manner, the techniques described in this disclosure may be applied to live, streaming, real-time audio and video data or to archived, pre-recorded audio and video data.

Audio frames that correspond to video frames are generally audio frames containing audio data that was captured (or generated) by audio source 22 contemporaneously with video data captured (or generated) by video source 24 that is contained within the video frames. For example, while a speaking participant generally produces audio data by speaking, audio source 22 captures the audio data, and video source 24 captures video data of the speaking participant at the same time, that is, while audio source 22 is capturing the audio data. Hence, an audio frame may temporally correspond to one or more particular video frames. Accordingly, an audio frame corresponding to a video frame generally corresponds to a situation in which audio data and video data were captured at the same time and for which an audio frame and a video frame comprise, respectively, the audio data and the video data that was captured at the same time.

In some examples, audio encoder 26 may encode a timestamp in each encoded audio frame that represents a time at which the audio data for the encoded audio frame was recorded, and similarly, video encoder 28 may encode a timestamp in each encoded video frame that represents a time at which the video data for an encoded video frame was recorded. In such examples, an audio frame corresponding to a video frame may comprise an audio frame comprising a timestamp and a video frame comprising the same timestamp. Content preparation device 20 may include an internal clock from which audio encoder 26 and/or video encoder 28 may generate the timestamps, or that audio source 22 and video source 24 may use to associate audio and video data, respectively, with a timestamp.

In some examples, audio source 22 may send data to audio encoder 26 corresponding to a time at which audio data was recorded, and video source 24 may send data to video encoder 28 corresponding to a time at which video data was recorded. In some examples, audio encoder 26 may encode a sequence identifier in encoded audio data to indicate a relative temporal ordering of encoded audio data but without necessarily indicating an absolute time at which the audio data was recorded, and similarly, video encoder 28 may also use sequence identifiers to indicate a relative temporal ordering of encoded video data. Similarly, in some examples, a sequence identifier may be mapped or otherwise correlated with a timestamp.

Audio encoder 26 generally produces a stream of encoded audio data, while video encoder 28 produces a stream of encoded video data. Each individual stream of data (whether audio or video) may be referred to as an elementary stream. An elementary stream is a single, digitally coded (possibly compressed) component of a representation. For example, the coded video or audio part of the representation can be an elementary stream. An elementary stream may be converted into a packetized elementary stream (PES) before being encapsulated within a video file. Within the same representation, a stream ID may be used to distinguish the PES-packets belonging to one elementary stream from the other. The basic unit of data of an elementary stream is a packetized elementary stream (PES) packet. Thus, coded video data generally corresponds to elementary video streams. Similarly, audio data corresponds to one or more respective elementary streams.

Many video coding standards, such as ITU-T H.264/AVC and the upcoming High Efficiency Video Coding (HEVC) standard, define the syntax, semantics, and decoding process for error-free bitstreams, any of which conform to a certain profile or level. Video coding standards typically do not specify the encoder, but the encoder is tasked with guaranteeing that the generated bitstreams are standard-compliant for a decoder. In the context of video coding standards, a “profile” corresponds to a subset of algorithms, features, or tools and constraints that apply to them. As defined by the H.264 standard, for example, a “profile” is a subset of the entire bitstream syntax that is specified by the H.264 standard. A “level” corresponds to the limitations of the decoder resource consumption, such as, for example, decoder memory and computation, which are related to the resolution of the pictures, bit rate, and block processing rate. A profile may be signaled with a profile_idc (profile indicator) value, while a level may be signaled with a level_idc (level indicator) value.

The H.264 standard, for example, recognizes that, within the bounds imposed by the syntax of a given profile, it is still possible to require a large variation in the performance of encoders and decoders depending upon the values taken by syntax elements in the bitstream such as the specified size of the decoded pictures. The H.264 standard further recognizes that, in many applications, it is neither practical nor economical to implement a decoder capable of dealing with all hypothetical uses of the syntax within a particular profile. Accordingly, the H.264 standard defines a “level” as a specified set of constraints imposed on values of the syntax elements in the bitstream. These constraints may be simple limits on values. Alternatively, these constraints may take the form of constraints on arithmetic combinations of values (e.g., picture width multiplied by picture height multiplied by number of pictures decoded per second). The H.264 standard further provides that individual implementations may support a different level for each supported profile.

A decoder conforming to a profile ordinarily supports all the features defined in the profile. For example, as a coding feature, B-picture coding is not supported in the baseline profile of H.264/AVC but is supported in other profiles of H.264/AVC. A decoder conforming to a level should be capable of decoding any bitstream that does not require resources beyond the limitations defined in the level. Definitions of profiles and levels may be helpful for interpretability. For example, during video transmission, a pair of profile and level definitions may be negotiated and agreed for a whole transmission session. More specifically, in H.264/AVC, a level may define limitations on the number of blocks that need to be processed, decoded picture buffer (DPB) size, coded picture buffer (CPB) size, vertical motion vector range, maximum number of motion vectors per two consecutive MBs, and whether a B-block can have sub-block partitions less than 8×8 pixels. In this manner, a decoder may determine whether the decoder is capable of properly decoding the bitstream.

In the example of FIG. 1, encapsulation unit 30 of content preparation device 20 receives elementary streams comprising coded video data from video encoder 28 and elementary streams comprising coded audio data from audio encoder 26. In some examples, video encoder 28 and audio encoder 26 may each include packetizers for forming PES packets from encoded data. In other examples, video encoder 28 and audio encoder 26 may each interface with respective packetizers for forming PES packets from encoded data. In still other examples, encapsulation unit 30 may include packetizers for forming PES packets from encoded audio and video data.

Video encoder 28 may encode video data of multimedia content in a variety of ways, to produce different representations of the multimedia content at various bitrates and with various characteristics, such as pixel resolutions, frame rates, conformance to various coding standards, conformance to various profiles and/or levels of profiles for various coding standards, representations having one or multiple views (e.g., for two-dimensional or three-dimensional playback), or other such characteristics. A representation, as used in this disclosure, may comprise one of audio data, video data, text data (e.g., for closed captions), or other such data. The representation may include an elementary stream, such as an audio elementary stream or a video elementary stream. Each PES packet may include a stream_id that identifies the elementary stream to which the PES packet belongs. Encapsulation unit 30 is responsible for assembling elementary streams into video files (e.g., segments) of various representations.

Encapsulation unit 30 receives PES packets for elementary streams of a representation from audio encoder 26 and video encoder 28 and forms corresponding network abstraction layer (NAL) units from the PES packets. Coded video segments may be organized into NAL units, which provide a “network-friendly” video representation addressing applications such as video telephony, storage, broadcast, or streaming. NAL units can be categorized to Video Coding Layer (VCL) NAL units and non-VCL NAL units. VCL units may contain the core compression engine and may include block, macroblock, and/or slice level data. Other NAL units may be non-VCL NAL units. In some examples, a coded picture in one time instance, normally presented as a primary coded picture, may be contained in an access unit, which may include one or more NAL units.

Non-VCL NAL units may include parameter set NAL units and SEI NAL units, among others. Parameter sets may contain sequence-level header information (in sequence parameter sets (SPS)) and the infrequently changing picture-level header information (in picture parameter sets (PPS)). With parameter sets (e.g., PPS and SPS), infrequently changing information need not to be repeated for each sequence or picture; hence, coding efficiency may be improved. Furthermore, the use of parameter sets may enable out-of-band transmission of the important header information, avoiding the need for redundant transmissions for error resilience. In out-of-band transmission examples, parameter set NAL units may be transmitted on a different channel than other NAL units, such as SEI NAL units.

Supplemental Enhancement Information (SEI) may contain information that is not necessary for decoding the coded pictures samples from VCL NAL units, but may assist in processes related to decoding, display, error resilience, and other purposes. SEI messages may be contained in non-VCL NAL units. SEI messages are the normative part of some standard specifications, and thus are not always mandatory for standard compliant decoder implementation. SEI messages may be sequence level SEI messages or picture level SEI messages. Some sequence level information may be contained in SEI messages, such as scalability information SEI messages in the example of SVC and view scalability information SEI messages in MVC. These example SEI messages may convey information on, e.g., extraction of operation points and characteristics of the operation points. In addition, encapsulation unit 30 may form a manifest file, such as a media presentation descriptor (MPD) that describes characteristics of the representations. Encapsulation unit 30 may format the MPD according to extensible markup language (XML).

Encapsulation unit 30 may provide data for one or more representations of multimedia content, along with the manifest file (e.g., the MPD) to output interface 32. Output interface 32 may comprise a network interface or an interface for writing to a storage medium, such as a universal serial bus (USB) interface, a CD or DVD writer or burner, an interface to magnetic or flash storage media, or other interfaces for storing or transmitting media data. Encapsulation unit 30 may provide data of each of the representations of multimedia content to output interface 32, which may send the data to server device 60 via network transmission or storage media. In the example of FIG. 1, server device 60 includes storage medium 62 that stores various multimedia contents 64, each including a respective manifest file 66 and one or more representations 68A-68N (representations 68). In some examples, output interface 32 may also send data directly to network 74.

In some examples, representations 68 may be separated into adaptation sets. That is, various subsets of representations 68 may include respective common sets of characteristics, such as codec, profile and level, resolution, number of views, file format for segments, text type information that may identify a language or other characteristics of text to be displayed with the representation and/or audio data to be decoded and presented, e.g., by speakers, camera angle information that may describe a camera angle or real-world camera perspective of a scene for representations in the adaptation set, rating information that describes content suitability for particular audiences, or the like.

Manifest file 66 may include data indicative of the subsets of representations 68 corresponding to particular adaptation sets, as well as common characteristics for the adaptation sets. Manifest file 66 may also include data representative of individual characteristics, such as bitrates, for individual representations of adaptation sets. In this manner, an adaptation set may provide for simplified network bandwidth adaptation. Representations in an adaptation set may be indicated using child elements of an adaptation set element of manifest file 66.

Server device 60 includes request processing unit 70 and network interface 72. In some examples, server device 60 may include a plurality of network interfaces. Furthermore, any or all of the features of server device 60 may be implemented on other devices of a content delivery network, such as routers, bridges, proxy devices, switches, or other devices. In some examples, intermediate devices of a content delivery network may cache data of multimedia content 64, and include components that conform substantially to those of server device 60. In general, network interface 72 is configured to send and receive data via network 74.

Request processing unit 70 is configured to receive network requests from client devices, such as client device 40, for data of storage medium 62. For example, request processing unit 70 may implement hypertext transfer protocol (HTTP) version 1.1, as described in RFC 2616, “Hypertext Transfer Protocol—HTTP/1.1,” by R. Fielding et al, Network Working Group, IETF, June 1999. That is, request processing unit 70 may be configured to receive HTTP GET or partial GET requests and provide data of multimedia content 64 in response to the requests. The requests may specify a segment of one of representations 68, e.g., using a URL of the segment. In some examples, the requests may also specify one or more byte ranges of the segment, thus comprising partial GET requests. Request processing unit 70 may further be configured to service HTTP HEAD requests to provide header data of a segment of one of representations 68. In any case, request processing unit 70 may be configured to process the requests to provide requested data to a requesting device, such as client device 40.

Additionally or alternatively, request processing unit 70 may be configured to deliver media data via a broadcast or multicast protocol, such as eMBMS. Content preparation device 20 may create DASH segments and/or sub-segments in substantially the same way as described, but server device 60 may deliver these segments or sub-segments using eMBMS or another broadcast or multicast network transport protocol. For example, request processing unit 70 may be configured to receive a multicast group join request from client device 40. That is, server device 60 may advertise an Internet protocol (IP) address associated with a multicast group to client devices, including client device 40, associated with particular media content (e.g., a broadcast of a live event). Client device 40, in turn, may submit a request to join the multicast group. This request may be propagated throughout network 74, e.g., routers making up network 74, such that the routers are caused to direct traffic destined for the IP address associated with the multicast group to subscribing client devices, such as client device 40.

As illustrated in the example of FIG. 1, multimedia content 64 includes manifest file 66, which may correspond to a media presentation description (MPD). Manifest file 66 may contain descriptions of different alternative representations 68 (e.g., video services with different qualities) and the description may include, e.g., codec information, a profile value, a level value, a bitrate, and other descriptive characteristics of representations 68. Client device 40 may retrieve the MPD of a media presentation to determine how to access segments of representations 68.

In particular, retrieval unit 52 may retrieve configuration data (not shown) of client device 40 to determine decoding capabilities of video decoder 48 and rendering capabilities of video output 44. The configuration data may also include any or all of a language preference selected by a user of client device 40, one or more camera perspectives corresponding to depth preferences set by the user of client device 40, and/or a rating preference selected by the user of client device 40. Retrieval unit 52 may comprise, for example, a web browser or a media client configured to submit HTTP GET and partial GET requests. Retrieval unit 52 may correspond to software instructions executed by one or more processors or processing units (not shown) of client device 40. In some examples, all or portions of the functionality described with respect to retrieval unit 52 may be implemented in hardware, or a combination of hardware, software, and/or firmware, where requisite hardware may be provided to execute instructions for software or firmware.

Retrieval unit 52 may compare the decoding and rendering capabilities of client device 40 to characteristics of representations 68 indicated by information of manifest file 66. Retrieval unit 52 may initially retrieve at least a portion of manifest file 66 to determine characteristics of representations 68. For example, retrieval unit 52 may request a portion of manifest file 66 that describes characteristics of one or more adaptation sets. Retrieval unit 52 may select a subset of representations 68 (e.g., an adaptation set) having characteristics that can be satisfied by the coding and rendering capabilities of client device 40. Retrieval unit 52 may then determine bitrates for representations in the adaptation set, determine a currently available amount of network bandwidth, and retrieve segments from one of the representations having a bitrate that can be satisfied by the network bandwidth.

In general, higher bitrate representations may yield higher quality video playback, while lower bitrate representations may provide sufficient quality video playback when available network bandwidth decreases. Accordingly, when available network bandwidth is relatively high, retrieval unit 52 may retrieve data from relatively high bitrate representations, whereas when available network bandwidth is low, retrieval unit 52 may retrieve data from relatively low bitrate representations. In this manner, client device 40 may stream multimedia data over network 74 while also adapting to changing network bandwidth availability of network 74.

Additionally or alternatively, retrieval unit 52 may be configured to receive data in accordance with a broadcast or multicast network protocol, such as eMBMS or IP multicast. In such examples, retrieval unit 52 may submit a request to join a multicast network group associated with particular media content. After joining the multicast group, retrieval unit 52 may receive data of the multicast group without further requests issued to server device 60 or content preparation device 20. Retrieval unit 52 may submit a request to leave the multicast group when data of the multicast group is no longer needed, e.g., to stop playback or to change channels to a different multicast group.

Network interface 54 may receive and provide data of segments of a selected representation to retrieval unit 52, which may in turn provide the segments to decapsulation unit 50. Decapsulation unit 50 may decapsulate elements of a video file into constituent PES streams, depacketize the PES streams to retrieve encoded data, and send the encoded data to either audio decoder 46 or video decoder 48, depending on whether the encoded data is part of an audio or video stream, e.g., as indicated by PES packet headers of the stream. Audio decoder 46 decodes encoded audio data and sends the decoded audio data to audio output 42, while video decoder 48 decodes encoded video data and sends the decoded video data, which may include a plurality of views of a stream, to video output 44.

Video encoder 28, video decoder 48, audio encoder 26, audio decoder 46, encapsulation unit 30, retrieval unit 52, and decapsulation unit 50 each may be implemented as any of a variety of suitable processing circuitry, as applicable, such as one or more microprocessors, digital signal processors (DSPs), application specific integrated circuits (ASICs), field programmable gate arrays (FPGAs), discrete logic circuitry, software, hardware, firmware or any combinations thereof. Each of video encoder 28 and video decoder 48 may be included in one or more encoders or decoders, either of which may be integrated as part of a combined video encoder/decoder (CODEC). Likewise, each of audio encoder 26 and audio decoder 46 may be included in one or more encoders or decoders, either of which may be integrated as part of a combined CODEC. An apparatus including video encoder 28, video decoder 48, audio encoder 26, audio decoder 46, encapsulation unit 30, retrieval unit 52, and/or decapsulation unit 50 may comprise an integrated circuit, a microprocessor, and/or a wireless communication device, such as a cellular telephone.

Client device 40, server device 60, and/or content preparation device 20 may be configured to operate in accordance with the techniques of this disclosure. For purposes of example, this disclosure describes these techniques with respect to client device 40 and server device 60. However, it should be understood that content preparation device 20 may be configured to perform these techniques, instead of (or in addition to) server device 60.

Encapsulation unit 30 may form NAL units comprising a header that identifies a program to which the NAL unit belongs, as well as a payload, e.g., audio data, video data, or data that describes the transport or program stream to which the NAL unit corresponds. For example, in H.264/AVC, a NAL unit includes a 1-byte header and a payload of varying size. A NAL unit including video data in its payload may comprise various granularity levels of video data. For example, a NAL unit may comprise a block of video data, a plurality of blocks, a slice of video data, or an entire picture of video data. Encapsulation unit 30 may receive encoded video data from video encoder 28 in the form of PES packets of elementary streams. Encapsulation unit 30 may associate each elementary stream with a corresponding program.

Encapsulation unit 30 may also assemble access units from a plurality of NAL units. In general, an access unit may comprise one or more NAL units for representing a frame of video data, as well as audio data corresponding to the frame when such audio data is available. An access unit generally includes all NAL units for one output time instance, e.g., all audio and video data for one time instance. For example, if each view has a frame rate of 20 frames per second (fps), then each time instance may correspond to a time interval of 0.05 seconds. During this time interval, the specific frames for all views of the same access unit (the same time instance) may be rendered simultaneously. In one example, an access unit may comprise a coded picture in one time instance, which may be presented as a primary coded picture.

Accordingly, an access unit may comprise all audio and video frames of a common temporal instance, e.g., all views corresponding to time X. This disclosure also refers to an encoded picture of a particular view as a “view component.” That is, a view component may comprise an encoded picture (or frame) for a particular view at a particular time. Accordingly, an access unit may be defined as comprising all view components of a common temporal instance. The decoding order of access units need not necessarily be the same as the output or display order.

A media presentation may include a media presentation description (MPD), which may contain descriptions of different alternative representations (e.g., video services with different qualities) and the description may include, e.g., codec information, a profile value, and a level value. An MPD is one example of a manifest file, such as manifest file 66. Client device 40 may retrieve the MPD of a media presentation to determine how to access movie fragments of various presentations. Movie fragments may be located in movie fragment boxes (moof boxes) of video files.

Manifest file 66 (which may comprise, for example, an MPD) may advertise availability of segments of representations 68. That is, the MPD may include information indicating the wall-clock time at which a first segment of one of representations 68 becomes available, as well as information indicating the durations of segments within representations 68. In this manner, retrieval unit 52 of client device 40 may determine when each segment is available, based on the starting time as well as the durations of the segments preceding a particular segment.

After encapsulation unit 30 has assembled NAL units and/or access units into a video file based on received data, encapsulation unit 30 passes the video file to output interface 32 for output. In some examples, encapsulation unit 30 may store the video file locally or send the video file to a remote server via output interface 32, rather than sending the video file directly to client device 40. Output interface 32 may comprise, for example, a transmitter, a transceiver, a device for writing data to a computer-readable medium such as, for example, an optical drive, a magnetic media drive (e.g., floppy drive), a universal serial bus (USB) port, a network interface, or other output interface. Output interface 32 outputs the video file to a computer-readable medium, such as, for example, a transmission signal, a magnetic medium, an optical medium, a memory, a flash drive, or other computer-readable medium.

Network interface 54 may receive a NAL unit or access unit via network 74 and provide the NAL unit or access unit to decapsulation unit 50, via retrieval unit 52. Decapsulation unit 50 may decapsulate a elements of a video file into constituent PES streams, depacketize the PES streams to retrieve encoded data, and send the encoded data to either audio decoder 46 or video decoder 48, depending on whether the encoded data is part of an audio or video stream, e.g., as indicated by PES packet headers of the stream. Audio decoder 46 decodes encoded audio data and sends the decoded audio data to audio output 42, while video decoder 48 decodes encoded video data and sends the decoded video data, which may include a plurality of views of a stream, to video output 44.

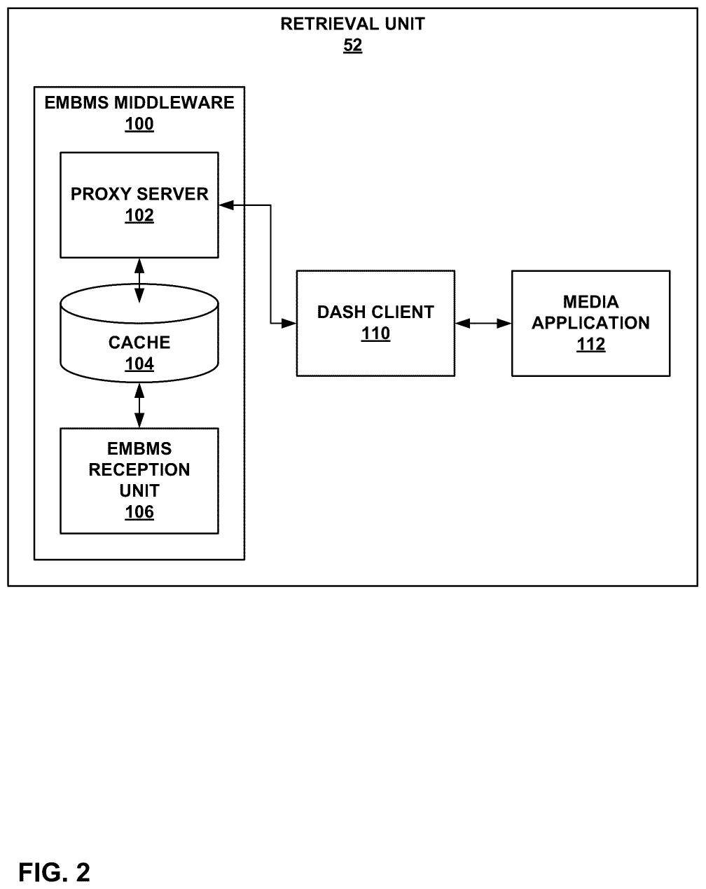

FIG. 2 is a block diagram illustrating an example set of components of retrieval unit 52 of FIG. 1 in greater detail. In this example, retrieval unit 52 includes eMBMS middleware unit 100, DASH client 110, and media application 112.

In this example, eMBMS middleware unit 100 further includes eMBMS reception unit 106, cache 104, and proxy server unit 102. In this example, eMBMS reception unit 106 is configured to receive data via eMBMS, e.g., according to File Delivery over Unidirectional Transport (FLUTE), described in T. Paila et al., “FLUTE-File Delivery over Unidirectional Transport,” Network Working Group, RFC 6726, November 2012, available at tools.ietf.org/html/rfc6726. That is, eMBMS reception unit 106 may receive files via broadcast from, e.g., server device 60, which may act as a broadcast/multicast service center (BM-SC).

As eMBMS middleware unit 100 receives data for files, eMBMS middleware unit may store the received data in cache 104. Cache 104 may comprise a computer-readable storage medium, such as flash memory, a hard disk, RAM, or any other suitable storage medium.

Proxy server unit 102 may act as a server for DASH client 110. For example, proxy server unit 102 may provide a MPD file or other manifest file to DASH client 110. Proxy server unit 102 may advertise availability times for segments in the MPD file, as well as hyperlinks from which the segments can be retrieved. These hyperlinks may include a localhost address prefix corresponding to client device 40 (e.g., 127.0.0.1 for IPv4). In this manner, DASH client 110 may request segments from proxy server unit 102 using HTTP GET or partial GET requests. For example, for a segment available from link http://127.0.0.1/rep1/seg3, DASH client 110 may construct an HTTP GET request that includes a request for http://127.0.0.1/rep1/seg3, and submit the request to proxy server unit 102. Proxy server unit 102 may retrieve requested data from cache 104 and provide the data to DASH client 110 in response to such requests.

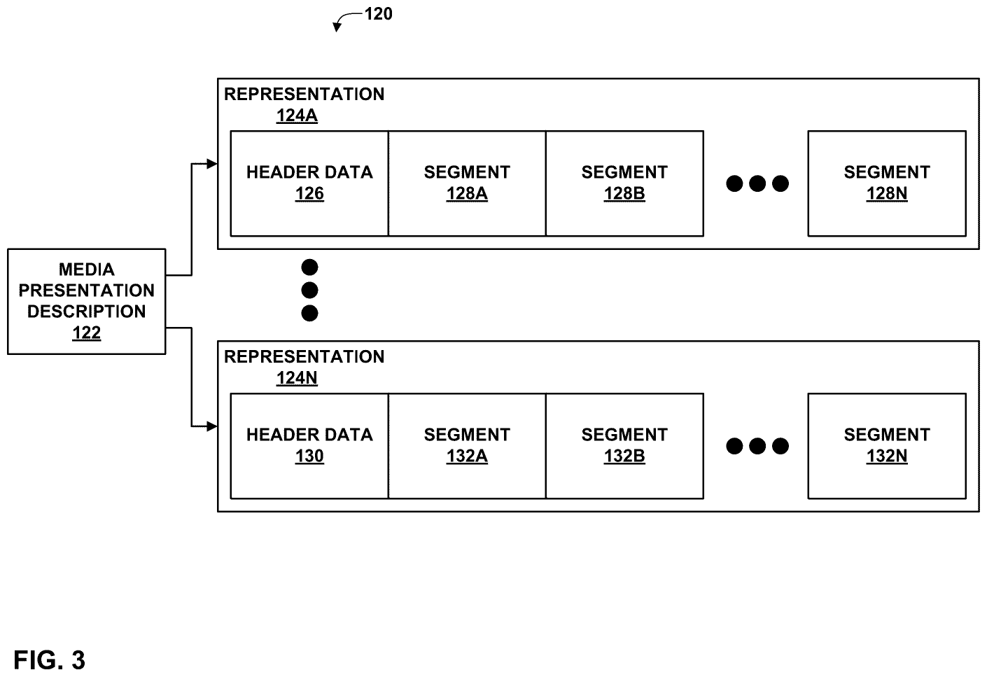

FIG. 3 is a conceptual diagram illustrating elements of example multimedia content 120. Multimedia content 120 may correspond to multimedia content 64 (FIG. 1), or another multimedia content stored in storage medium 62. In the example of FIG. 3, multimedia content 120 includes media presentation description (MPD) 122 and a plurality of representations 124A-124N (representations 124). Representation 124A includes optional header data 126 and segments 128A-128N (segments 128), while representation 124N includes optional header data 130 and segments 132A-132N (segments 132). The letter N is used to designate the last movie fragment in each of representations 124 as a matter of convenience. In some examples, there may be different numbers of movie fragments between representations 124.

MPD 122 may comprise a data structure separate from representations 124. MPD 122 may correspond to manifest file 66 of FIG. 1. Likewise, representations 124 may correspond to representations 68 of FIG. 1. In general, MPD 122 may include data that generally describes characteristics of representations 124, such as coding and rendering characteristics, adaptation sets, a profile to which MPD 122 corresponds, text type information, camera angle information, rating information, trick mode information (e.g., information indicative of representations that include temporal sub-sequences), and/or information for retrieving remote periods (e.g., for targeted advertisement insertion into media content during playback).

Header data 126, when present, may describe characteristics of segments 128, e.g., temporal locations of random access points (RAPs, also referred to as stream access points (SAPs)), which of segments 128 includes random access points, byte offsets to random access points within segments 128, uniform resource locators (URLs) of segments 128, or other aspects of segments 128. Header data 130, when present, may describe similar characteristics for segments 132. Additionally or alternatively, such characteristics may be fully included within MPD 122.

Segments 128, 132 include one or more coded video samples, each of which may include frames or slices of video data. Each of the coded video samples of segments 128 may have similar characteristics, e.g., height, width, and bandwidth requirements. Such characteristics may be described by data of MPD 122, though such data is not illustrated in the example of FIG. 3. MPD 122 may include characteristics as described by the 3GPP Specification, with the addition of any or all of the signaled information described in this disclosure.

Each of segments 128, 132 may be associated with a unique uniform resource locator (URL). Thus, each of segments 128, 132 may be independently retrievable using a streaming network protocol, such as DASH. In this manner, a destination device, such as client device 40, may use an HTTP GET request to retrieve segments 128 or 132. In some examples, client device 40 may use HTTP partial GET requests to retrieve specific byte ranges of segments 128 or 132.

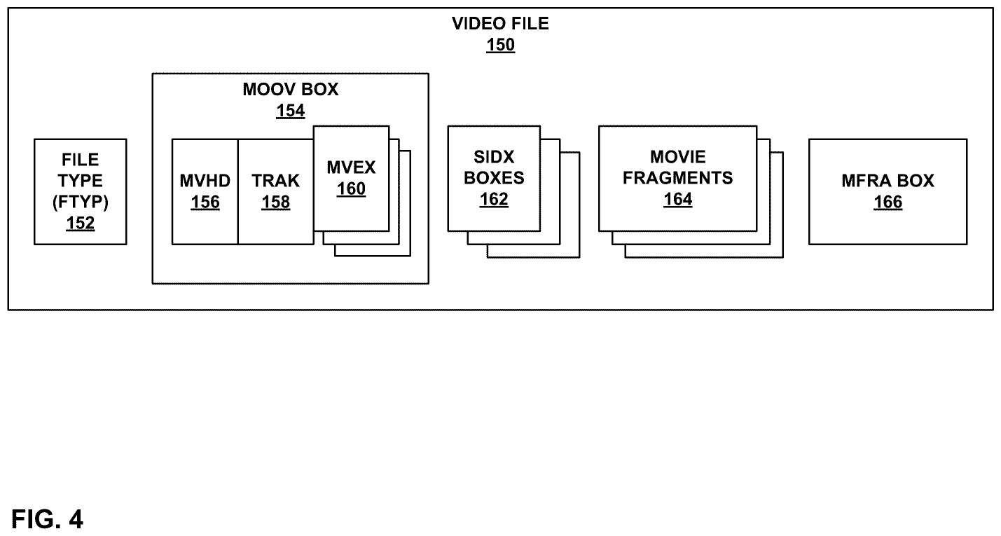

FIG. 4 is a block diagram illustrating elements of an example video file 150, which may correspond to a segment of a representation, such as one of segments 128, 132 of FIG. 3. Each of segments 128, 132 may include data that conforms substantially to the arrangement of data illustrated in the example of FIG. 4. Video file 150 may be said to encapsulate a segment. As described above, video files in accordance with the ISO base media file format and extensions thereof store data in a series of objects, referred to as “boxes.” In the example of FIG. 4, video file 150 includes file type (FTYP) box 152, movie (MOOV) box 154, segment index (sidx) boxes 162, movie fragment (MOOF) boxes 164, and movie fragment random access (MFRA) box 166. Although FIG. 4 represents an example of a video file, it should be understood that other media files may include other types of media data (e.g., audio data, timed text data, or the like) that is structured similarly to the data of video file 150, in accordance with the ISO base media file format and its extensions.

File type (FTYP) box 152 generally describes a file type for video file 150. File type box 152 may include data that identifies a specification that describes a best use for video file 150. File type box 152 may alternatively be placed before MOOV box 154, movie fragment boxes 164, and/or MFRA box 166.

In some examples, a Segment, such as video file 150, may include an MPD update box (not shown) before FTYP box 152. The MPD update box may include information indicating that an MPD corresponding to a representation including video file 150 is to be updated, along with information for updating the MPD. For example, the MPD update box may provide a URI or URL for a resource to be used to update the MPD. As another example, the MPD update box may include data for updating the MPD. In some examples, the MPD update box may immediately follow a segment type (STYP) box (not shown) of video file 150, where the STYP box may define a segment type for video file 150.

MOOV box 154, in the example of FIG. 4, includes movie header (MVHD) box 156, track (TRAK) box 158, and one or more movie extends (MVEX) boxes 160. In general, MVHD box 156 may describe general characteristics of video file 150. For example, MVHD box 156 may include data that describes when video file 150 was originally created, when video file 150 was last modified, a timescale for video file 150, a duration of playback for video file 150, or other data that generally describes video file 150.

TRAK box 158 may include data for a track of video file 150. TRAK box 158 may include a track header (TKHD) box that describes characteristics of the track corresponding to TRAK box 158. In some examples, TRAK box 158 may include coded video pictures, while in other examples, the coded video pictures of the track may be included in movie fragments 164, which may be referenced by data of TRAK box 158 and/or sidx boxes 162.

In some examples, video file 150 may include more than one track. Accordingly, MOOV box 154 may include a number of TRAK boxes equal to the number of tracks in video file 150. TRAK box 158 may describe characteristics of a corresponding track of video file 150. For example, TRAK box 158 may describe temporal and/or spatial information for the corresponding track. A TRAK box similar to TRAK box 158 of MOOV box 154 may describe characteristics of a parameter set track, when encapsulation unit 30 (FIG. 3) includes a parameter set track in a video file, such as video file 150. Encapsulation unit 30 may signal the presence of sequence level SEI messages in the parameter set track within the TRAK box describing the parameter set track.

MVEX boxes 160 may describe characteristics of corresponding movie fragments 164, e.g., to signal that video file 150 includes movie fragments 164, in addition to video data included within MOOV box 154, if any. In the context of streaming video data, coded video pictures may be included in movie fragments 164 rather than in MOOV box 154. Accordingly, all coded video samples may be included in movie fragments 164, rather than in MOOV box 154.

MOOV box 154 may include a number of MVEX boxes 160 equal to the number of movie fragments 164 in video file 150. Each of MVEX boxes 160 may describe characteristics of a corresponding one of movie fragments 164. For example, each MVEX box may include a movie extends header box (MEHD) box that describes a temporal duration for the corresponding one of movie fragments 164.

As noted above, encapsulation unit 30 may store a sequence data set in a video sample that does not include actual coded video data. A video sample may generally correspond to an access unit, which is a representation of a coded picture at a specific time instance. In the context of AVC, the coded picture include one or more VCL NAL units, which contain the information to construct all the pixels of the access unit and other associated non-VCL NAL units, such as SEI messages. Accordingly, encapsulation unit 30 may include a sequence data set, which may include sequence level SEI messages, in one of movie fragments 164. Encapsulation unit 30 may further signal the presence of a sequence data set and/or sequence level SEI messages as being present in one of movie fragments 164 within the one of MVEX boxes 160 corresponding to the one of movie fragments 164.

SIDX boxes 162 are optional elements of video file 150. That is, video files conforming to the 3GPP file format, or other such file formats, do not necessarily include SIDX boxes 162. In accordance with the example of the 3GPP file format, a SIDX box may be used to identify a sub-segment of a segment (e.g., a segment contained within video file 150). The 3GPP file format defines a sub-segment as “a self-contained set of one or more consecutive movie fragment boxes with corresponding Media Data box(es) and a Media Data Box containing data referenced by a Movie Fragment Box must follow that Movie Fragment box and precede the next Movie Fragment box containing information about the same track.” The 3GPP file format also indicates that a SIDX box “contains a sequence of references to subsegments of the (sub)segment documented by the box. The referenced subsegments are contiguous in presentation time. Similarly, the bytes referred to by a Segment Index box are always contiguous within the segment. The referenced size gives the count of the number of bytes in the material referenced.”

SIDX boxes 162 generally provide information representative of one or more sub-segments of a segment included in video file 150. For instance, such information may include playback times at which sub-segments begin and/or end, byte offsets for the sub-segments, whether the sub-segments include (e.g., start with) a stream access point (SAP), a type for the SAP (e.g., whether the SAP is an instantaneous decoder refresh (IDR) picture, a clean random access (CRA) picture, a broken link access (BLA) picture, or the like), a position of the SAP (in terms of playback time and/or byte offset) in the sub-segment, and the like.

Movie fragments 164 may include one or more coded video pictures. In some examples, movie fragments 164 may include one or more groups of pictures (GOPs), each of which may include a number of coded video pictures, e.g., frames or pictures. In addition, as described above, movie fragments 164 may include sequence data sets in some examples. Each of movie fragments 164 may include a movie fragment header box (MFHD, not shown in FIG. 4). The MFHD box may describe characteristics of the corresponding movie fragment, such as a sequence number for the movie fragment. Movie fragments 164 may be included in order of sequence number in video file 150.

MFRA box 166 may describe random access points within movie fragments 164 of video file 150. This may assist with performing trick modes, such as performing seeks to particular temporal locations (i.e., playback times) within a segment encapsulated by video file 150. MFRA box 166 is generally optional and need not be included in video files, in some examples. Likewise, a client device, such as client device 40, does not necessarily need to reference MFRA box 166 to correctly decode and display video data of video file 150. MFRA box 166 may include a number of track fragment random access (TFRA) boxes (not shown) equal to the number of tracks of video file 150, or in some examples, equal to the number of media tracks (e.g., non-hint tracks) of video file 150.

In some examples, movie fragments 164 may include one or more stream access points (SAPs), such as IDR pictures. Likewise, MFRA box 166 may provide indications of locations within video file 150 of the SAPs. Accordingly, a temporal sub-sequence of video file 150 may be formed from SAPs of video file 150. The temporal sub-sequence may also include other pictures, such as P-frames and/or B-frames that depend from SAPs. Frames and/or slices of the temporal sub-sequence may be arranged within the segments such that frames/slices of the temporal sub-sequence that depend on other frames/slices of the sub-sequence can be properly decoded. For example, in the hierarchical arrangement of data, data used for prediction for other data may also be included in the temporal sub-sequence.

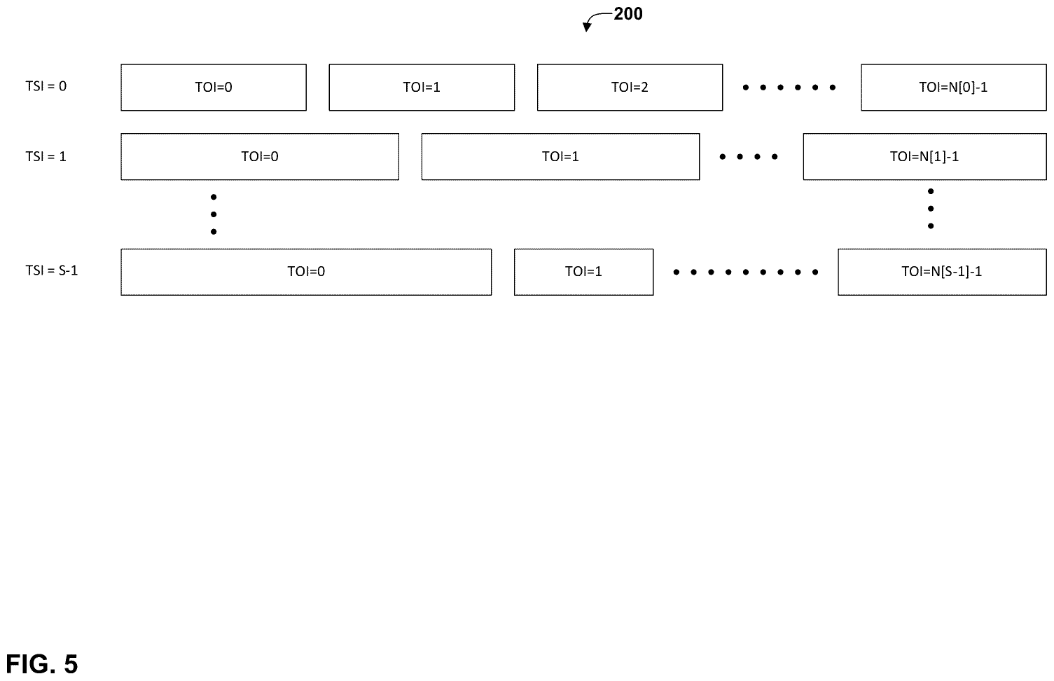

FIG. 5 is a conceptual diagram illustrating a delivery session model 200 for CMMF. FIG. 5 depicts multiple transport sessions having respective transport session identifiers (TSIs). According to the techniques of this disclosure, application data and application objects to be delivered from a CMMF sender to a CMMF receiver may be organized into transport objects. Transport objects are application objects with associated metadata that are to be available for retrieval in order to be useful to the receiving application. The objects may be organized in a delivery session.

A transport session may include one or more transport objects, whereby each transport object can be uniquely identified within the session by a transport object identifier (TOI). Each transport object may be assigned to one transport session within the delivery session. Transport session flows may be uniquely identified by a transport session identifier (TSI). Transport objects within a transport session may be uniquely identified by a TOI and may have a specified delivery order. Transport objects within a transport session may share common metadata and other properties.

Each TOI may be associated with respective metadata and a URL. A bye range of a single application object may be retrieved using the associated metadata and URL, e.g., using an HTTP partial GET request. File Delivery Tables (FDTs) may be used to create a mapping between TOI/TSI and URLs for application objects.

A File Delivery Table may provide a mechanism for describing various attributes associated with files that are to be delivered within the file delivery session. The following lists are examples of such attributes and are not intended to be mutually exclusive or exhaustive.

Attributes related to the delivery of a file may include:
TOI value that represents the file
FEC Object Transmission Information (including the FEC Encoding ID and, if relevant, the FEC Instance ID)
Size of the transmission object carrying the file
Aggregate rate of sending packets to all channels

Attributes related to the file itself may include:
Name, Identification, and Location of file (specified by the URI)
Alternative File-Locations
Media type of file
Size of file
Encoding of file
   Message digest of file

FIG. 5 depicts an overview of the application and source data in the context of the techniques of this disclosure. In this example, a delivery session includes N transport session, each identified by a TSI from 0 to N−1. Each transport session includes N[TSI]transport objects, each identified by a TOI from 0 to N[TSI]−1. The techniques of this disclosure may be applied for a single transport session with a single transport object, or multiple transport objects and/or transport sessions.

The data model and the associated metadata may be provided implicitly or may be provided as part of a manifest file. A typical example is a DASH or HLS manifest that would describe the delivery session model.

CMMF provides techniques to generate repair objects and to repair object sessions for transport sessions, as discussed below. The CMMF repair framework is based on existing FEC Frameworks. Based on the Forward Error Correction (FEC) Building Block as defined in IETF RFC5052, CMMF can be considered as a Content Delivery Protocol (CDP) specification as defined in clause of 8 of RFC5052. In the description, terminology defined in IETF RFC5052, clause 2, is used in this disclosure, specifically:
Object: An ordered sequence of octets to be transferred by the transport protocol. For example, a file or stream.
Symbol: A unit of data processed by the Forward Error Correction code. A symbol is always considered as a unit, i.e., it is either completely received or completely lost.
Source symbol: A symbol containing information from the original object
Repair symbol: A symbol containing information generated by the FEC code which can be used to recover lost source symbols.
Encoding symbol: A source symbol or a repair symbol.
Encoder: The FEC scheme specific functions required to transform an object into FEC encoded data. That is, the functions that produce repair symbols using source symbols.
Decoder: The FEC scheme-specific functions required to transform received FEC-encoded data into a copy of the original object.
Receiver: A system supporting the receiving functions of a CDP and FEC scheme according to this specification.
Sender: A system supporting the sending functions of a CDP and FEC scheme according to this specification.
Source Block: A part of the object formed from a subset of the object's source symbols.
FEC scheme: ancillary information and procedures which, combined with an FEC code or algorithm specification, fully define how the FEC code can be used with a Content Packaging or Delivery system

CMMF may use a FEC scheme based on the FEC building block definition in RFC5052 and CMMF can be considered as a CDP as defined in RFC5052. RFC5052 also provides the definition and transport of three kinds of information from sender to receivers, as follows:
Encoding symbols themselves,
Ancillary information associated with encoding symbols (or groups of such symbols), such as the group of symbols in a repair object, and
Ancillary information associated with the whole object being transferred.

FEC information may be classified as follows:
FEC information associated with an object may be FEC object transmission information
FEC information associated with specific encoding symbols for an object may be a FEC payload ID

FEC schemes may be identified by a FEC encoding ID (e.g., an integer assigned by IANA). Requirements for FEC scheme specifications are defined in clause 7 of RFC 5052.

In addition, for FEC, the following information is defined and provided in RFC5052:
FEC information associated with an object, referred to as FEC Object Transmission Information. This includes for example the FEC Encoding ID that identifies the FEC scheme and is an integer assigned by IANA, the transfer length of the object or the encoding symbol length. For details, refer to clause 6.2 of RFC5052.
FEC information associated with specific encoding symbols for an object, referred to as FEC Payload ID. This information indicates how the associated repair symbols were constructed from the object. The semantics and encoding format of the FEC Payload ID, including its size, is defined by the FEC Scheme. CDPs specify how the FEC Payload ID is carried in the respective framework. For details, refer to clause 6.3 of RFC5052.

Central to RFC5052 is the concept of a ‘FEC Scheme’, which can be distinguished from the concept of an ‘FEC code’ or ‘FEC algorithm.’ A FEC scheme defines the ancillary information and procedures which, combined with a FEC code or algorithm specification, fully defines how the FEC code can be used with CDPs. Requirements for FEC scheme specifications are defined in clause 7 of RFC5052.

FEC object transmission information may include a FEC encoding ID, which may be an integer between 0 and 255, inclusive, identifying a specific FEC scheme. The FEC object transmission information may further include:
Transfer-length: a non-negative integer indicating the length of the object in octets
Encoding-Symbol-Length: a non-negative integer indicating the length of each encoding symbol in octets
Maximum-Source-Block-Length: a non-negative integer indicating the maximum number of source symbols in a source block
Max-Number-of-Encoding-Symbols: a non-negative integer indicating the maximum number of encoding symbols

The FEC object transmission information may further include scheme-specific information. The Scheme-specific FEC Object Transmission Information element may be used by an FEC Scheme to communicate information that is essential to the decoder and that cannot adequately be represented within the Mandatory or Common FEC Object Transmission Information elements.

The FEC Payload ID contains information that indicates to the FEC decoder the relationships between the encoding symbols carried by a particular packet and the FEC encoding transformation. For example, if the packet carries source symbols, then the FEC Payload ID indicates which source symbols of the object are carried by the packet. If the packet carries repair symbols, then the FEC Payload ID indicates how those repair symbols were constructed from the object. The FEC Payload ID may also contain information about larger groups of encoding symbols, of which those contained in the packet are part. For example, the FEC Payload ID may contain information about the source block the symbols are related to. The encoding format of the FEC Payload ID, including its size, is defined by the FEC Scheme. CDPs specify how the FEC Payload ID is carried within data packets, i.e., the position of the FEC Payload ID within the CDP packet format and the how it is associated with encoding symbols. FEC schemes for systematic FEC codes (that is, those codes in which the original source data is included within the encoded data) may specify two FEC Payload ID formats: one for packets carrying only source symbols, and another for packets carrying at least one repair symbol.

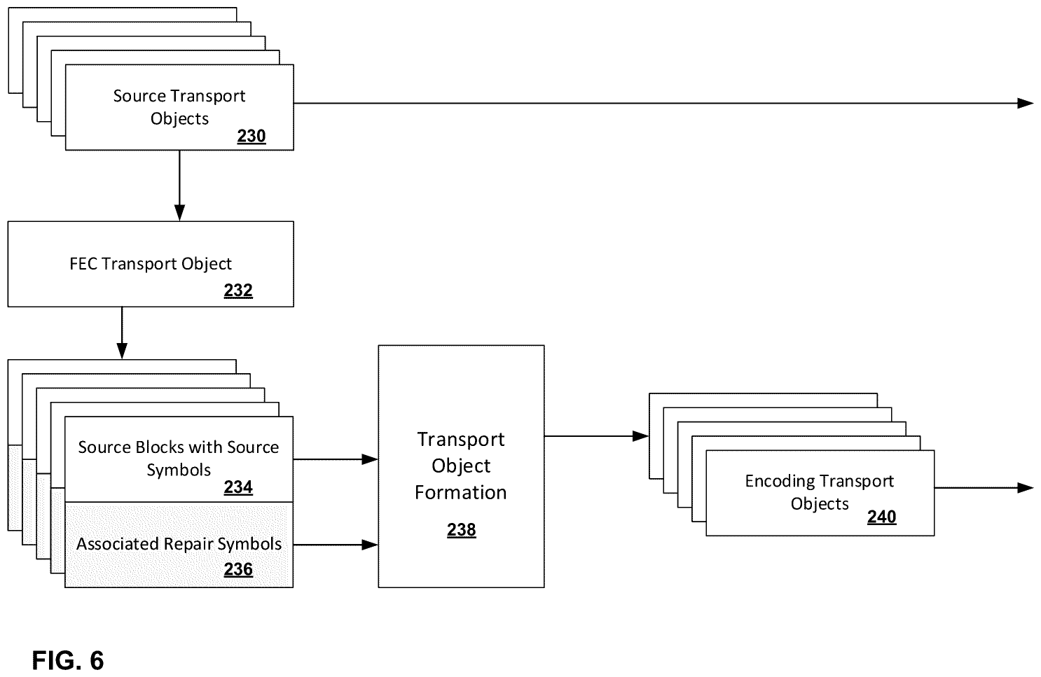

FIG. 6 is a conceptual diagram illustrating an example process for generating transport objects. Forward error correction (FEC) transport objects 232 may be formed from one or more source transport objects 230, as shown in FIG. 6.

As shown in FIG. 6, initially, one or multiple source transport objects 230 are combined into a FEC Transport Object 232. One typical case is that a Source Transport Object is directly transferred into an FEC Transport Object. Then for each FEC Transport Object, one or multiple source blocks 234 are generated, each containing an integer number of symbols of size T. For each source block associated to the FEC Transport object, a set of repair symbols 236 may be generated, each of size T as well. A transport object formation unit 238 uses the source and repair symbols of all source blocks associated with a FEC Transport Object to generate one or multiple encoding transport objects 240. CMMF encoding transport objects may include source symbols only, a mixture of source symbols and repair symbols, or repair symbols only.

For FEC Transport Object Formation, several instantiations and modes are defined in CMMF. In one example, principles defined RFC 5052 and summarized above are reused, i.e., the formation of source blocks from an FEC Transport object. In this case, CMMF may also inherit principles from IETF RFC 9223, the Real-Time Transport Object Delivery over Unidirectional Transport (ROUTE).

In some examples, there may be a one-to-one mapping between source data and transport objects, which may be available in file delivery protocols such as FLUTE and ROUTE. In some examples, there may be a many to one mapping of source objects into a single transport object, which may be available in ROUTE. In some examples, there may be a one-to-many mapping of a byte range of a source object mapped to a transport object, such that the source object may be mapped to multiple transport objects (e.g., each byte range of the source object may be mapped to a respective transport object).

In some examples, each repair object includes a distinct set of repair symbols. In some examples, each repair object contains the encoding symbols with the same ESI for each source block. The encoding symbols may be sequential for each source block or may be interleaved across repair objects to optimize start-up.

A repair object, according to the techniques of this disclosure, may include any or all of the following information:
An indication that the object is a CMMF repair object
A header including FEC object transmission information, e.g.:
   FEC encoding ID
   Common FEC object transmission information
      Transfer Length
      Symbol Size
   Scheme specific object transmission information
A repair TOI/TSI information and optional header information that includes information about the source object:
   Identifier
   Source object to repair object mapping
   Source object URLs
   contentType
   Time code related to the source object
Source FEC payload ID: A header that provides information about the included encoding symbols, the FEC payload ID
A sequence of encoding symbols

Static and common information may be included by a repair object that is explicitly or implicitly referenced by multiple repair objects.

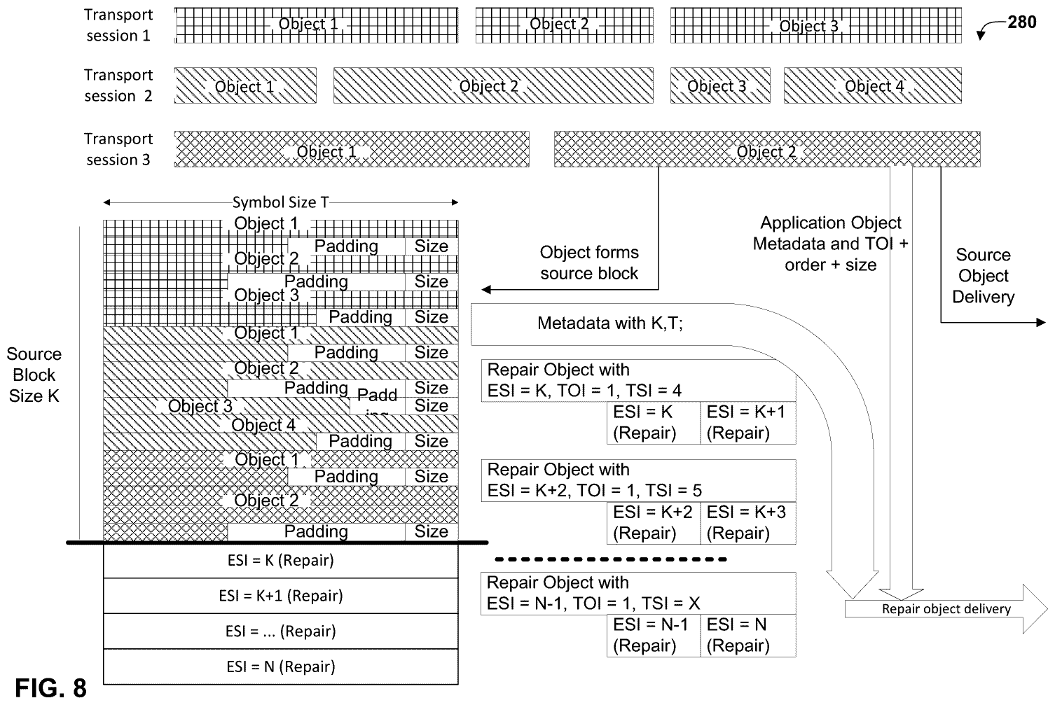

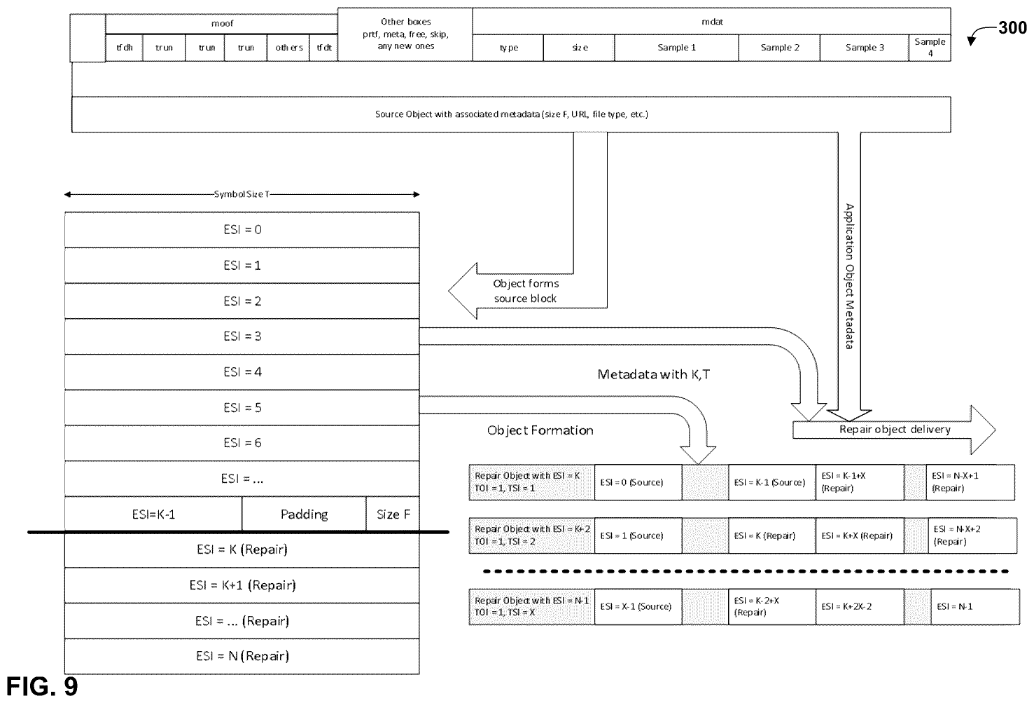

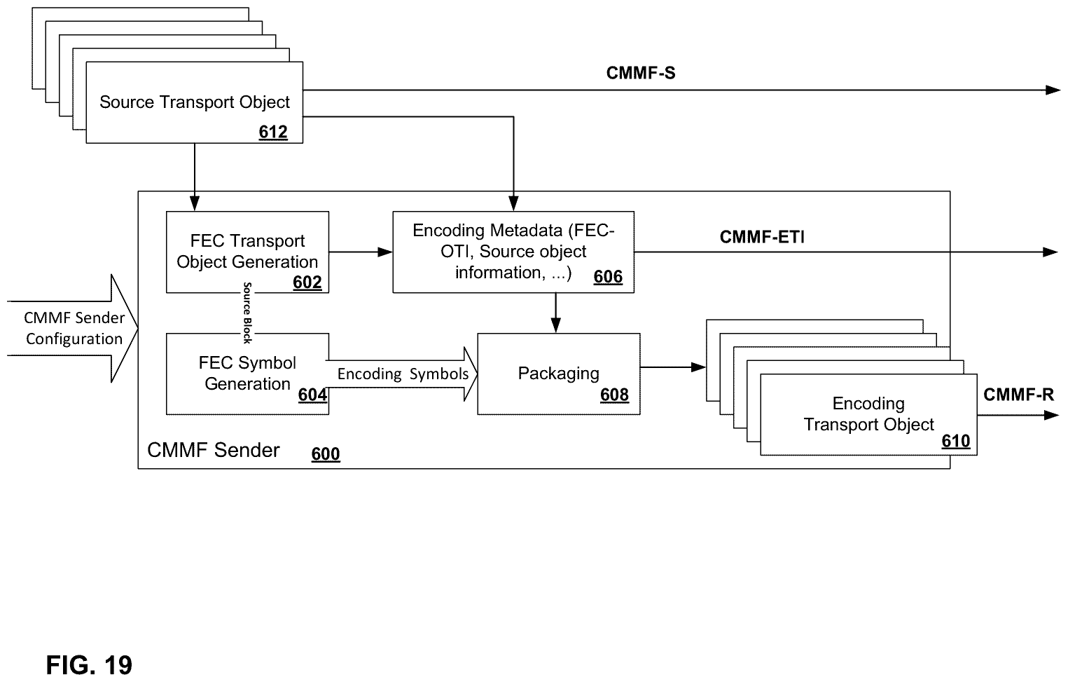

The following may be assumed for CMMF:
A fully-specified FEC code
Systematic FEC code
Application objects may be offered unmodified
Application objects may follow the model described with respect to FIG. 19
A mapping between application objects, URLs, and FEC association may exist in terms of TSI and TOI.
   This mapping may be provided explicitly, e.g., in an FDT or manifest
A FEC transport object may be:
   A single application object with padding and size, e.g., as discussed with respect to FIG. 9.
   A byte range of an application object with padding and size
   An aggregation of a transport object to create and a FEC super object, e.g., as discussed with respect to FIG. 8.
The repair objects may each be an aggregation of
   FEC object transmission information
   Repair TO and TSI (based on source TOI and TSI)
   Source information (including FDT and possibly timing information)
   FEC payload ID
   Contained repair symbols
Repair objects may be organized in flows/sessions with a TSI and a repair object header

Encoding symbols may be included in the following pattern: all encoding symbols with the same ESI are written sequentially starting with block 1. After this, the next ESI is written for all source blocks as well.

Each repair object may contain sufficient symbols to recover the application objects.

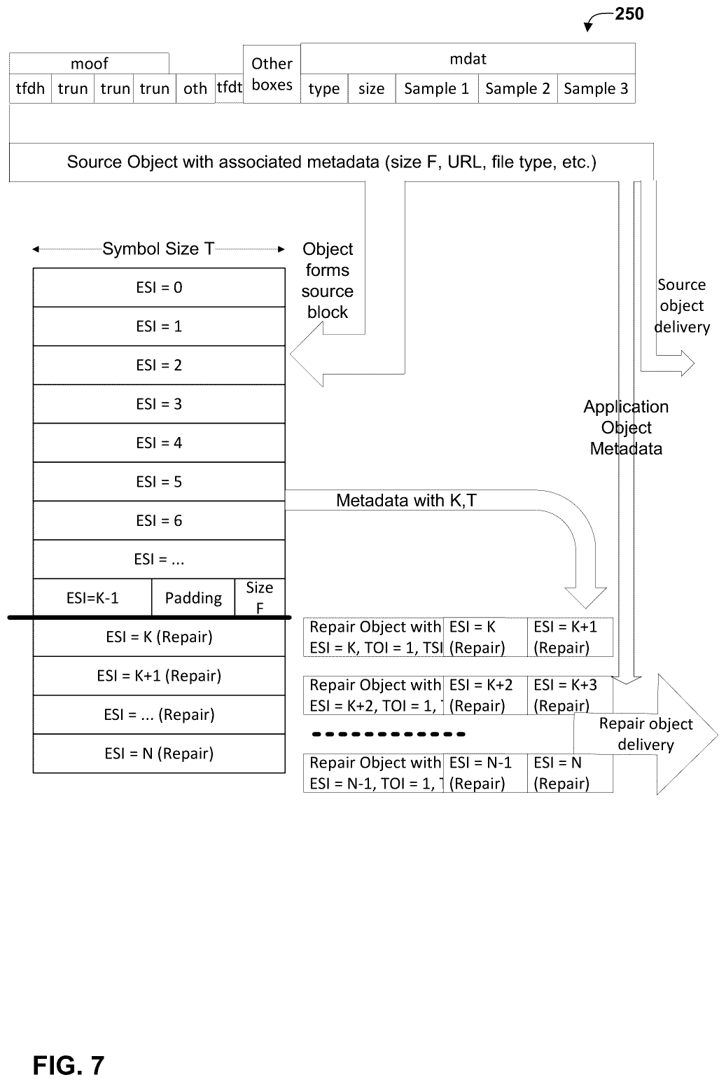

FIG. 7 is a conceptual diagram depicting a relationship 250 between source and repair objects. The process of generating the FEC Transport Object is provided in RFC9223, clause 5.6. Assuming a transport object is a single application object as shown in FIG. 7, the associated FEC transport object is comprised of the concatenation of the transport object, padding octets (P), and the FEC object size (F) in octets, where F is carried in a 4-octet field. The FEC transport object size K, in FEC encoding symbols, may be an integer multiple of the symbol size Y. The transport object size F is carried in the last 4 octets of the FEC transport object. Then the FEC scheme is used to generate repair symbols with ESI K, K+1, . . . . Then the information K and Y, as well the FEC OTI, the FEC Payload ID, as well as the application metadata is added to the repair object and/or may be provided in the External Transport Information (ETI).

CMMF may include certain principles ported from ROUTE. The FEC design may adhere to the following design principles:
FEC-related information is provided only where needed.
Receivers not capable of this framework can ignore repair packets.
The FEC is symbol based with fixed symbol size per protected Source Flow.
A FEC Repair Flow provides protection of delivery objects from one or more Source Flows.

In addition, FEC Repair Flow declaration may include FEC-specific information, such as:
A FEC Repair Flow declaration including all FEC-specific information.
A FEC transport object that is the concatenation of a delivery object, padding octets, and size information in order to form a chunk of data that has a size in symbols of N, where N>=1.
A FEC super-object that is the concatenation of one or more FEC transport objects in order to bundle FEC transport objects for FEC protection.
A packaging of the FEC data into repair objects

A receiver may be configured to recover application objects from repair objects based on available FEC information.

FIG. 8 is a conceptual diagram illustrating an example super-object generation technique 280. ROUTE permits transport objects to be combined with FEC super-objects in order to generate a single FEC source block that protects all transport objects included in the virtual super-object jointly, as described in RFC9223, clause 5.7, and shown in FIG. 8.

FIG. 9 is a conceptual diagram illustrating another example technique 230 for super-object generation. Repair objects may be formed as shown in FIG. 9. In this example, the objects in different TSIs include source symbols in a round-robin fashion. Such a setup may enable the download of repair objects in parallel and aggregation of the initial symbols of each encoded object into the initial data of the application object.

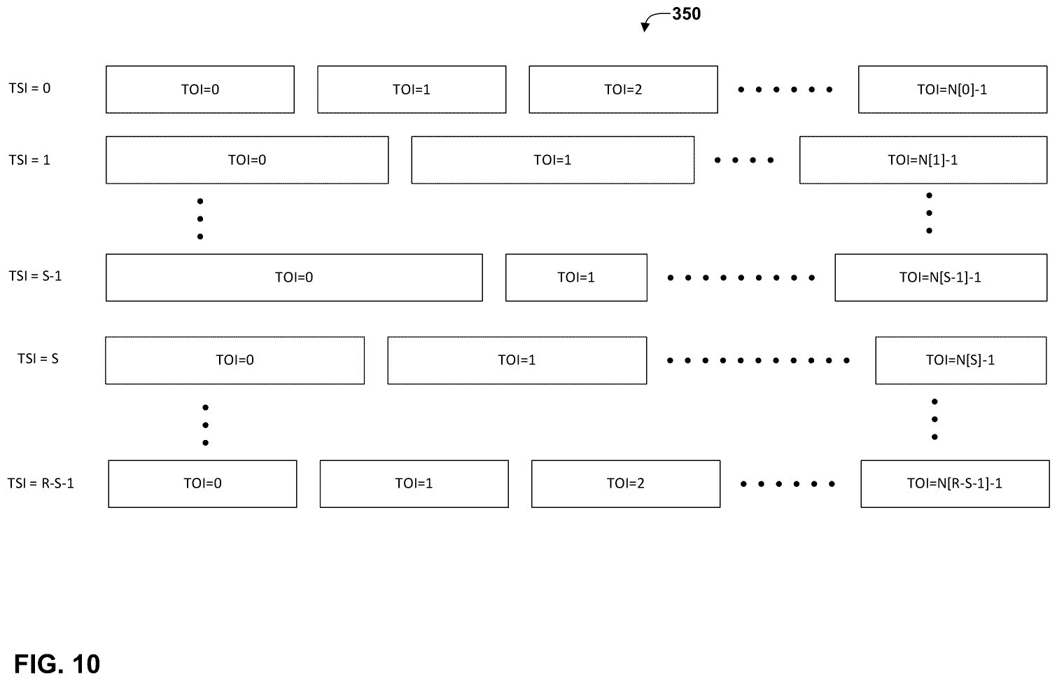

FIG. 10 is a conceptual diagram illustrating an example CMMF delivery session 350 including a collection of source and repair objects organized in different transport sessions. For the CMMF content delivery framework the following assumptions are made:
The FEC code is fully specified according to the definition in RFC5052
The FEC Code is systematic
The application objects are offered unmodified to be accessed by the CMMF receiver
Application data may follow the principles introduced above.
A mapping between application objects, repair objects and sessions exists using TOI and TSI and associated metadata may be provided in an ETI
The FEC Transport object may follow the principles discussed above and may be one of the following:
   A single application object with padding and size according to FIG. 7.
   An aggregation of a transport object to create and FEC super object according to FIG. 8
Encoding transport objects may include or be associated with any or all of the following information:
   FEC Object Transmission information
   Repair TOI and TSI (based on source TOI and TSI)
   Source objection information
   FEC Payload ID
   Repair symbols
Repair objects may be organized in sessions with a TSI and may have an assigned repair object header that includes common metadata applicable to all objects in the delivery session

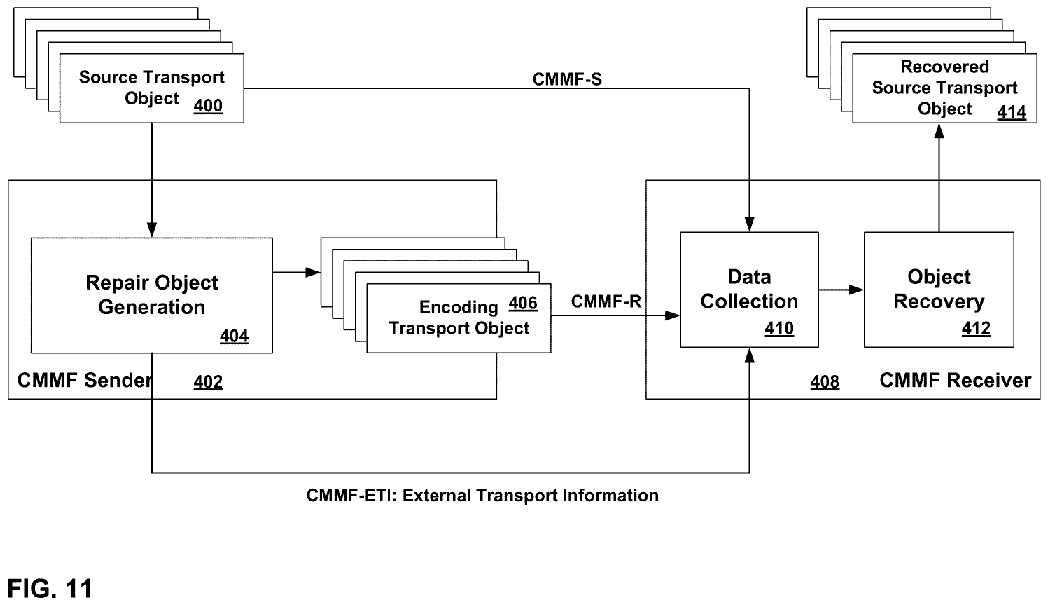

FIG. 11 is a conceptual diagram illustrating a CMMF reference architecture per techniques of this disclosure. In this example, the CMMF reference architecture includes source transport objects 400, CMMF sender 402 (e.g., content preparation device 20 and/or server device 60 of FIG. 1), CMMF receiver 408 (e.g., client device 40 of FIG. 1), and recovered source transport objects 414. In this example, CMMF sender 402 includes repair object generation unit 404 which forms encoding transport objects 406, which may include application objects and repair objects. CMMF receiver 408, in this example, includes data collection unit 410 and object recover unit 412. As discussed below, object recovery unit 412 uses application objects and repair objects to form recovered source transport objects 414. Data collection unit 410 may provide metrics regarding reception statistics or the like back to CMMF sender 402, which may be used to perform future FEC encoding (e.g., increasing or decreasing repair object frequency, size, number, or the like).

CMMF defines the generation of repair objects from source objects as shown in FIG. 11. These repair objects, together with the original source objects and External Transport Information (ETI) describing the location and relationship of the source and repair objects, may be provided to CMMF receiver 408 (e.g., client device 40 of FIG. 1). CMMF receiver 408, using the ETI as well as by collecting parts of source transport and repair transport objects, is able to recover the source transport objects and provide this to an application (e.g., a decoder and a presentation unit, as shown in client device 40 of FIG. 1). Details on CMMF sender and CMMF receiver architectures are provided below.

The reference points between CMMF sender 402 and CMMF receiver 408 include:
CMMF-ETI: This reference point provides External Transport Information (ETI) describing the location and relationship of the source and repair objects, may be provided to a CMMF receiver. Such information may for example be provided in a streaming manifest or any other file delivery manifest.
CMMF-S: This reference point provides the source transport objects. For CMMF, these objects are unmodified from original data. Parts of these objects may be used by object recovery to recover source objects.
CMMF-R: This reference point provides the repair transport objects.

Various deployment options may be used. In one example deployment option, only coded objects are provided. In another example, source objects are provided together with repair objects.

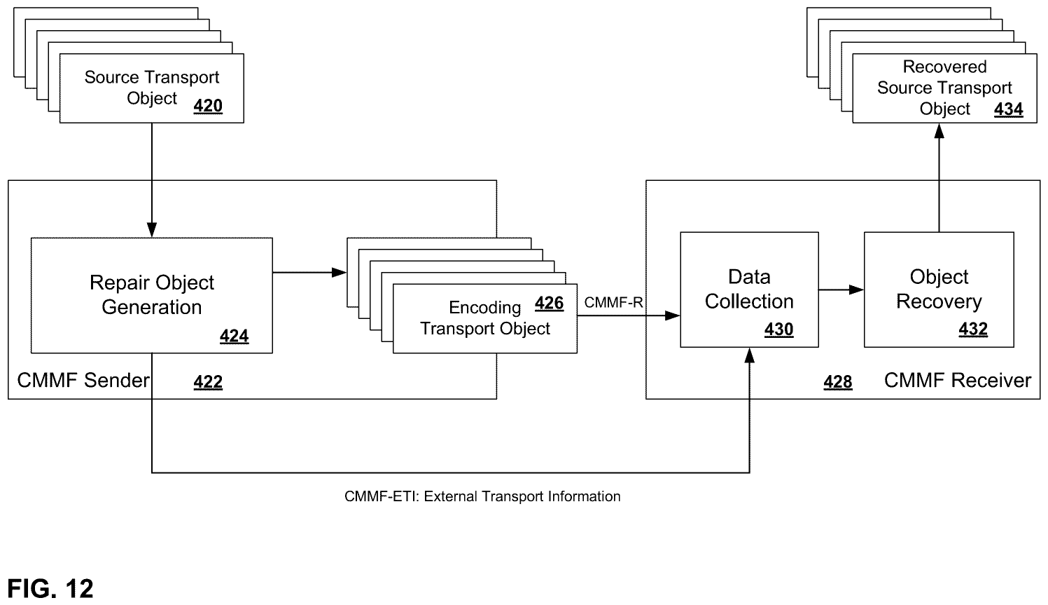

FIG. 12 is a conceptual diagram illustrating a deployment option for which CMMF receiver 428 only has access to encoding transport objects 426 via CMMF-R, based on the information in the CMMF-ETI. In particular, similar to FIG. 11, FIG. 12 depicts source transport objects 420, CMMF sender 422, repair object generation unit 424, encoding transport objects 426, CMMF receiver 428, data collection unit 430, object recovery unit 432, and recovered source transport objects 434. CMMF receiver 428 uses the information (encoding transport objects 426 and ETI information) to recover full objects. Sub-cases include 1) each encoding transport object includes sufficient information to recover the source transport objects; and 2) encoding transport objects are partial and may only by combination of multiple encoding objects, the source transport object can be recovered.

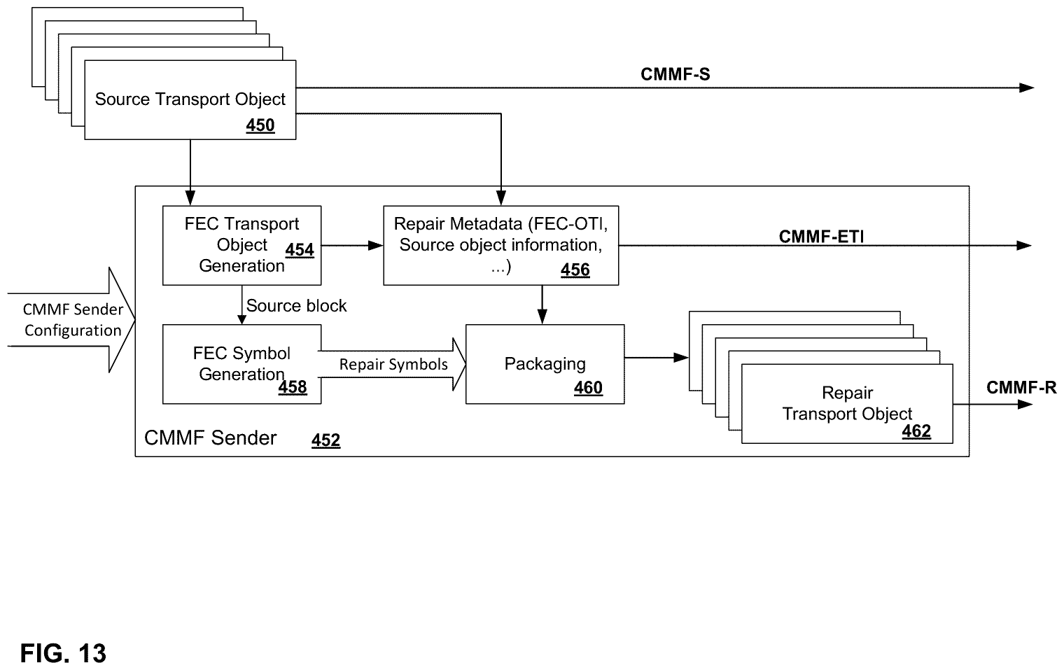

FIG. 13 is a conceptual diagram illustrating a deployment option for which CMMF sender 452 includes several processes in order to create repair objects. Like FIGS. 11 and 12, FIG. 13 depicts source transport objects 450, and CMMF sender 452. However, in this example, CMMF sender 452 includes FEC transport object generation unit 454, repair metadata source object information, FEC symbol generation unit 458, packaging unit 460, and repair transport objects 462. The elements of FIG. 13 may be incorporated in encapsulation unit 30 and/or request processing unit 70 of FIG. 1. CMMF sender 452 may include several processes in order to create repair objects as follows:
One or several source transport objects are provided to the FEC Transport Object generation. A source block may be formed based on the principles discussed above.
The source block is then provided to the FEC symbol generation process together with the FEC OTI which generates repair symbols
The repair symbols provided to the packaging together with the repair metadata
The packaging function creates one or multiple report objects based on the repair metadata and the repair symbols.

In order to properly operate the CMMF sender, configuration information may be provided to the CMMF sender. This includes, but may not be limited to:
FEC Object Transmission information
Source objects included in the FEC Transport object
Packaging options, for example how many repair objects are generated by source block, how many encoding symbols are included in each repair object, whether the repair object header is generated, or whether the repair objects are self-contained (i.e., have sufficient symbols to recover the source object).

The external transmission information allows the CMMF client to map an application request to a CMMF Receiver operations. Table 1 below provides a summary of the possible external transmission information. A specific JSON instantiation may be provided to provide ETI information to a receiver. However, there are other cases in the remainder of this disclosure that allow only a subset of the use cases, for which the information is provided in a simpler version.

TABLE 1
Summary of external transmission information

| Parameter | | Usage | Definition |
|---|---|---|---|
| Complete | | OD | If set to true, indicates that the external transmission |
| | | | information is complete. |
| Location | | O | Provides information, where the ETI information can be accessed. |
| Expires | | M | Provides information when this information is no longer valid and |
| | | | an update is needed, for example using a reload from Location. |
| Source Flow | | 1 . . . S | Provides 1 . . . S source flows |
| | TSI | M | Identifier of the source flow |

| | | |
|---|---|---|
| Object | 1 . . . N | Provides 1 . . . N objects in the source flow |

| | | |
|---|---|---|
| TOI | M | Transport object identifier, TOI value that represents the file |
| Size | M | Size of the transmission object carrying the file in bytes |
| Content-Type | | Media type of file |
| Encoding | | Encoding of file |
| Message Digest | | Message digest of file |
| Associated URI | | Name, Identification, and Location of file (specified by the URI) |
| Access URL | | The URL where the source object can be accessed. If the field is |
| | | not present, then the source flow is not directly accessible. |
| availabilityStartTime | | Provides a wall-clock time, when the resource is accessible |
| availabilityStartTime | | Provides a wall-clock time, when the resource ceases |
| | | to be available |
| <Additional metadata> | | May include cache or E-Tag metadata |
| CMAF Track | | Refers to a DASH Representation in an MPD or a Track |
| | | in an HLS manifest. |

| Repair Flow | | 1 . . . R | Provides 1 . . . R repair flows |
|---|---|---|---|
| | TSI | M | Identifier of the source flow |

| | | |
|---|---|---|
| Object | 1 . . . N | Provides 1 . . . N objects in the source flow |

| | | |
|---|---|---|
| TOI | M | |
| FEC-OTI | | FEC Object transmission information including the FEC Encoding |
| | | ID and, if relevant, the FEC Instance ID |
| includedSourceTOI | M | List of (TSI, TOI pairs) of the included source transport objects |
| | | forming a super objects. |
| | | Typically only a single pair is provided. |
| Content-Type | | Media Mime Type of the file |
| independent | OD | If set to TRUE, the file includes sufficient information to recover |
| | FALSE | all files included in this repair object. |
| includedSymbols | | Provides a list of the included FEC-Payload-ID and the number of |
| | | symbols included [SBN, ESI, K]. |
| | | Example: [0, 0, 1000] |
| Access URLs | | The URLs where the encoded object can be accessed. |
| availabilityStartTime | | Provides a wall-clock time, when the resource is accessible |
| availabilityEndTime | | Provides a wall-clock time, when the resource ceases |
| | | to be available |
| <Additional metadata> | | |

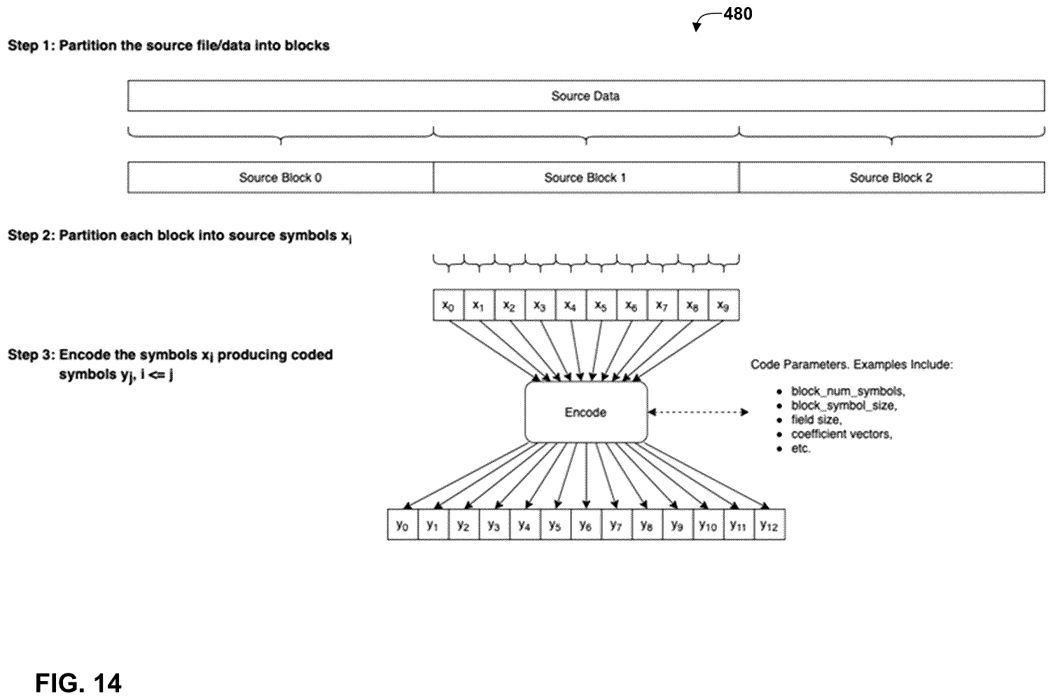

FIG. 14 is a conceptual diagram illustrating an example CMMF encoding process 480. Coded media representations carried within CMMF can be provisioned to serve a number of current and emerging use cases for media caching, distribution and delivery. For example:
Efficient multisource/multipath and/or multi-access network delivery.
Improved caching flexibility including efficient operations with open caching and peer-based systems.
Application-layer FEC for improved reliability in the presence of packet loss.

Applying linear, network or channel coding to source coded audio-visual media may follow these basic steps:
Partitioning of the source coded media data into block_count number of blocks. The value of block_count may be small (e.g., 1) or large depending on the size of the source data.
Partition each of the source coded media blocks into block_num_symbols worth of source symbols, xᵢ, where i is the index of the original source symbol in the block. Each symbol is of size block_symbol_size (in bytes), padding the final symbol with zero-valued bytes if necessary. The value of block_num_symbols is typically chosen based on the specific application and the code type used.
Encode the source symbols to create at least block_num_symbols worth of coded symbols (depending on coding type), yᵢ. The number of coded symbols generated is typically a function of the code type, use case, and network.

FIG. 14 depicts an example graphical representation of these steps. In this example, the original source (media) data file or stream is partitioned into three source blocks. Each source block is further partitioned into eight source symbols xᵢ, i=0, 1, . . . , block_num_symbols−1. These source symbols are then encoded by one of the supported CMMF code types to produce the resulting coded symbols yⱼ, j≥i.

The resulting coded symbols and associated metadata (coding parameters) may be formatted per the CMMF specification for storage, interchange or delivery. The coding parameter metadata is necessary to ensure that a compliant decoder can reconstruct the original (media) source symbols. Depending on the type of code utilized, the coding parameters can include an encoding symbol ID (EID), coefficient vector, pseudo-random number generator (PRNG) seed, etc. along with the block_num, block_symbol_size, etc.

The CMMF bitstream specifies and enables carriage and signaling of these essential coding parameters required for reconstruction of the original source symbols in a decoder.

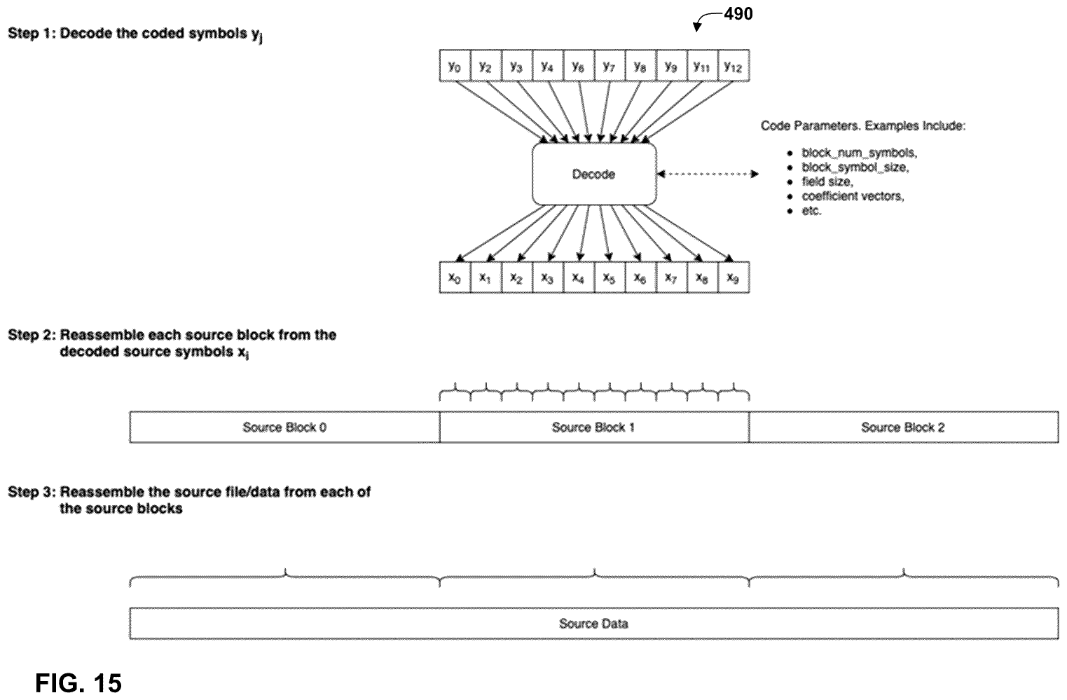

FIG. 15 is a conceptual diagram illustrating an example CMMF decoding process 490. The basic steps for decoding include:
For each block, decode the received coded symbols yⱼ recreating the source symbols xᵢ.
Concatenate each source symbol xᵢ and removing any zero-padding from the last symbol if necessary to reform the original source block.
Concatenate each of the reassembled source blocks to reform the original source coded media file/data.

In some examples, a FLUTE-based instantiation of the CMMF framework may be provided. The instantiation may be aligned with RFC 6726 and reuse some of the concepts defined 3GPP TS 26.346. In this case, the following restrictions may apply:
The ETI is a File Delivery Table (FDT) with minimum extensions to support CMMF.
Only a single Transport Session is used, and different encoded objects may be generated for a TOI
The encoding objects are compatible with ALC Payload formats with some additional headers and carry only repair symbols.
Only a single object is associated with a TOI, super objects are not used.

The FEC encoding ID may be set to 1 (Raptor), 5 (Reed-Solomon over GF 2\hat{ }\hat{ }8) or 6 (RaptorQ).

In the example of FLUTE, ETI information may be provided in an extended file delivery table. In order to provide relevant ETI information to the CMMF receiver a document including an extended File Delivery Table may be created to signal ETI information to the receiver as follows:
Attributes and elements from RFC 6726 may be re-used as follows:
   The Expires attribute expresses the validity of the FDT instance, i.e. how long the binding is valid.
   The Complete attribute, when TRUE, signals that this “FDT Instance” includes the set of “File” entries that exhausts both the set of files delivered so far and the set of files to be provided in the session.
   The following data may be set as default on instance level, or may set on file level. If set on file level, the instance level information is overwritten:
      The Content-Type attribute is included to express the type of the delivered file according to RFC2616.
      The Content-Encoding attribute is included to express the encoding of the delivered file. For details refer to RFC6726.
      The FEC-OTI-FEC-Encoding-ID attribute provides the “FEC Encoding ID” Object Transmission Information element defined in [RFC5052].
      The FEC-OTI-FEC-Instance-ID attribute provides the “FEC Instance ID” Object Transmission Information element defined in [RFC5052].
      The FEC-OTI-Maximum-Source-Block-Length attribute provides the “Maximum-Source-Block-Length” Object Transmission Information element defined in [RFC5052], if required by the FEC Scheme.
      The FEC-OTI-Max-Number-of-Encoding-Symbols attribute provides the “Max-Number-of-Encoding-Symbols” Object Transmission Information element defined in [RFC5052], if required by the FEC Scheme.
      The FEC-OTI-Max-Number-of-Encoding-Symbols attribute provides the “Max-Number-of-Encoding-Symbols” Object Transmission Information element defined in [RFC5052], if required by the FEC Scheme.
   The TOI value is a positive integer to express the Transport Object Identifier.
   The attribute Content-Location is used for the purpose defined in [RFC2616]
   The attribute Content-Length is used for the purpose defined in [RFC2616]
   The attribute Transfer-Length is used to carry the transfer length if the file is content encoded before transport (and thus the “Content-Encoding” attribute is used), e.g., if compression is applied before transport to reduce the number of octets that need to be transferred, then the transfer length is generally different.
   The Content-MD5 attribute is used for the purpose defined in [RFC2616].
The following new elements and attributes may be defined in order access the content
   A list of access objects assigned to a file, each defined by:
      An access-URL where the object can be accessed.
      A type attribute that provides the type of the transport object
      An attribute Included-Symbols that provides a list of included symbols in the encoded object. Together with interleaving type, it provides how the symbols are added.
      An attribute Independent-Object if set to TRUE, the file includes sufficient information to recover all files included in this repair object.
      An availability time window expressed by a an availabilityStartTime and an availabilityEndTime attribute indicating when the URL is available.

An extended FDT schema is provided below as one example that may be used to address the support of such a document:

```
<?xml version=“1.0” encoding=“UTF-8”?>
<xs:schema
xmlns=“urn:ETSI:CMMF:2023:EFD”
      xmlns:xs=“http://www.w3.org/2001/XMLSchema”
      targetNamespace=“urn: ETSI:CMMF:2023:EFD”
      elementFormDefault=“qualified”
      version=“1”>
      <xs:element name=“FDT-Instance” type=“FDT-InstanceType”/>
      <xs:complexType name=“FDT-InstanceType”>
            <xs:sequence>
                  <xs:element name=“File” type=“FileType”
maxOccurs=“unbounded”/>
                  <xs:element name=“schemaVersion” type=“xs:unsignedInt”/>
                  <xs:element name=“delimiter” type=“DelimiterType”/>
                  <xs:any namespace=“##other” processContents=“skip”
minOccurs=“0” maxOccurs=“unbounded”/>
            </xs:sequence>
            <xs:attribute name=“Expires” type=“xs:dateTime” use=“required”/>
            <xs:attribute name=“Complete” type=“xs:boolean” use=“optional”/>
            <xs:attribute name=“Content-Type” type=“xs:string” use=“optional”/>
            <xs:attribute name=“Content-Encoding” type=“xs:string”
use=“optional”/>
            <xs:attribute name=“FEC-OTI-FEC-Encoding-ID”
type=“xs:unsignedLong” use=“optional”/>
            <xs:attribute name=“FEC-OTI-FEC-Instance-ID”
type=“xs:unsignedLong” use=“optional”/>
            <xs:attribute name=“FEC-OTI-Maximum-Source-Block-Length”
type=“xs:unsignedLong” use=“optional”/>
            <xs:attribute name=“FEC-OTI-Encoding-Symbol-Length”
type=“xs:unsignedLong” use-“optional”/>
            <xs:attribute name=“FEC-OTI-Max-Number-of-Encoding-Symbols”
type=“xs:unsignedLong” use=“optional”/>
            <xs:attribute name=“FEC-OTI-Scheme-Specific-Info”
type=“xs:base64Binary” use=“optional”/>
            <xs:anyAttribute processContents=“skip”/>
      </xs:complexType>
      <xs:complexType name=“FileType”>
            <xs:sequence>
                  <xs:element name=“EncodedObjects”
type=“EncodedObjectType” minOccurs=“1” maxOccurs=“unbounded”/>
                  <xs:element name=“delimiter” type=“DelimiterType”/>
                  <xs:any namespace=“##other” processContents=“skip”
minOccurs=“0” maxOccurs=“unbounded”/>
            </xs:sequence>
            <xs:attribute name=“Content-Location” type=“xs:anyURI”
use=“required”/>
            <xs:attribute name=“TOI” type=“xs:positiveInteger” use=“required”/>
            <xs:attribute name=“Content-Length” type=“xs:unsignedLong”
use=“optional”/>
            <xs:attribute name=“Transfer-Length” type=“xs:unsignedLong”
use=“optional”/>
            <xs:attribute name=“Content-Type” type=“xs:string” use=“optional”/>
            <xs:attribute name=“Content-Encoding” type=“xs:string”
use=“optional”/>
            <xs:attribute name=“Content-MD5” type=“xs:base64Binary”
use=“optional”/>
            <xs:attribute name=“FEC-OTI-FEC-Encoding-ID”
type=“xs:unsignedLong” use=“optional”/>
            <xs:attribute name=“FEC-OTI-FEC-Instance-ID”
type=“xs:unsignedLong” use=“optional”/>
            <xs:attribute name=“FEC-OTI-Maximum-Source-Block-Length”
type=“xs:unsignedLong” use=“optional”/>
            <xs:attribute name=“FEC-OTI-Encoding-Symbol-Length”
type=“xs:unsignedLong” use=“optional”/>
            <xs:attribute name=“FEC-OTI-Max-Number-of-Encoding-Symbols”
type=“xs:unsignedLong” use=“optional”/>
            <xs:attribute name=“FEC-OTI-Scheme-Specific-Info”
type=“xs:base64Binary” use=“optional”/>
            <xs:anyAttribute processContents=“skip”/>
      </xs:complexType>
      <xs:complexType name=“EncodedObjectType”>
            <xs:simpleContent>
                  <xs:extension base=“xs:anyURI”>
                        <xs:attribute name-“interleaving”
type=“interleavingType”/>
                        <xs:attribute name=“includedSymbols” type=“xs:string”/>
                        <xs:attribute name=“objectType” type=“ObjectTypeType”
default=“source”/>
                        <xs:attribute name=“independentObject”
type=“xs:boolean” default=“false”/>
                        <xs:attribute name=“availabilityStartTime”
type=“xs:dateTime”/>
                        <xs:attribute name=“availabilityEndTime”
type=“xs:dateTime”/>
                        <xs:anyAttribute namespace=“##other”
processContents=“skip”/>
                  </xs:extension>
            </xs:simpleContent>
            <xs:anyAttribute processContents=“skip”/>
      </xs:complexType>
      <xs:simpleType name=“DelimiterType”>
            <xs:restriction base=“xs:byte”/>
      </xs:simpleType>
      <xs:simpleType name=“ObjectTypeType”>
            <xs:restriction base=“xs:string”>
                  <xs:enumeration value=“source”/>
                  <xs:enumeration value=“self-contained”/>
                  <xs:enumeration value=“partial”/>
            </xs:restriction>
      </xs:simpleType>
      <xs:simpleType name=“interleavingType”>
            <xs:restriction base=“xs:string”>
                  <xs:enumeration value=“symbol-list”/>
                  <xs:enumeration value=“list-sbn”/>
                  <xs:enumeration value=“sequential-sbn”/>
                  <xs:enumeration value-“interleaved”/>
                  <xs:enumeration value=“spread”/>
            </xs:restriction>
      </xs:simpleType>
</xs:schema>
```

An Extended FDT Description (EFD) is a document that may contain metadata required by a CMMF Client to access Objects and to provide the CMMF session. The EFD may be an XML document formatted according to the XML schema provided above.

The EFD may be authored such that, after XML attributes or elements in the EFD namespace but not in the XML schema documented above are removed, the result is a valid XML document formatted according to that schema and that conforms to this disclosure. In addition, the EFD may be authored such that, after XML attributes or elements in the other namespaces than the EFD namespace are removed, the result is a valid XML document formatted according to that schema and that conforms to this document. If CMMF Clients remove all XML attributes and elements from the EFD in this namespace and in other namespaces that are not in the XML schema documented above, the EFD results in a valid XML document which complies with this document.

The MIME type of the EFD document is defined below. The encoding of the EFD may be UTF-8 as defined in IETF RFC 3629. All data provided in extension namespaces may be UTF-8 as defined in IETF RFC 3629. If binary data needs to be added, it may be included in Base64 as described in IETF RFC 4648 within a UTF-8 encoded element with a proper name space or identifier, such that an XML parser knows how to process or ignore it.

If the EFD is delivered over HTTP, then the EFD document may be transfer encoded for transport, as described in IETF RFC 7230.

An IANA Registration for EFD may be as follows. The MIME type and subtype may be defined as follows:
MIME media type name: application
MIME subtype name: cmmf-efd+xml
Required parameters: None
Optional parameters: None.
Encoding considerations: UTF-8
Security considerations: The EFD contains references to other resources. It is coded in XML, and there are risks that deliberately malformed XML can cause security issues. In addition, an EFD can be authored that causes receiving clients to access other resources; if widely distributed, this can be used to cause a denial-of-service attack.
   The EFD format does not incorporate any active or executable content. However, other forms of material from outside sources can be referenced by an EFD, and this material can contain active or executable content. Such material is expected to be identified by its own MIME type, and the security considerations of that format should be taken into account.
   If operating in an insecure environment and required by the content/service provider, elements and attributes of EFD may be encrypted to protect their confidentiality by using the syntax and processing rules specified in the W3C Recommendation “XML Encryption Syntax and Processing”.
   If operating in an insecure environment and required by the content/service provider, the digital signing and verification procedures specified in the W3C Recommendation “XML Signature Syntax and Processing” may be used to protect data origin authenticity and integrity of the EFD.
Interoperability considerations: The specification defines a platform-independent expression of a document, and it is intended that wide interoperability can be achieved.
Published specification: ETSI TS XXXX
Applications which use this media type: Various
Additional information:
File extension(s): efd
Intended usage: common
Other information/general comment: None
Author/Change controller: ETSI

Transport object formats may include encoding object formats using well-defined ALC Payload formats, with some additional headers, and may carry only repair symbols as documented. Three example different types of transport objects are defined as follows:
Source transport objects, i.e., unmodified source objects.
Partial encoding objects, i.e., objects that only include encoding symbols but are not sufficient to recover the object.
Self-contained encoding objects, i.e., objects that include encoding symbols and are sufficient to recover the object and all metadata.

If the EFD signals a type equal to “source”, then the object referenced in the Access-URL may be the original source object. The value of the Access-URL may be identical to the value of the Content-Location, if the application can also access the object at the original location. The source object as a whole or partially may be used by the CMMF receiver to reconstruct the application object, possibly in combination with encoded objects.

The following example syntax and semantics provide the details of collecting symbols in a data structure. Table 2 provides a summary of the encoding symbol syntax including an index and mapping of the symbols as well as the collection of coded symbols as well.

TABLE 2
Encoding Symbol Syntax

| | | |
|---|---|---|
| Syntax | Encoding | Clause |

| | |
|---|---|
| encoding_symbols( ) | |
| { | |
| es_header( ) | |
| for (i=0; i < | |
| number_symbols; i++) { | v(symbol_size) |
| coded_symbol[i]; | |
| } | |
| } | |

Table 3 below provides the syntax of the encoding symbol header. Different header structures as defined in order to provide the order and details of the included symbols from different source blocks, referred to with their source block number SBN and the encoding symbol id (ESI). Specifically:
Table 4 lists the Encoding Symbol Header that provides the SBN and ESI for each symbol individually in the header.
Table 5 lists the Encoding Symbol Header that provides for one source block with a specified SNB the ESI for each included symbol individually in the header.
Table 6 lists the Encoding Symbol Header that provides the index of the first symbol and the number of symbols for one source block with a specified SNB. The ESI included are then from first_esi to first_esi+number symbols−1.
Table 7 lists the Encoding Symbol Header for an interleaved version of the source blocks. It provides the index of the first symbol and the first sbn and the number of symbols.
Table 8 lists the Encoding Symbol Header for a spread version of source symbols where spreading is done first with the first source block, then with the second source block, etc.

TABLE 3
Encoding Symbol Header

| | | |
|---|---|---|
| Syntax | Encoding | Clause |

| | |
|---|---|
| es_header( ) | |
| { | u(4) |
| es_header_type | |
| switch(header_type) | |
| { | |
| case HT_LIST: | |
| es_header_list( ) | |
| break | |
| case HT_LIST_ESI: | |
| es_header_list_esi( ) | |
| break | |
| case HT_SEQUENCE_ESI: | |
| es_header_sequence_esi( ) | |
| break | |
| case HT_INTERLEAVED_SBN: | |
| es_header_interleaved_sbn( ) | |
| break | |
| case HT_SPREAD: | |
| es_ht_spread( ) | |
| break | |
| default: | |
| UNKNOWN | v(subatom_size × 8) |
| } | |

TABLE 4
Encoding Symbol Header List

| | | |
|---|---|---|
| Syntax | Encoding | Clause |

| | |
|---|---|
| es_header_list( ) | |
| { | |
| number_symbols | u(32) |
| for (i=0; i < | |
| number_symbols; i++) { | |
| sbn; | u(8) |
| esi; | u(24) |
| } | |
| } | |

TABLE 5
Encoding Symbol Header List for one source block

| | | |
|---|---|---|
| Syntax | Encoding | Clause |

| | |
|---|---|
| es_header_list_sbn( ) | |
| { | |
| number_symbols | u(32) |
| sbn | u(8) |
| for (i=0; i < number_symbols; | |
| i++) { | |
| esi; | u(24) |
| } | |
| } | |

TABLE 6
Encoding Symbol Header List with sequential ESI

| | | |
|---|---|---|
| Syntax | Encoding | Clause |

| | |
|---|---|
| es_header_sequence_esi( ) | |
| { | |
| number_symbols | u(32) |
| sbn | u(8) |
| first_esi | u(24) |
| } | |

TABLE 7
Encoding Symbol Header with ESIs Interleaved

| | | |
|---|---|---|
| Syntax | Encoding | Clause |

| | |
|---|---|
| es_header_interleaved_sbn( ) | |
| { | |
| number_symbols | u(32) |
| number_sbn | u(8) |
| for (i=0; i < number_sbn; | |
| i++) { | |
| sbn; | u(24) |
| } | |
| first_sbn | u(8) |
| first_esi | u(24) |
| } | |

TABLE 8
Encoding Symbol Header with ESIs Spread

| | | |
|---|---|---|
| Syntax | Encoding | Clause |

| | |
|---|---|
| es_header_spread ( ) | |
| { | |
| number_symbols | u(32) |
| number_spread | u(8) |
| number_sbn | u(8) |
| for (i=0; i < number_sbn; | |
| i++) { | |
| sbn; | |
| } | |
| first_sbn | u(8) |
| first_esi | u(24) |
| } | |

Partial encoding objects may be CMMF objects that include symbols related to source objects. Information related to the objects may be carried in the EFD. Example syntax of a partial encoding object is shown in Table 9.

TABLE 9
Partial encoding object

| | | |
|---|---|---|
| Syntax | Encoding | Clause |

```
partialEncodingObject( )
{
  sync( )
  encoding_symbols( )
}
```

An encoding header may provide EFD information in binary format. The information may include FEC OTI information and information related to the file. Strings may be encoded using utf8( ), referring to UTF-8 string as defined in RFC 3629, null-terminated. Table 10 below shows an example encoding header syntax.

TABLE 10
Encoding Symbol Header with ESIs interleaved

| | | |
|---|---|---|
| Syntax | Encoding | Clause |

| | |
|---|---|
| encoding_object_header( ) | |
| { | |
| fec_encoding_id | u(8) |
| fec_payload_id | v(32) |
| fec_oti_common | v(64) |
| fec_oti_specific | v(32) |
| content_length | u(64) |
| num_cl_bytes | u(16) |
| content_location | utf8(8* |
| | number_cl_bytes) |
| num_ct_bytes | u(16) |
| content_type | utf8(8* |
| | number_ct_bytes) |
| num_oh_bytes | u(32) |
| object_header_bytes | utf8(8* |
| | number_oh_bytes) |
| } | |

Self-contained encoding objects may be objects that allow for recovery of the source object together with the associated metadata from the object itself. By this, a self-contained encoding object may include the sync information, encoding headers, as well as encoding symbols, whereby the object may include sufficient encoding symbols such that the object can be recovered. Example syntax for self-contained encoding objects are shown in Table 11.

TABLE 11
Self-Contained Encoding Objects

| | | |
|---|---|---|
| Syntax | Encoding | Clause |

```
selfContainedEncodingObject( )
{
  sync( )
  encoding_header( )
  encoding_symbols( )
}
```

Example offerings are shown below. In a first example, a single file is offered including a source object and a partial encoding object. In this example, a single file is offered, being an MP4 file compatible to some MIME type and in addition for this file, 3 partial repair objects are provided that each contains 500 symbols of a single source block. The files are only partial and the information is provided in the extended FDT. The FDT is complete, i.e., no new information is provided.

```
<?xml version=“1.0” encoding=“UTF-8”?>
<FDTInstance xmlns:xsi=“http://www.w3.org/2001/XMLSchema-instance”
      xmlns=“urn: ETSI:CMMF:2023:FDT”
      xsi:schemaLocation=“urn:ETSI:CMMF:2023:FDT extendedFDT.xsd”
      Expires=“2024-05-30T09:30:10Z”
      Complete=“true”
      ContentType=“video/mp4 codecs=‘avc1.42c01e,mp4a.40.29’
profiles=‘iso8’”
      FEC-Encoding-ID=“6”
      FEC-Encoding-Symbol-Length=“64”>
      <File ContentLocation=“https://example.com/efd1.mp4”
          TOI=“0”
          Content-Length=“64000”>
              <EncodedObjects type=“source”
independentObject=“true”>https://example.com/efd1.mp4</EncodedObjects>
              <EncodedObjects type=“partial”
                      interleavingType=“sequential-sbn”
includedSymbols=“500,0,1001”>https://example.com/part1.cmf</EncodedObjec
ts>
            <EncodedObjects type=“partial”
                    interleavingType=“sequential-sbn”
includedSymbols=“500,0,1501”>https://example.com/part2.cmf</EncodedObjec
ts>
            <EncodedObjects type=“partial”
                    interleavingType=“sequential-sbn”
includedSymbols=“500,0,2001”>https://example.com/part3.cmf</EncodedObjec
ts>
      </File>
</FDTInstance>
```

As another example offering, multiple files may be offered, including self-contained objects including source symbols. In this example, two files are provided, both encoded with RaptorQ and symbol length 64. In this case, only self-contained objects are provided, and these symbols are spread such that symbols 0, 3, 6 . . . are contained in one file, 1, 4, 7, . . . are contained in another file, and 2, 5, 8, . . . are yet included in another file. At the same time, each encoded object is self-contained and can represent the files.

```
<?xml version=“1.0” encoding=“UTF-8”?>
<FDTInstance xmlns:xsi=“http://www.w3.org/2001/XMLSchema-instance”
      xmlns=“urn:ETSI:CMMF:2023:FDT”
      xsi:schemaLocation=“urn:ETSI:CMMF:2023:FDT extendedFDT.xsd”
      Expires=“2024-05-30T09:30:10Z”
      Complete=“true”
      FEC-OTI-FEC-Encoding-ID=“6”
      FEC-OTI-Encoding-Symbol-Length=“64”>
      <File ContentLocation=“https://example.com/efd1-video.mp4”
              ContentType=“video/mp4 codecs=‘avc1.42c01e’ profiles=‘iso8’”
          TOI=“0”
          Content-Length=“64000”>
              <EncodedObjects type=“self-contained”
                      interleavingType=“spread”
                      independentObject=“true”
includedSymbols=“1001,3,1,0,0,0”>https://example.com/part1-
video.cmf</EncodedObjects>
                  <EncodedObjects type=“self-contained”
                          interleavingType=“spread”
                          independentObject=“true”
includedSymbols=“1001,3,1,0,0,1”>https://example.com/part2-
video.cmf</EncodedObjects>
                  <EncodedObjects type=“self-contained”
                          interleavingType=“spread”
                          independentObject=“true”
includedSymbols=“1001,3,1,0,0,2”>https://example.com/part3-
video.cmf</EncodedObjects>
            </File>
            <File ContentLocation=“https://example.com/efd1-audio.mp4”
                    ContentType=“audio/mp4 codecs=‘mp4a.40.29’
profiles=‘iso8’”
              TOI=“1”
              Content-Length=“4800”>
                  <EncodedObjects type=“self-contained”
                          interleavingType=“spread”
                          independentObject=“true”
includedSymbols=“80,3,1,0,0,0”>https://example.com/part1-
audio.cmf</EncodedObjects>
                  <EncodedObjects type=“self-contained”
                          interleavingType=“spread”
                          independentObject=“true”
includedSymbols=“80,3,1,0,0,1”>https://example.com/part2-
audio.cmf</EncodedObjects>
                  <EncodedObjects type=“self-contained”
                          interleavingType=“spread”
                          independentObject=“true”
includedSymbols=“80,3,1,0,0,2”>https://example.com/part3-
audio.cmf</EncodedObjects>
      </File>
</FDTInstance>
```

In another example, live streaming is used. In this example, Initialization Segments/CMAF Headers as 4 segments, 2 for video and 2 for audio are provided. Encoding is preset to RaptorQ with symbol length 64. The EFD will expire and reloads are expected. The files are documented with availability times. Media segments are provided in original version as well as in encoded versions. For video, the source object and 3 partial objects are provided. For audio, the source object and a single partial object is provided. The example shows, as well, that optimizations are possible, for example:
Combination of the information about source objects and encoded objects into a streaming manifest
Do templating of information to avoid listing URLs
Do defaulting on hierarchy levels
Provide the abibility to operate with patch and diff updates.

```
<?xml version=“1.0” encoding=“UTF-8”?>
<FDTInstance xmlns:xsi=“http://www.w3.org/2001/XMLSchema-instance”
      xmlns=“urn: ETSI:CMMF:2023:FDT”
      xsi:schemaLocation=“urn:ETSI:CMMF:2023:FDT extendedFDT.xsd”
      Expires=“2023-08-08T9:30:18Z”
      Complete=“false”
      FEC-OTI-FEC-Encoding-ID=“6”
      FEC-OTI-Encoding-Symbol-Length=“64”>
  <File ContentLocation=“https://example.com/video/init-video.mp4”
      ContentType=“video/mp4 codecs=‘avc1.42c01e’ profiles=‘cmfc’”
      TOI=“0”
      Content-Length=“2000”>
          <EncodedObjects type=“source”
                availabilityStartTime=“2023-08-
08T9:30:10Z”>https://example.com/video/init-video.mp4</EncodedObjects>
  </File>
  <File ContentLocation=“https://example.com/init-audio.mp4”
      ContentType=“audio/mp4 codecs=‘mp4a.40.29’ profiles=‘cmfc’”
      TOI=“1”
      Content-Length=“1500”>
          <EncodedObjects type=“source”
                availabilityStartTime=“2023-08-
08T9:30:10Z”>https://example.com/video/init-audio.mp4</EncodedObjects>
  </File>
  <File ContentLocation=“https://example.com/video/video001.m4s”
      ContentType=“video/m4s”
      TOI=“2”
      Content-Length=“12000”>
          <EncodedObjects type=“source”
                independentObject=“true”
                availabilityStartTime=“2023-08-
08T9:30:10Z”>https://example.com/video/video001.m4s</EncodedObjects>
          <EncodedObjects type=“partial”
                interleavingType=“sequential-sbn”
                includedSymbols=“100,0,188”
                availabilityStartTime=“2023-08-
08T9:30:10Z”>https://example.com/video/video001-1.cmf</EncodedObjects>
          <EncodedObjects type=“partial”
                interleavingType=“sequential-sbn”
                includedSymbols=“100,0,288”
                availabilityStartTime=“2023-08-
08T9:30:10Z”>https://example.com/video/video001-2.cmf</EncodedObjects>
          <EncodedObjects type=“partial”
                interleavingType=“sequential-sbn”
                includedSymbols=“100,0,388”
                availabilityStartTime=“2023-08-
08T9:30:10Z”>https://example.com/video/video001-3.cmf</EncodedObjects>
  </File>
  <File ContentLocation=“https://example.com/audio/audio001.m4s”
      ContentType=“audio/m4s”
      TOI=“3”
      Content-Length=“2000”>
          <EncodedObjects type=“source”
                independentObject=“true”
                availabilityStartTime=“2023-08-
08T9:30:10Z”>https://example.com/audio/audio001.m4s</EncodedObjects>
          <EncodedObjects type=“partial”
                interleavingType=“sequential-sbn”
                includedSymbols=“32,0,32”
                availabilityStartTime=“2023-08-
08T9:30:10Z”>https://example.com/audio/audio001-1.cmf</EncodedObjects>
  </File>
  <File ContentLocation=“https://example.com/video/video002.m4s”
      ContentType=“video/m4s”
      TOI=“4”
      Content-Length=“14000”>
          <EncodedObjects type=“source”
                independentObject=“true”
                availabilityStartTime=“2023-08-
08T9:30:14Z”>https://example.com/video/video002.m4s</EncodedObjects>
          <EncodedObjects type=“partial”
                interleavingType=“sequential-sbn”
                includedSymbols=“100,0,219”
                availabilityStartTime=“2023-08-
08T9:30:14Z”>https://example.com/video/video001-1.cmf</EncodedObjects>
          <EncodedObjects type=“partial”
                interleavingType=“sequential-sbn”
                includedSymbols=“100,0,319”
                availabilityStartTime=“2023-08-
08T9:30:14Z”>https://example.com/video/video001-2.cmf</EncodedObjects>
          <EncodedObjects type=“partial”
                interleavingType=“sequential-sbn”
                includedSymbols=“100,0,419”
                availabilityStartTime=“2023-08-
08T9:30:14Z”>https://example.com/video/video001-3.cmf</EncodedObjects>
  </File>
  <File ContentLocation=“https://example.com/audio/audio001.m4s”
      ContentType=“audio/m4s”
      TOI=“3”
      Content-Length=“2000”>
          <EncodedObjects type=“source”
                independentObject=“true”
                availabilityStartTime=“2023-08-
08T9:30:10Z”>https://example.com/audio/audio001.m4s</EncodedObjects>
          <EncodedObjects type=“partial”
                interleavingType=“sequential-sbn”
                includedSymbols=“32,0,32”
                availabilityStartTime=“2023-08-
08T9:30:10Z”>https://example.com/audio/audio001-1.cmf</EncodedObjects>
  </File>
  <File ContentLocation=“https://example.com/audio/audio002.m4s”
      ContentType=“audio/m4s”
      TOI=“3”
      Content-Length=“3000”>
          <EncodedObjects type=“source”
                independentObject=“true”
                availabilityStartTime=“2023-08-
08T9:30:14Z”>https://example.com/audio/audio002.m4s</EncodedObjects>
          <EncodedObjects type=“partial”
                interleavingType=“sequential-sbn”
                includedSymbols=“48,0,48”
                availabilityStartTime=“2023-08-
08T9:30:14Z”>https://example.com/audio/audio002-2.cmf</EncodedObjects>
  </File>
</FDTInstance>
```

Potential receiver operations may be as follows. Once a CMMF receiver receives an EFD, the receiver may access different versions of the same source object. The details are implementation specific. However, some potential operation is provided below.

If multiple encoded objects are available for a single source object, the CMMF receiver may download multiple transport objects in parallel until a sufficient set of symbols are received to recover the source object. The download may be terminated in case a sufficient set of symbols is available. Determining a sufficient set depends on the FEC code in use, but for RaptorQ, a sufficient set of each source block are K+2 independent source symbols, where K is the source block size.

If the objects are available in spread format including the source symbols, all objects may be download in parallel and the systematic symbols may be used to gradually recover the object from the start.

If the source objects are available and downloaded partially, the CMMF receiver may translate the available partial data into correct source symbols and may use received repair symbols for the purpose of recovering the entire object.

In an extended deployment option, an RFC5052 based instantiation of the CMMF framework as defined in clause 4.2 to 4.4 is provided. The instantiation may be aligned with RFC 5052 and may reuse some of the concepts defined in ROUTE as defined in RFC923:
For the ETI, a further extended XML-based manifest is defined that mimics the data model for ROUTE and as defined above, but builds on the schema above.
Multiple Transport Sessions may be used.
The encoding objects are compatible with ALC Payload formats with some additional headers and carry only repair symbols as documented above.
Super-objects may be used.
The encoding object types as defined above may be re-used.
The FEC encoding ID may be set to 6 (RaptorQ).

A transport session based delivery may be provided in a Transport Session Description. The Transport Session Description (TSD) is a document that contains metadata required by a CMMF Client to access Objects and to provide the CMMF session. The TSD is an XML document that shall be formatted according to the XML schema provided above. An XML schema for the TSD may be as follows:

```
<?xml version=“1.0” encoding=“UTF-8”?>
<xs:schema
xmlns=“urn: ETSI:CMMF:2023: TSD”
      xmlns:xs=“http://www.w3.org/2001/XMLSchema”
      targetNamespace=“urn:ETSI:CMMF:2023:TSD“
      elementFormDefault=“qualified”
      version=“1”>
      <xs:element name=“TSD” type=“TSDType”/>
      <xs:complexType name=“TSDType”>
            <xs:sequence>
                  <xs:element name=“SourceFlow”
type=“SourceFlowType” minOccurs=“1” maxOccurs=“unbounded”/>
                  <xs:element name=“RepairFlow”
type=“RepairFlowType” minOccurs=“1” maxOccurs=“unbounded”/>
                  <xs:element name=“delimiter” type=“DelimiterType”/>
                  <xs:any namespace=“##other” processContents=“skip”
minOccurs=“0” maxOccurs=“unbounded”/>
            </xs:sequence>
            <xs:attribute name=“Content-Location” type=“xs:anyURI”
use=“optional”/>
            <xs:attribute name=“Complete” type=“xs:boolean”
use=“optional” default=“true”/>
            <xs:attribute name=“Expires” type=“xs:dateTime”
use=“optional”/>
      </xs:complexType>
      <xs:complexType name=“SourceFlowType”>
            <xs:choice>
                  <xs:element name=“Object” type=“ObjectType”
minOccurs=“0” maxOccurs=“unbounded”/>
                  <xs:element name=“Representation”
type=“Representation Type” minOccurs=“0” maxOccurs=“1”>
                  <xs:element name=“delimiter” type=“DelimiterType”/>
                  <xs:any namespace=“##other” processContents=“skip”
minOccurs=“0” maxOccurs=“unbounded”/>
            </xs:choice>
            <xs:attribute name=“TSI” type=“xs:positiveInteger”
use=“required”/>
      </xs:complexType>
      <xs:complexType name=“ObjectType”>
            <xs:sequence>
                  <xs:element name=“Access-URL” type=“xs:anyURI”
minOccurs=“1” maxOccurs=“unbounded”/>
                  <xs:element name=“delimiter” type=“DelimiterType”/>
                  <xs:any namespace=“##other” processContents=“skip”
minOccurs=“0” maxOccurs=“unbounded”/>
            </xs:sequence>
            <xs:attribute name=“Content-Location” type=“xs:anyURI”
use=“required”/>
            <xs:attribute name=“TOI” type=“xs:positiveInteger“
use=“required”/>
            <xs:attribute name=“Content-Length” type=“xs:unsignedLong”
use=“optional”/>
            <xs:attribute name=“Transfer-Length” type=“xs:unsignedLong”
use=“optional”/>
            <xs:attribute name=“Content-Type” type=“xs:string”
use=“optional”/>
            <xs:attribute name=“Content-Encoding” type=“xs:string”
use=“optional”/>
            <xs:attribute name=“Content-MD5” type=“xs:base64Binary”
use=“optional”/>
            <xs:anyAttribute processContents=“skip”/>
      </xs:complexType>
      <xs:complexType name=“RepresentationType”>
            <xs:simpleContent>
                  <xs:extension base=“xs:anyURI”>
                        <xs:attribute name=“firstToi”
type=“xs:unsignedLong”/>
                        <xs:anyAttribute namespace=“##other”
processContents=“skip”/>
                  </xs:extension>
            </xs:simpleContent>
            <xs:anyAttribute processContents=“skip”/>
      </xs:complexType>
      <xs:complexType name=“RepairFlowType”>
            <xs:choice>
                  <xs:element name=“RepairObject“
type=“RepairObjectType” minOccurs=“0” maxOccurs=“unbounded”/>
                  <xs:element name=“RepairTemplate”
type=“RepairTemplateType” minOccurs=“0” maxOccurs=“1”>
                  <xs:element name=“delimiter” type=“DelimiterType”/>
                  <xs:any namespace=“##other” processContents=“skip”
minOccurs=“0” maxOccurs=“unbounded”/>
            </xs:choice>
            <xs:attribute name=“TSI” type=“xs:positiveInteger”
use=“required”/>
            <xs:attribute name=“FEC-OTI-FEC-Encoding-ID”
type=“xs:unsignedLong” use=“optional”/>
            <xs:attribute name=“FEC-OTI-FEC-Instance-ID”
type=“xs:unsignedLong” use=“optional”/>
            <xs:attribute name=“FEC-OTI-Maximum-Source-Block-Length”
type=“xs:unsignedLong” use=“optional”/>
            <xs:attribute name=“FEC-OTI-Encoding-Symbol-Length”
type=“xs:unsignedLong” use=“optional”/>
            <xs:attribute name=“FEC-OTI-Max-Number-of-Encoding-
Symbols” type=“xs:unsignedLong” use=“optional”/>
            <xs:attribute name=“FEC-OTI-Scheme-Specific-Info”
type=“xs:base64Binary” use=“optional”/>
      </xs:complexType>
      <xs:complexType name=“RepairObjectType”>
            <xs:simpleContent>
                  <xs:extension base=“xs:anyURI”>
                        <xs:attribute name=“includedSourceTOI”
type=“xs:string”/>
                        <xs:attribute name=“includedSymbols”
type=“xs:string”/>
                        <xs:attribute name=“interleaving”
type=“xs:interleavingType”/>
                        <xs:attribute name=“independentObject”
type=“xs:boolean” default=“false”/>
                        <xs:attribute name=“availabilityStartTime”
type=“xs:dateTime”/>
                        <xs:attribute name=“availabilityEndTime”
type=“xs:dateTime”/>
                        <xs:anyAttribute namespace=“##other”
processContents=“skip”/>
                  </xs:extension>
            </xs:simpleContent>
            <xs:anyAttribute processContents=“skip”/>
      </xs:complexType>
      <xs:complexType name=“RepairTTemplateType”>
            <xs:simpleContent>
                  <xs:extension base=“xs:anyURI”>
                        <xs:attribute name=“repairTOI”
type=“xs:string”/>
                        <xs:attribute name=“includedSymbols”
type=“xs:string”/>
                        <xs:attribute name=“interleaving”
type=“xs:interleavingType”/>
                        <xs:attribute name=“independentObject”
type=“xs:boolean” default=“false”/>
                        <xs:attribute name=“availabilityStartTime”
type=“xs:dateTime”/>
                        <xs:attribute name=“availabilityEndTime”
type=“xs:dateTime”/>
                        <xs:anyAttribute namespace=“##other”
processContents=“skip”/>
                  </xs:extension>
            </xs:simpleContent>
            <xs:anyAttribute processContents=“skip”/>
      </xs:complexType>
      <xs:simpleType name=“DelimiterType”>
            <xs:restriction base=“xs:byte”/>
      </xs:simpleType>
      <xs:simpleType name=“interleavingType”>
            <xs:restriction base=“xs:string”>
                  <xs:enumeration value=“symbol-list”/>
                  <xs:enumeration value=“list-sbn”/>
                  <xs:enumeration value=“sequential-sbn”/>
                  <xs:enumeration value=“interleaved”/>
                  <xs:enumeration value=“spread”/>
            </xs:restriction>
      </xs:simpleType>
</xs:schema>
```

The TSD shall be authored such that, after XML attributes or elements in the TSD namespace but not in the XML schema documented above may be removed, the result is a valid XML document formatted according to that schema and that conforms to this document. In addition, the TSD shall be authored such that, after XML attributes or elements in the other namespaces than the TSD namespace are removed, the result is a valid XML document formatted according to that schema and that conforms to this document. If CMMF Clients remove all XML attributes and elements from the TSD in this namespace and in other namespaces that are not in the XML schema documented above, the TSD results in a valid XML document which complies with this document.

The MIME type of the TSD document is defined below. The encoding of the TSD shall be UTF-8 as defined in IETF RFC 3629. All data provided in extension namespaces shall be UTF-8 as defined in IETF RFC 3629. If binary data needs to be added, it shall be included in Base64 as described in IETF RFC 4648 within a UTF-8 encoded element with a proper name space or identifier, such that an XML parser knows how to process or ignore it.

The delivery of the TSD is outside the scope of this document. However, if the TSD is delivered over HTTP, then the TSD document may be transfer encoded for transport, as described in IETF RFC 7230.

The formal MIME type registration for the TSD may be as follows. The MIME Type and Subtype may be defined as follows:
MIME media type name: application
MIME subtype name: cmmf-tsd+xml
Required parameters: None
Optional parameters: None.
Encoding considerations: UTF-8
Security considerations: The TSD contains references to other resources. It is coded in XML, and there are risks that deliberately malformed XML can cause security issues. In addition, an TSD can be authored that causes receiving clients to access other resources; if widely distributed, this can be used to cause a denial-of-service attack.
   The TSD format does not incorporate any active or executable content. However, other forms of material from outside sources can be referenced by an TSD, and this material can contain active or executable content. Such material is expected to be identified by its own MIME type, and the security considerations of that format should be taken into account.
   If operating in an insecure environment and required by the content/service provider, elements and attributes of TSD may be encrypted to protect their confidentiality by using the syntax and processing rules specified in the W3C Recommendation “XML Encryption Syntax and Processing”.
   If operating in an insecure environment and required by the content/service provider, the digital signing and verification procedures specified in the W3C Recommendation “XML Signature Syntax and Processing” may be used to protect data origin authenticity and integrity of the EFD.
Interoperability considerations: The specification defines a platform-independent expression of a document, and it is intended that wide interoperability can be achieved.
Published specification: ETSI TS XXXX
Applications which use this media type: Various
Additional information:
File extension(s): tsd
Intended usage: common
Other information/general comment: None
Author/Change controller: ETSI

The encoding object formats for this instantiation may make use of the well defined ALC Payload formats with some additional headers and carry only repair symbols as documented. Three different types of transport objects are defined:
Source Transport Objects, i.e., unmodified source objects
Partial Encoding Objects, i.e., objects that include only encoding symbols, but are not sufficient to recover the object.
Self-contained transport objects are not defined, the availability of a TSD is required.

The mapping of source objects to transport objects is defined above using the super-object formation.

Additional example offerings are described below. An example efficient DASH distribution may be as follows. Encoding may be preset to RaptorQ with symbol length 64. It is assumed the information is provided in a manifest and the Representation is referenced. The repair objects may be generated for each of the source objects, but a super-object may be created for each of the first and third Representation (e.g., video 1 and audio) as well as second and third (e.g., video 2 and audio).

```
<?xml version=“1.0” encoding-“UTF-8”?>
<TSD xmlns:xsi=“http://www.w3.org/2001/XMLSchema-instance”
  xmlns=“urn:ETSI:CMMF:2023:TSD”
  xsi:schemaLocation=“urn:ETSI:CMMF:2023: TSD TSD.xsd”
  Expires=“2024-05-30T09:30:10Z”
  Complete=“true”
  Content-Location=“http://www.example.com/my.tsd”>
      <SourceFlow TSI=“1”>
            <Representation
firstTOI=“17”>https://example.com/dash.mpd#rep=1</Representation>
      </SourceFlow>
      <SourceFlow TSI=“2”>
            <Representation
firstTOI=“17”>https://example.com/dash.mpd#rep=2</Representation>
      </SourceFlow>
      <SourceFlow TSI=“3”>
            <Representation
firstTOI=“10”>https://example.com/dash.mpd#rep=3</Representation>
      </SourceFlow>
      <RepairFlow TSI=“4”
            FEC-OTI-FEC-Encoding-ID=“6”
            FEC-OTI-Encoding-Symbol-Length=“64”
            interleavingType=“sequential-sbn”
            includedSymbols=“500,0,500”
            repairTOI=“TOI(TSI=1),TOI(TSI=3)”>
            <RepairTemplate
firstTOI=“17”>https://example.com/repair_4_$TOI$</RepairTemplate>
      </RepairFlow>
      <RepairFlow TSI=“5”
            FEC-OTI-FEC-Encoding-ID=“6”
            FEC-OTI-Encoding-Symbol-Length=“64”
            interleavingType=“sequential-sbn”
            includedSymbols=“500,0,1000”
            repairTOI=“TOI(TSI=1),TOI(TSI=3)”>
            <RepairTemplate
firstTOI=“17”>https://example.com/repair_5_$TOI$</RepairTemplate>
      </RepairFlow>
      <RepairFlow TSI=“6”
            FEC-OTI-FEC-Encoding-ID=“6”
            FEC-OTI-Encoding-Symbol-Length=“64”
            interleavingType=“sequential-sbn”
            includedSymbols=“500,0,1500”
            repairTOI=“TOI(TSI=1),TOI(TSI=3)”>
            <RepairTemplate
firstTOI=“17”>https://example.com/repair_6_$TOI$</RepairTemplate>
      </RepairFlow>
      <RepairFlow TSI=“7”
            FEC-OTI-FEC-Encoding-ID=“6”
            FEC-OTI-Encoding-Symbol-Length=“64”
            interleavingType=“sequential-sbn”
            includedSymbols=“500,0,500”
            repairTOI=“TOI(TSI=2),TOI(TSI=3)”>
            <RepairTemplate
firstTOI=“17”>https://example.com/repair_7_$TOI$</RepairTemplate>
      </RepairFlow>
      <RepairFlow TSI=“8”
            FEC-OTI-FEC-Encoding-ID=“6”
            FEC-OTI-Encoding-Symbol-Length=“64”
            interleavingType=“sequential-sbn”
            includedSymbols=“500,0,1000”
            repairTOI=“TOI(TSI=2),TOI(TSI=3)”>
            <RepairTemplate
firstTOI=“17”>https://example.com/repair_8_$TOI$</RepairTemplate>
      </RepairFlow>
      <RepairFlow TSI=“9”
                  FEC-OTI-FEC-Encoding-ID=“6”
                  FEC-OTI-Encoding-Symbol-Length=“64”
                  interleavingType=“sequential-sbn”
                  includedSymbols=“500,0,1500”
                  repairTOI=“TOI(TSI=2),TOI(TSI=3)”>
                  <RepairTemplate
firstTOI=“17”>https://example.com/repair_9_$TOI$</RepairTemplate>
      </RepairFlow>
</TSD>
```

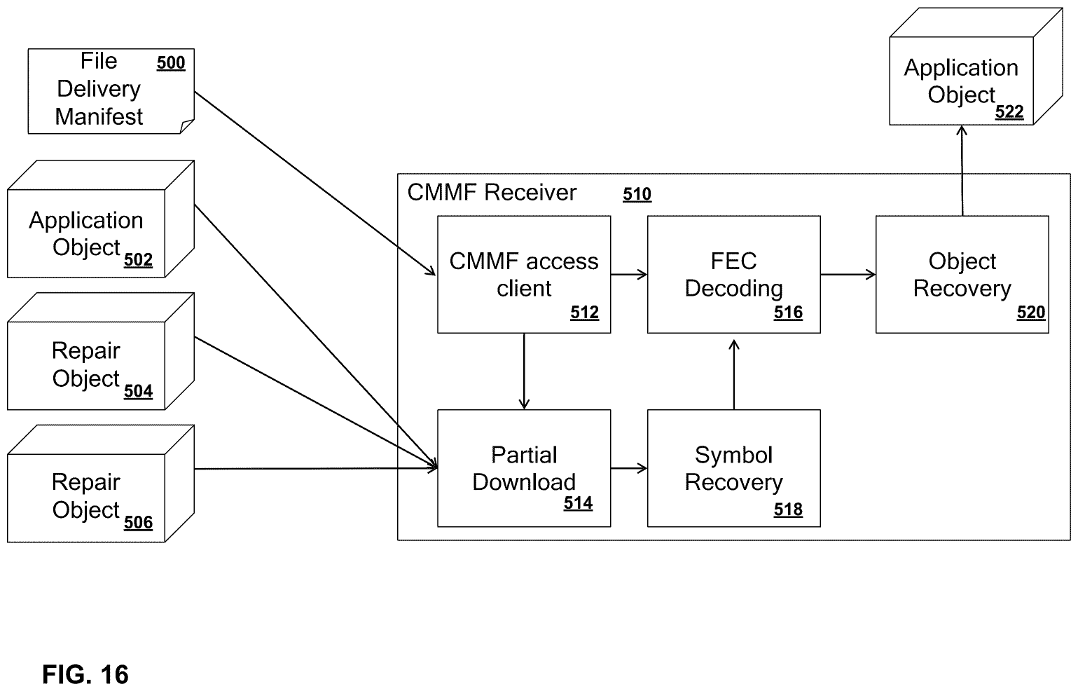

FIG. 16 is a conceptual diagram illustrating an example of CMMF receiver 510 and decoder for a single application object. In this example, CMMF receiver 510 includes CMMF access client 512, partial download unit 514, symbol recovery unit 518, FEC decoding unit 516, and object recovery unit 520. Per techniques of this disclosure, CMMF access client 512 retrieves file delivery manifest 500 (e.g., an extended FDT including ETI information, per techniques of this disclosure). File delivery manifest 500 may include data representing locations of application objects (e.g., application object 502) and repair objects 504, 506. The locations may be represented by URLs, and may indicate separate and distinct servers (e.g., separate CDNs) from which each of application object 502 and repair objects 504, 506 are available. File delivery manifest 500 may further indicate that various application objects of source flows are available from separate server devices/CDNs as well.

Thus, partial download unit 514 may retrieve portions of a segment in the form of application object 502, and repair objects 504, 506 in parallel. Application object 502 as retrieved may not be a complete segment, but in combination with repair objects 504, 506, symbol recover unit 518 and FEC decoding unit 516 may be capable of fully recovering the segment.

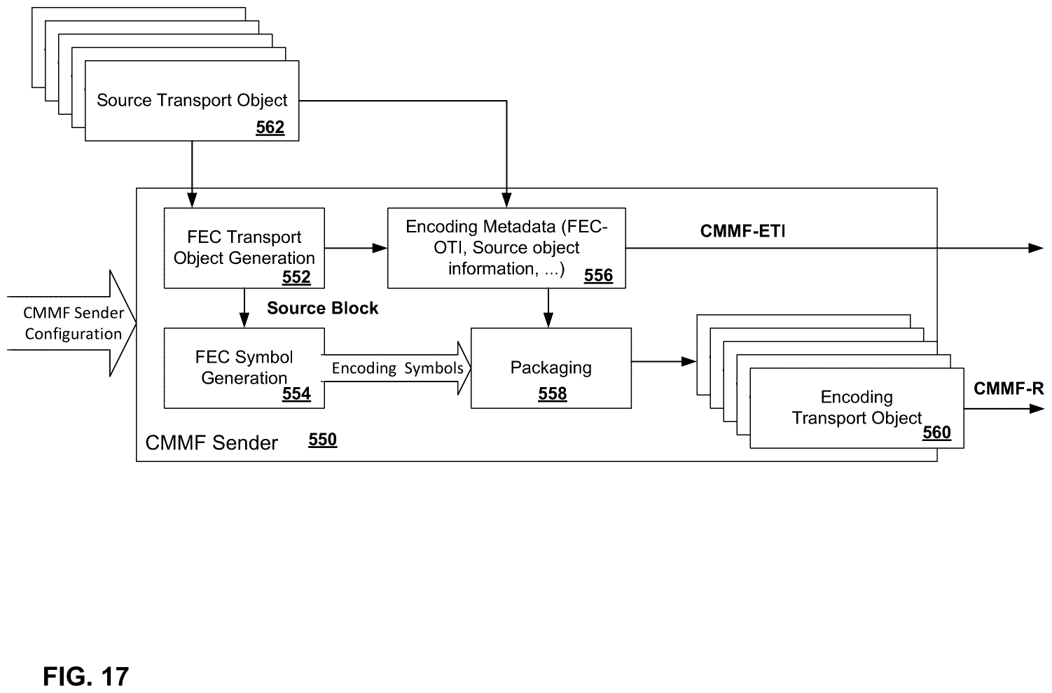

FIG. 17 is a conceptual diagram illustrating an example CMMF architecture. In this example, encoding represents a mixture of systematic and FEC symbols/repair objects. In this example, CMMF sender 550 includes FEC transport object generation unit 552, FEC symbol generation unit 554, encoding metadata 552, and packaging unit 558. FEC transport object generation unit 552 may receive source transport objects 562 and generate a source block and provide the source block to FEC symbol generation unit 554. FEC symbol generation unit 554 forms encoding symbols from the source block, and provides the encoding symbols to packaging unit 558. Packaging unit 558 uses the encoding symbols, along with encoding metadata 556, to form encoding transport objects 560.

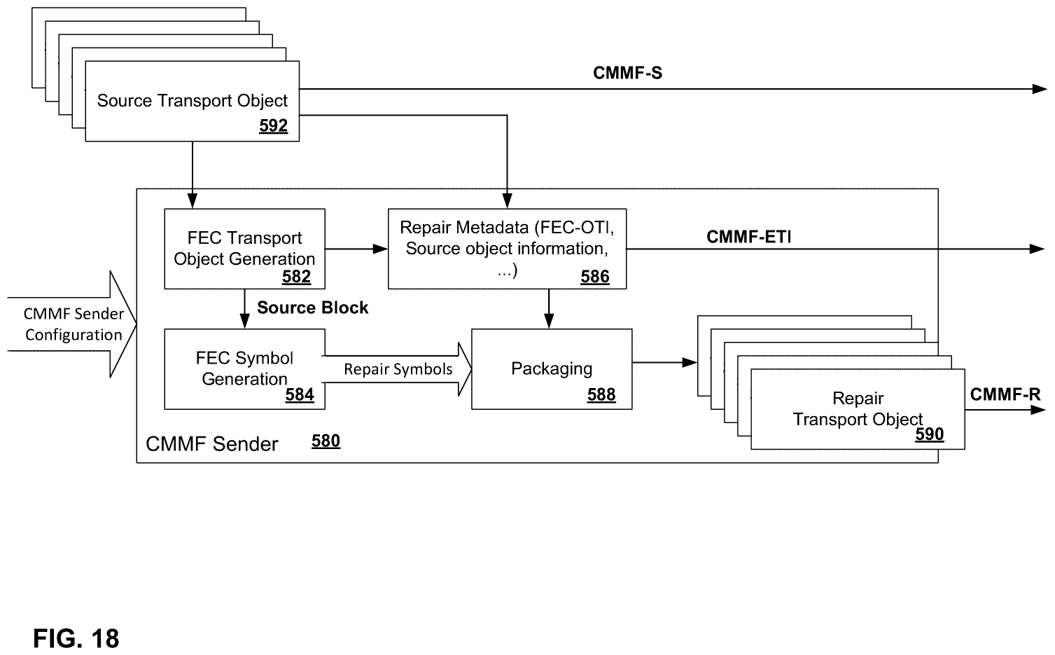

FIG. 18 is a conceptual diagram illustrating another example CMMF architecture. In this example, source objects are provided to the receiver, and only repair symbols are provided in repair transport objects. In this example, CMMF sender 580 includes FEC transport object generation unit 582, FEC symbol generation unit 584, encoding metadata 582, and packaging unit 588. FEC transport object generation unit 582 may receive source transport objects 592 and generate a source block and provide the source block to FEC symbol generation unit 584. FEC symbol generation unit 584 forms encoding symbols from the source block, and provides the encoding symbols to packaging unit 588. Packaging unit 588 uses the encoding symbols, along with encoding metadata 586, to form encoding transport objects 590.

FIG. 19 is a conceptual diagram illustrating another CMMF architecture. The example of FIG. 19 represents a generalized sending architecture that allows for both incarnations of FIGS. 17 and 18. In this example, CMMF sender 600 includes FEC transport object generation unit 602, FEC symbol generation unit 604, encoding metadata 602, and packaging unit 608. FEC transport object generation unit 602 may receive source transport objects 612 and generate a source block and provide the source block to FEC symbol generation unit 604. FEC symbol generation unit 604 forms encoding symbols from the source block, and provides the encoding symbols to packaging unit 608. Packaging unit 608 uses the encoding symbols, along with encoding metadata 606, to form encoding transport objects 610.

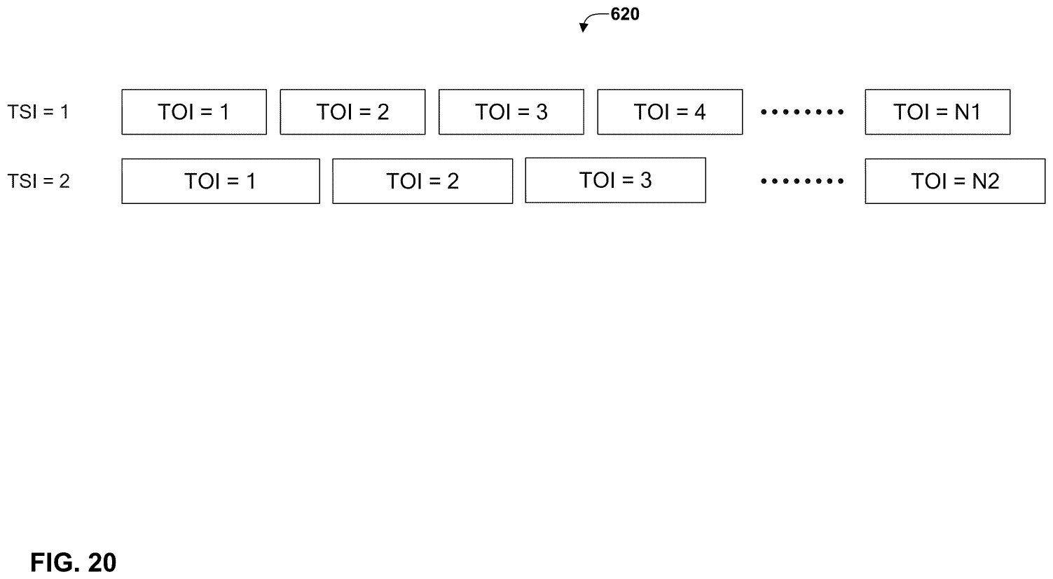

FIG. 20 is a conceptual diagram illustrating an example mapping 620 between transport object identifiers (TOIs) and transport session identifiers (TSIs) and a URL or source data in a file delivery manifest. For example, the file delivery manifest may be a file delivery table (FDT) or template mechanism. A single application object may be associated with metadata and a URL. A byte range of a single application object may be associated with metadata and a URL. A single application object flow may include multiple objects, where each object may include associated metadata and a URL and a transport object identifier (TOI) identifying the sequence of the object. Multiple application object flows may each follow the principles of a single application flow and may be identified with a transport session identifier (TSI).

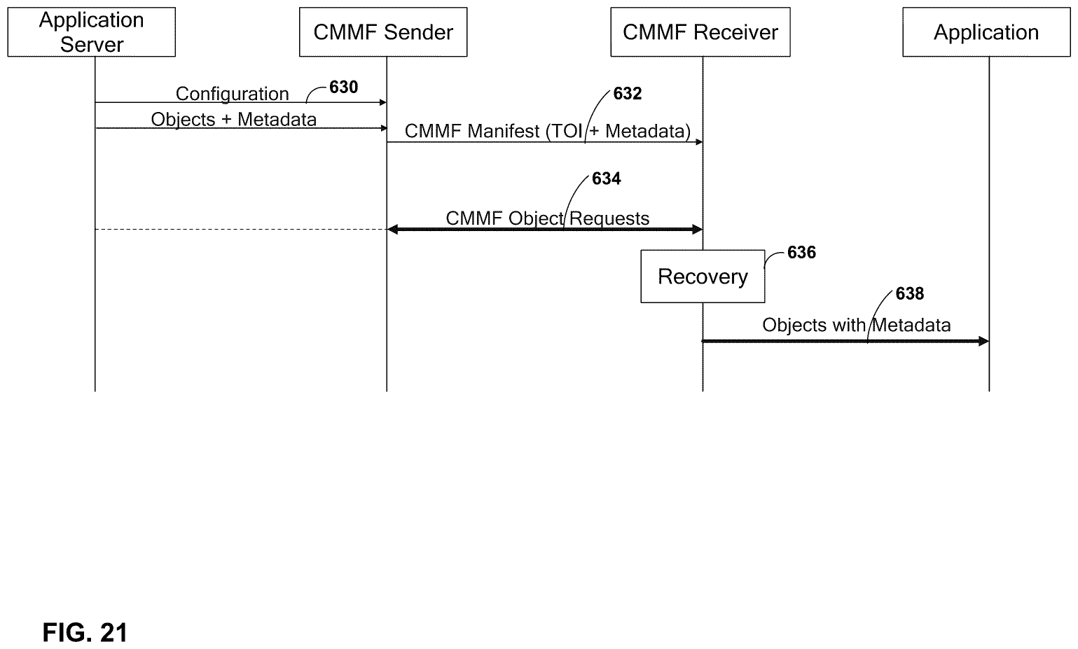

FIG. 21 is a flow diagram illustrating an example of static operation according to techniques of this disclosure. In this example, an application server provides configuration data and objects and metadata to a CMMF sender (630). The CMMF sender may then send a CMMF manifest file (including TOI and metadata) to a CMMF receiver (632). The CMMF sender may correspond to request processing unit 70 and the application server may correspond to server device 60 of FIG. 1. The CMMF receiver may request one or more CMMF objects (e.g., repair objects). The CMMF receiver may correspond to retrieval unit 52, and the application may correspond to media application 112 (FIG. 2).

In this example, the CMMF receiver retrieves CMMF objects by sending CMMF object requests to the CMMF sender, and the CMMF sender sends the CMMF objects to the CMMF receiver (634). The CMMF receiver recovers object data according to the techniques of this disclosure (636), then provides the objects with their metadata to the application (638).

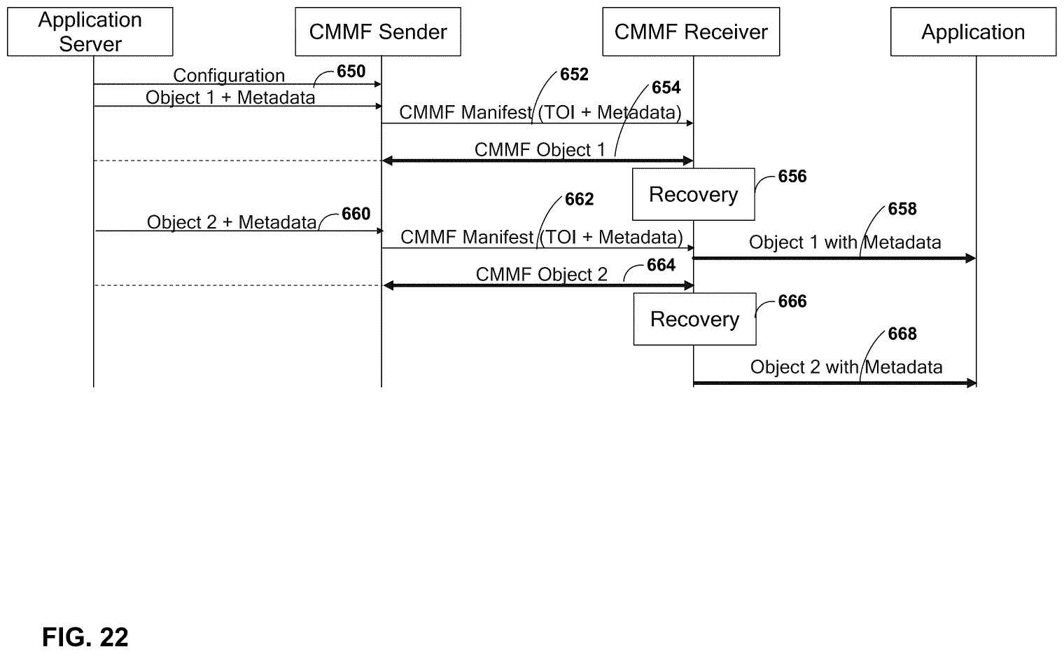

FIG. 22 is a flow diagram illustrating an example of dynamic operation according to techniques of this disclosure. This may include continuous updates of a manifest file. In this example, an application server provides configuration data and a first set of objects and metadata to a CMMF sender (650). The CMMF sender may then send a first CMMF manifest file (including TOI and metadata) to a CMMF receiver (652). The CMMF sender may correspond to request processing unit 70 and the application server may correspond to server device 60 of FIG. 1. The CMMF receiver may request a first CMMF object using the first manifest file (654). The CMMF receiver may correspond to retrieval unit 52, and the application may correspond to media application 112 (FIG. 2). In this example, the CMMF receiver recovers object data for the first object according to the techniques of this disclosure (656), then provides the first object with its metadata to the application (658).

Subsequently, the application server may provide a second CMMF object and metadata to the CMMF sender (660). The CMMF sender may send a second CMMF manifest file to the CMMF receiver (662). The CMMF receiver may use the second CMMF manifest file to request a second CMMF object (664). The CMMF receiver may then recover object data for the second object (666), then provide the second object to the application (668).

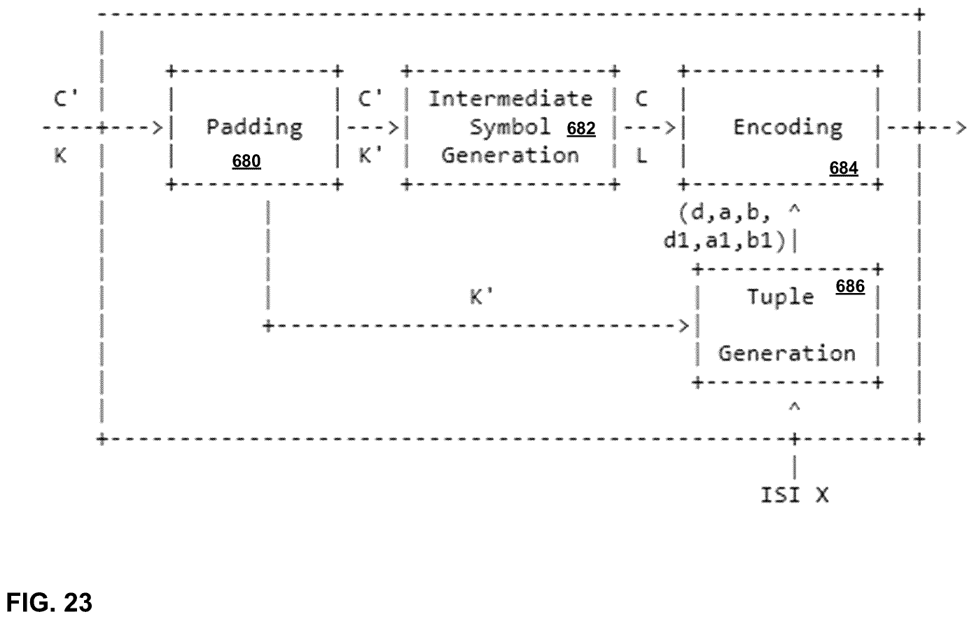

FIG. 23 is a conceptual diagram illustrating an example FLUTE transmission unit. In this example, the FLUTE transmission unit includes padding unit 680, intermediate symbol generation unit 628, encoding unit 684, and tuple generation unit 686.

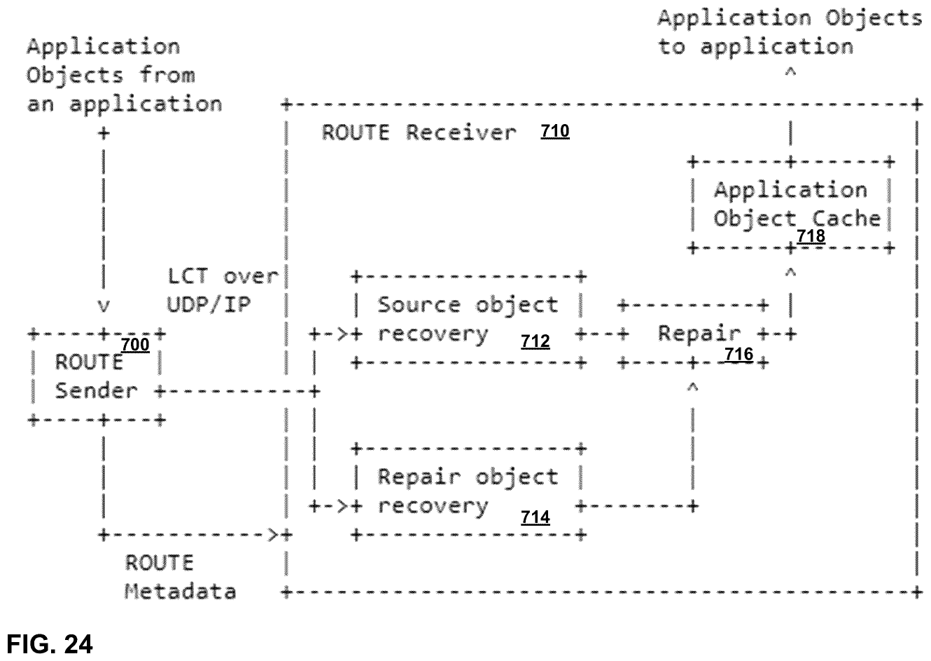

FIG. 24 is a conceptual diagram illustrating a ROUTE system including an example ROUTE receiver 710 and a ROUTE sender 700. In this example, ROUTE receiver 710 includes source object recovery unit 712 and repair object recovery unit 714. Repair object recovery unit 714 recovers repair object 716 and stores repair object 716 to application object cache 718. ROUTE receiver 710 may provide repair objects from application object cache 718 to a media player application.

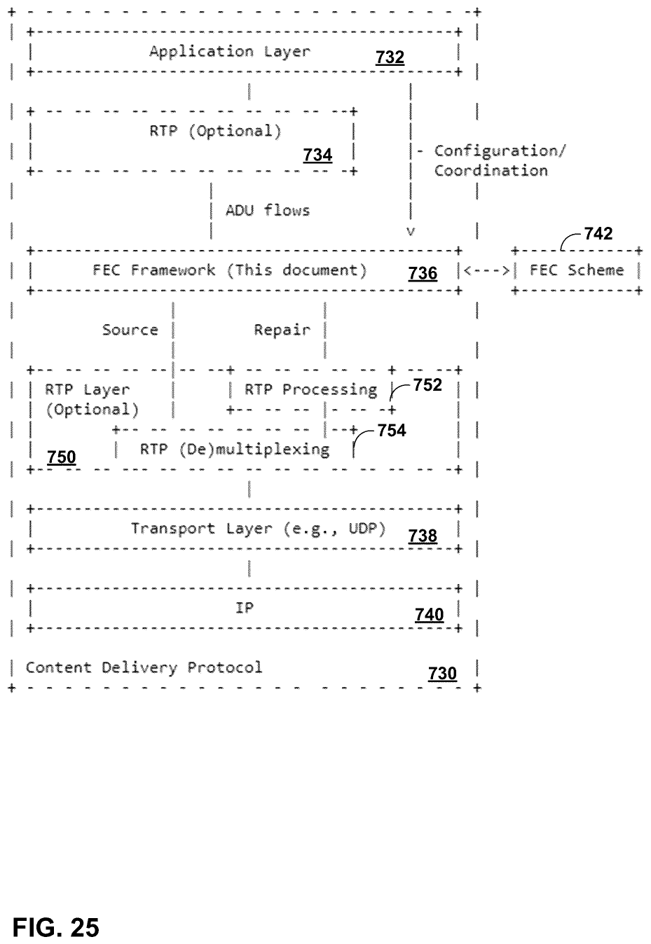

FIG. 25 is a conceptual diagram illustrating an example FECFRAME protocol stack. In this example, the FECFRAME protocol stack for content delivery protocol 730 includes application layer 732, RTP 734, FEC framework 736, RTP layer 750, transport layer 738, and IP layer 740. FEC framework 736 represents data formed according to the techniques of this disclosure. FEC framework 736 uses FEC scheme 742 to perform FEC coding of media data objects. RTP layer 750 further includes RTP processing 752 and RTP (de)multiplexing 754.

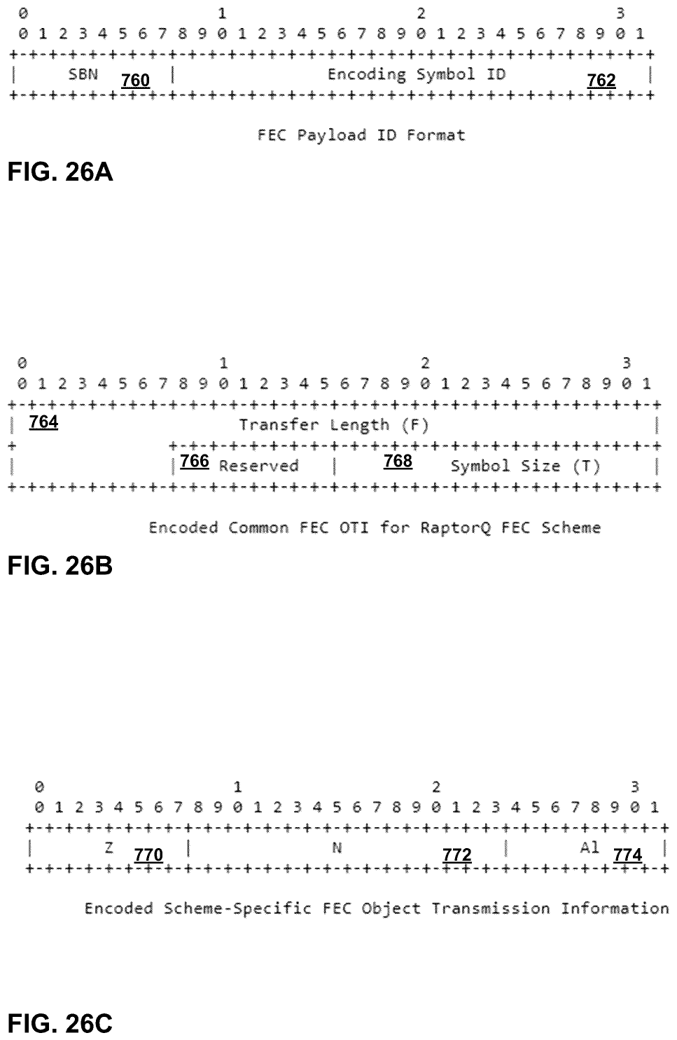

FIGS. 26A-26C are conceptual diagrams illustrating various example FEC packets. In particular, the example of FIG. 26A depicts a FEC payload ID format. The packet includes source block number (SBN) 760 and encoding symbol ID (ESI) 762. FIG. 26B depicts an example encoded common FEC OTI for RaptorQ FEC scheme. The packet includes a transfer length value (F) 7t64, a symbol size value (T) 768, and reserved field 766. FIG. 26C depicts an example encoded scheme-specific FEC object transmission information format. The packet includes scheme-specific parameters Z 770, N 772, and Al 774 for implementation optimization.

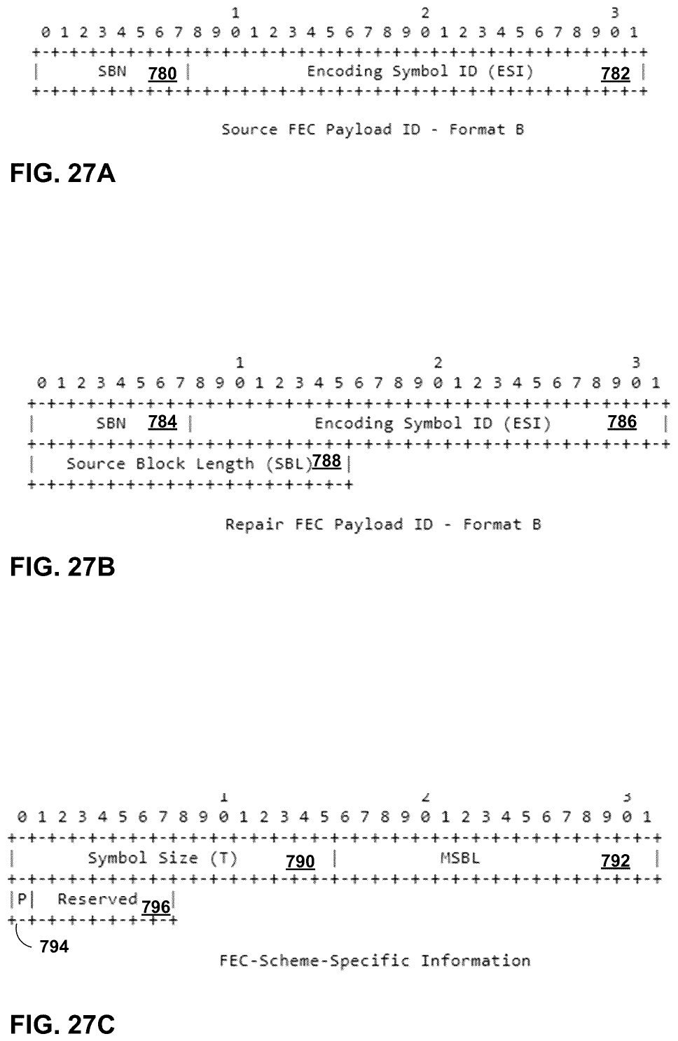

FIGS. 27A-27C are conceptual diagrams illustrating various example Raptor/RaptorQ code formats for FECFRAME. FIG. 27A depicts an example source FEC payload ID, including SBN 780 and ESI 782. FIG. 27B depicts an example repair FEC payload ID, including an SBN 784, ESI 786, and source block length (SBL) value 788. FIG. 27C depicts an example FEC scheme specific information format including a symbol size (T) value 790, a maximum source block length (MSBL) value 792, and a P value 794, along with reserved field 796.

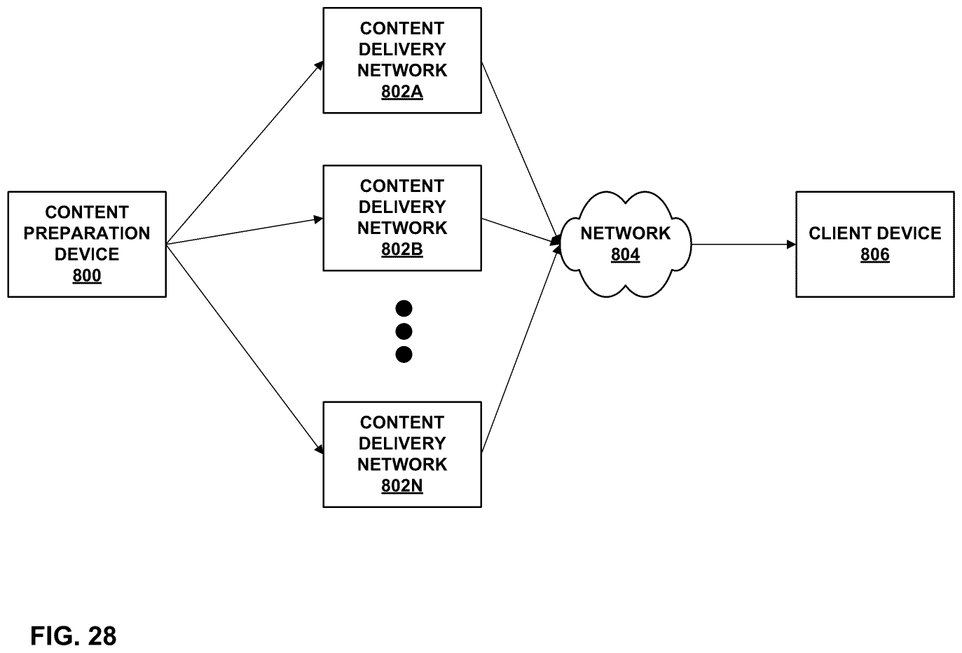

FIG. 28 is a block diagram illustrating an example set of devices that may perform the techniques of this disclosure. In this example, FIG. 28 depicts content preparation device 800, content delivery networks 802A-802N (CDNs 802), network 804, and client device 806. Content preparation device 800 may correspond to content preparation device 20 of FIG. 1 or the application server of FIGS. 21 and 22. CDNs 802 may correspond to server device 60 of FIG. 1, CMMF senders 402, 422, 452, 550, 580, 600 of FIGS. 11, 12, 13, 17, 18, and 19, respectively, or the CMMF sender of FIGS. 21 and 22. Client device 806 may correspond to client device 40 of FIG. 1, CMMF receivers 408, 428, 510 of FIGS. 11, 12, and 16, respectively, the CMMF receiver and application of FIGS. 21 and 22, or ROUTE receiver 710 of FIG. 24.

Per techniques of this disclosure, content preparation device 800 may prepare content to be streamed in the form of application objects and repair objects. Content preparation device 800 may store certain application objects to, e.g., CDN 802A, other application objects to, e.g., CDN 802B, and repair objects to, e.g., CDN 802N. In some examples, content preparation device 800 may store all application objects and/or all repair objects to each of CDNs 802. For example, content preparation device 800 may store all application objects to CDN 802A and to CDN 802B, and store repair objects to CDN 802N.

Content preparation device 800 may also construct a manifest file indicating the locations of the various application objects and repair objects. The manifest file may be or include an enhanced FDT as discussed above. Content preparation device 800 may construct the manifest file to indicate source flow information, indicative of locations of application objects, and repair flow information, indicative of locations of repair objects. The manifest file may, for example, indicate that application objects are available from URLs associated with CDNs 802A, 802B, and that repair objects are available from URLs associated with CDN 802N. In some examples, content preparation device 800 may send the manifest file to client device 806 via network 804. In other examples, content preparation device 800 may store the manifest file to any or all of CDNs 802, and client device 806 may retrieve the manifest file from one of CDNs 802.

After retrieving the manifest file, client device 806 may determine locations of application objects and repair objects. For example, client device 806 may determine that application objects are available from CDNs 802A, 802B, and that repair objects are available from CDN 802N, per the manifest file. Using this information, client device 806 may retrieve application objects from CDNs 802A, 802B and repair objects from CDN 802N in parallel. As discussed above, client device 806 may use the repair objects to repair incomplete application objects, that is, application objects for which not all data has been retrieved. Thus, rather than retrieving full application objects from CDNs 802A, 802B (for example), client device 806 may simply retrieve enough of each application object that, in combination with the corresponding repair object, the application object can be recovered to form a decodable segment of the media data.

In this manner, client device 806 represents an example of a device for retrieving media data, including: a memory configured to store media data; and a processing system including a decoder implemented in circuitry, the processing system being configured to: retrieve a manifest file indicating a plurality of network locations for at least a first segment of media data and a second segment of the media data, each network location among the plurality of network locations being hosted by a separate physical server device; retrieve at least a first portion of the first segment from a first network location of the plurality of network locations; retrieve at least a second portion of the second segment from a second network location of the plurality of network locations; and provide the at least first portion of the first segment and the at least second portion of the second segment to the decoder.

Likewise, content preparation device 800 represents an example of a device for sending media data, including: a memory configured to store media data; and a processing system implemented in circuitry and configured to: forward error correction (FEC) encode at least a first portion of a first segment to form a first FEC encoded first portion of the first segment and at least a second portion of a second segment to form a second FEC encoded second portion of the second segment; store the first FEC encoded first portion to a first physical server device; store the second FEC encoded second portion to a second physical server device; and form a manifest file indicating that the first FEC encoded first portion is available from the first physical server device and that the second FEC encoded second portion is available from the second physical server device.

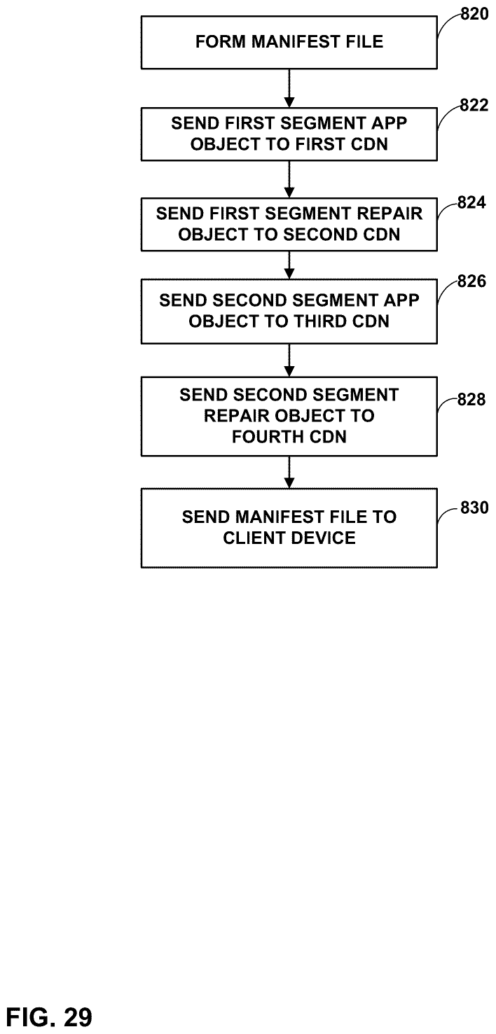

FIG. 29 is a flowchart illustrating an example method of sending media data according to techniques of this disclosure. The method of FIG. 29 is explained with respect to content preparation device 800 and CDNs 802 of FIG. 28. However, other devices may be configured to perform this or a similar method as discussed above.

Initially, content preparation device 800 may form a manifest file (820) for a media presentation. The media presentation may include a variety of different adaptation sets, representations, and segments (e.g., video files, per FIG. 4). Content preparation device 800 may FEC-encode the segments to form application objects and repair objects. Content preparation device 800 may send a first segment application object to a first CDN (822), e.g., CDN 802A of FIG. 28. Content preparation device 800 may send the first segment repair object to a second CDN (824), e.g., CND 802N of FIG. 28. Content preparation device 800 may send a second segment application object to a third CDN (826), e.g., CDN 802B of FIG. 28. Content preparation device 800 may also send the second segment repair object to a fourth CDN (828), e.g., CDN 802N or another CDN not shown in FIG. 28. Content preparation device 800 may indicate the locations of the various application objects in the manifest file. Content preparation device 800 may send the manifest file to a client device (830), e.g., directly or via one or more of CDNs 802.

In this manner, the method of FIG. 29 represents an example of a method of sending media data including: forward error correction (FEC) encoding at least a first portion of a first segment to form a first FEC encoded first portion of the first segment and at least a second portion of a second segment to form a second FEC encoded second portion of the second segment; storing the first FEC encoded first portion to a first physical server device; storing the second FEC encoded second portion to a second physical server device; and forming a manifest file indicating that the first FEC encoded first portion is available from the first physical server device and that the second FEC encoded second portion is available from the second physical server device.

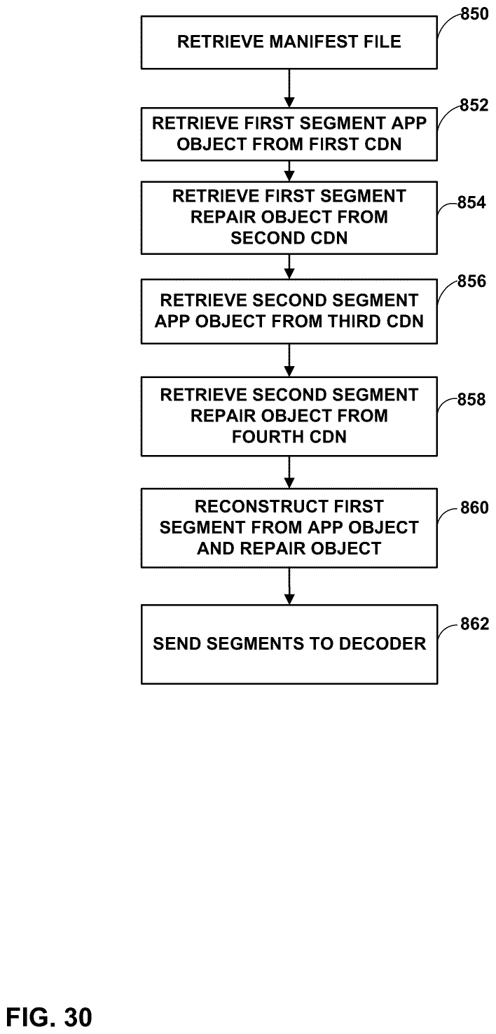

FIG. 30 is a flowchart illustrating an example method of retrieving media data according to techniques of this disclosure. For purposes of example, the method of FIG. 30 is explained with respect to client device 806 and CDNs 802 of FIG. 28. However, other devices may be configured to perform this or a similar method as explained above.

Initially, client device 806 retrieves a manifest file (850) for a media presentation. The manifest file may indicate locations of application objects and repair objects for segments of the media presentation. The manifest file may also indicate adaptation sets and representations to which the segments correspond. Thus, client device 806 may select an appropriate representation of the media presentation from which to retrieve segments. Client device 806 may then retrieve a first segment application object from a first CDN (852), e.g., CDN 802A of FIG. 28. Client device 806 may retrieve the first segment repair object from a second CDN (854), e.g., CDN 802N of FIG. 28. Client device 806 may retrieve a second segment application object from a third CDN (856), e.g., CDN 802B. Client device 806 may retrieve the second segment repair object from a fourth CDN (858), e.g., CDN 802N or another CDN not shown in FIG. 28.

Client device 806 may use the application objects and repair objects to reconstruct the first and second segments (860). Client device 806 may then send the segments to a decoder (862), e.g., video decoder 48 (FIG. 1). Thus, media data of the first and second segments may be decoded and presented to a user of client device 806.

In this manner, the method of FIG. 30 represents an example of a method of retrieving media data including: retrieving a manifest file indicating a plurality of network locations for at least a first segment of media data and a second segment of the media data, each network location among the plurality of network locations being hosted by a separate physical server device; retrieving at least a first portion of the first segment from a first network location of the plurality of network locations; retrieving at least a second portion of the second segment from a second network location of the plurality of network locations; and providing the at least first portion of the first segment and the at least second portion of the second segment to a decoder.

Various examples of the techniques of this disclosure are summarized in the following clauses:

Clause 1: A method of transporting media data, the method comprising transporting media data encapsulated with an extensible container format, the media data being encoded using one or more forward error correction (FEC) codes.

Clause 2: The method of clause 1, wherein the one or more FEC codes include xCD-1, RaptorQ, and Reed-Solomon.

Clause 3: The method of any of clauses 1 and 2, wherein the extensible container format includes data representing one or more of a coding type for the media data, media information for the media data, integrity information for the media data, an encoder universally unique identifier (UUID), or a time for the media data.

Clause 4: A method of transporting media data, the method comprising transporting one or more forward error correction (FEC) coded pieces of media data via multisource, multipath, and/or multi-access connections.

Clause 5: A method comprising a combination of the method of any of clauses 1-3 and the method of clause 4.

Clause 6: A method of transporting media data, the method comprising transporting forward error correction (FEC) coded pieces of media data over one of transport control protocol (TCP), uniform datagram protocol (UDP), or Web Real-Time Communication (WebRTC) Protocol.

Clause 7: A method comprising a combination of the method of any of clauses 1-5 and the method of clause 6.

Clause 8: The method of any of clauses 6 and 7, wherein the encoded pieces of media data correspond to at least one of a multipath audio/video stream or an ultra-low latency extended reality (XR) communication session.

Clause 9: The method of any of clauses 1-8, wherein transporting the media data comprises transporting the media data using HTTP-based streaming.

Clause 10: The method of clause 9, wherein transporting the media data comprises transporting the media data using Dynamic Adaptive Streaming over HTTP (DASH).

Clause 11: The method of clause 9, wherein transporting the media data comprises transporting the media data using HTTP Live Streaming (HLS).

Clause 12: The method of any of clauses 1-11, wherein transporting the media data comprises transporting the media data using at least one of File Delivery over Unidirectional Transport (FLUTE) or Real-time Transport Object Delivery over Unidirectional Transport (ROUTE) protocol.

Clause 13: A method of transporting media data, the method comprising: processing feedback packets for one or more previous application data units (ADUs) of media data of a media streaming session; and transporting an amount of forward error correction (FEC) data for an application data unit (ADU) of the media data the media streaming session, the amount of FEC data being associated with data of the feedback packets.

Clause 14: A method comprising a combination of the method of any of clauses 1-12 and the method of clause 13.

Clause 15: A method of retrieving media data, the method comprising: retrieving a manifest file indicating a plurality of network locations for at least a first segment of media data and a second segment of the media data, each network location among the plurality of network locations being hosted by a separate physical server device; retrieving at least a first portion of the first segment from a first network location of the plurality of network locations; retrieving at least a second portion of the second segment from a second network location of the plurality of network locations; and providing the at least first portion of the first segment and the at least second portion of the second segment to a decoder.

Clause 16: A method comprising a combination of the method of any of clauses 1-14 and the method of clause 15.

Clause 17: The method of any of clauses 15 and 16, wherein retrieving the at least first portion comprises: sending a first request for the first at least portion of the first segment to a first uniform resource location (URL); and sending a second request for a third portion of the first segment to a second URL.

Clause 18: The method of clause 17, further comprising combining the first at least portion and the third portion using FEC decoding.

Clause 19: The method of any of clauses 17 and 18, wherein the first portion comprises an application object, and wherein the third portion comprises a repair object.

Clause 20: A method of sending media data, the method comprising: forward error correction (FEC) encoding at least a first portion of a first segment to form a first FEC encoded first portion of the first segment and at least a second portion of a second segment to form a second FEC encoded second portion of the second segment; storing the first FEC encoded first portion and the second FEC encoded second portion to a first physical server device; storing the first FEC encoded first portion and the second FEC encoded second portion to a second physical server device; and forming a manifest file indicating that the first FEC encoded first portion and the second FEC encoded second portion are available from the first physical server device and the second physical server device.

Clause 21: A method comprising a combination of the method of any of clauses 1-14 and the method of clause 20.

Clause 22: The method of any of clauses 20 and 21, further comprising sending the manifest file to the first physical server device and the second physical server device.

Clause 23: The method of any of clauses 20-22, further comprising sending the manifest file to a client device.

Clause 24: The method of any of clauses 20-23, further comprising: by the first physical server device: receiving a first request for the first FEC encoded first portion from a client device; and in response to the first request, sending the first FEC encoded first portion to the client device; and by the second physical server device: receiving a second request for the second FEC encoded second portion from the client device; and in response to the second request, sending the second FEC encoded second portion to the client device.

Clause 25: A device for transporting media data, the device comprising one or more means for performing the method of any of clauses 1-24.

Clause 26: The device of clause 25, wherein the one or more means comprise one or more processors implemented in circuitry.

Clause 27: The device of clause 25, further comprising a memory configured to store media data.

Clause 28: The device of clause 25, wherein the device comprises at least one of: an integrated circuit; a microprocessor; and a wireless communication device.

Clause 29: A system for transporting media data, the system comprising: a computing device comprising one or more processors; a first physical server device; and a second physical server device, wherein the one or more processors of the computing device are configured to: forward error correction (FEC) encode at least a first portion of a first segment to form a first FEC encoded first portion of the first segment and at least a second portion of a second segment to form a second FEC encoded second portion of the second segment; store the first FEC encoded first portion and the second FEC encoded second portion to the first physical server device; storing the first FEC encoded first portion and the second FEC encoded second portion to the second physical server device; and form a manifest file indicating that the first FEC encoded first portion and the second FEC encoded second portion are available from the first physical server device and the second physical server device.

Clause 30: The system of clause 29, wherein the first physical server device is configured to: receive a first request for the first FEC encoded first portion from a client device; and in response to the first request, send the first FEC encoded first portion to the client device, and wherein the second physical server device is configured to: receive a second request for the second FEC encoded second portion from the client device; and in response to the second request, send the second FEC encoded second portion to the client device.

Clause 31: A device for transporting media data, the device comprising means for transporting media data encapsulated with an extensible container format, the media data being encoded using one or more forward error correction (FEC) codes.

Clause 32: A device for transporting media data, the device comprising means for transporting one or more forward error correction (FEC) coded pieces of media data via multisource, multipath, and/or multi-access connections.

Clause 33: A device for transporting media data, the device comprising means for transporting forward error correction (FEC) coded pieces of media data over one of transport control protocol (TCP), uniform datagram protocol (UDP), or Web Real-Time Communication (WebRTC) Protocol.

Clause 34: A device for transporting media data, the device comprising: means for processing feedback packets for one or more previous application data units (ADUs) of media data of a media streaming session; and means for transporting an amount of forward error correction (FEC) data for an application data unit (ADU) of the media data the media streaming session, the amount of FEC data being associated with data of the feedback packets.

Clause 35: A device for transporting media data, the device comprising: means for retrieving a manifest file indicating a plurality of network locations for at least a first segment of media data and a second segment of the media data, each network location among the plurality of network locations being hosted by a separate physical server device; means for retrieving at least a first portion of the first segment from a first network location of the plurality of network locations; means for retrieving at least a second portion of the second segment from a second network location of the plurality of network locations; and means for providing the at least first portion of the first segment and the at least second portion of the second segment to a decoder.

Clause 36: A device for transporting media data, the device comprising: means for forward error correction (FEC) encoding at least a first portion of a first segment to form a first FEC encoded first portion of the first segment and at least a second portion of a second segment to form a second FEC encoded second portion of the second segment; means for storing the first FEC encoded first portion and the second FEC encoded second portion to a first physical server device; means for storing the first FEC encoded first portion and the second FEC encoded second portion to a second physical server device; and means for forming a manifest file indicating that the first FEC encoded first portion and the second FEC encoded second portion are available from the first physical server device and the second physical server device.

Clause 37: A method of retrieving media data, the method comprising: retrieving a manifest file indicating a plurality of network locations for at least a first segment of media data and a second segment of the media data, each network location among the plurality of network locations being hosted by a separate physical server device; retrieving at least a first portion of the first segment from a first network location of the plurality of network locations; retrieving at least a second portion of the second segment from a second network location of the plurality of network locations; and providing the at least first portion of the first segment and the at least second portion of the second segment to a decoder.

Clause 38: The method of clause 37, wherein retrieving the at least first portion of the first segment comprises sending a first request for the first at least portion of the first segment to a first uniform resource location (URL), the method further comprising sending a second request for a third portion of the first segment to a second URL.

Clause 39: The method of clause 38, wherein the at least first portion comprises an application object including media data, and wherein the third portion comprises a repair object for repairing the application object in the event of loss of a portion of the application object according to forward error correction (FEC).

Clause 40: The method of clause 38, further comprising combining the first at least portion and the third portion using forward error correction (FEC) decoding.

Clause 41: The method of clause 38, wherein the manifest file includes source flow information for a media flow including the first at least portion of the first segment, the manifest file further including: an identifier for the source flow, an identifier of an object corresponding to the first at least portion of the first segment and included in the source flow, a transport object identifier (TOI) for the object, a size of the object, a content-type for the object representing a media type for the object, encoding information for the object, a message digest for the object, an associated uniform resource identifier (URI) for the object, a uniform resource locator (URL) for the object, and an availability start time indicating a time at which the object can be retrieved.

Clause 42: The method of clause 38, wherein the manifest file includes repair flow information for a repair flow including the third portion of the first segment, the manifest file further including: an identifier of a source flow corresponding to the repair flow, an identifier of an object of the source flow corresponding to the at least first portion of the first segment, an identifier of a repair object of the repair flow corresponding to the object of the source flow, forward error correction (FEC) object transmission information for the repair object including a FEC encoding identifier, data associating a transport session identifier (TSI) with a transport object identifier (TOI) for the repair object, a media type for the repair object, a number of symbols included in the repair object, a uniform resource locator (URL) for the repair object, and an availability start time indicating a time at which the repair object can be retrieved.

Clause 43: The method of clause 37, wherein the manifest file includes data indicating an expiration time at which the manifest file needs to be updated, the method further comprising updating the manifest file by the expiration time.

Clause 44: The method of clause 37, further comprising sending feedback packets for one or more application data units (ADUs) of media data of a media streaming session by which the first segment was received.

Clause 45: A device for retrieving media data, the device comprising: a memory configured to store media data; and a processing system including a decoder implemented in circuitry, the processing system being configured to: retrieve a manifest file indicating a plurality of network locations for at least a first segment of media data and a second segment of the media data, each network location among the plurality of network locations being hosted by a separate physical server device; retrieve at least a first portion of the first segment from a first network location of the plurality of network locations; retrieve at least a second portion of the second segment from a second network location of the plurality of network locations; and provide the at least first portion of the first segment and the at least second portion of the second segment to the decoder.

Clause 46: The device of clause 45, wherein to retrieve the at least first portion of the first segment, the processing system is configured to send a first request for the first at least portion of the first segment to a first uniform resource location (URL), the processing system being further configured to send a second request for a third portion of the first segment to a second URL.

Clause 47: The device of clause 46, wherein the at least first portion comprises an application object including media data, and wherein the third portion comprises a repair object for repairing the application object in the event of loss of a portion of the application object according to forward error correction (FEC).

Clause 48: The device of clause 46, wherein the manifest file includes source flow information for a media flow including the first at least portion of the first segment, the manifest file further including: an identifier for the source flow, an identifier of an object corresponding to the first at least portion of the first segment and included in the source flow, a transport object identifier (TOI) for the object, a size of the object, a content-type for the object representing a media type for the object, encoding information for the object, a message digest for the object, an associated uniform resource identifier (URI) for the object, a uniform resource locator (URL) for the object, and an availability start time indicating a time at which the object can be retrieved.

Clause 49: The device of clause 46, wherein the manifest file includes repair flow information for a repair flow including the third portion of the first segment, the manifest file further including: an identifier of a source flow corresponding to the repair flow, an identifier of an object of the source flow corresponding to the at least first portion of the first segment, an identifier of a repair object of the repair flow corresponding to the object of the source flow, forward error correction (FEC) object transmission information for the repair object including a FEC encoding identifier, data associating a transport session identifier (TSI) with a transport object identifier (TOI) for the repair object, a media type for the repair object, a number of symbols included in the repair object, a uniform resource locator (URL) for the repair object, and an availability start time indicating a time at which the repair object can be retrieved.

Clause 50: The device of clause 45, wherein the manifest file includes data indicating an expiration time at which the manifest file needs to be updated, and wherein the processing system is further configured to update the manifest file by the expiration time.

Clause 51: The device of clause 45, wherein the processing system is further configured to send feedback packets for one or more application data units (ADUs) of media data of a media streaming session by which the first segment was received.

Clause 52: A method of sending media data, the method comprising: forward error correction (FEC) encoding at least a first portion of a first segment to form a first FEC encoded first portion of the first segment and at least a second portion of a second segment to form a second FEC encoded second portion of the second segment; storing the first FEC encoded first portion to a first physical server device; storing the second FEC encoded second portion to a second physical server device; and forming a manifest file indicating that the first FEC encoded first portion is available from the first physical server device and that the second FEC encoded second portion is available from the second physical server device.

Clause 53: The method of clause 52, further comprising sending the manifest file to the first physical server device and the second physical server device.

Clause 54: The method of clause 52, wherein FEC encoding the first at least portion of the first segment includes forming an object for the first at least portion of the first segment and a repair object for a third portion of the first segment, the method further comprising storing the repair object to a third physical server device.

Clause 55: The method of clause 54, wherein the manifest file includes source flow information for a media flow including the first at least portion of the first segment, the manifest file further including: an identifier for the source flow, an identifier of an object corresponding to the first at least portion of the first segment and included in the source flow, a transport object identifier (TOI) for the object, a size of the object, a content-type for the object representing a media type for the object, encoding information for the object, a message digest for the object, an associated uniform resource identifier (URI) for the object, a uniform resource locator (URL) for the object, and an availability start time indicating a time at which the object can be retrieved.

Clause 56: The method of clause 54, wherein the manifest file includes repair flow information for a repair flow including the third portion of the first segment, the manifest file further including: an identifier of a source flow corresponding to the repair flow, an identifier of an object of the source flow corresponding to the at least first portion of the first segment, an identifier of a repair object of the repair flow corresponding to the object of the source flow, forward error correction (FEC) object transmission information for the repair object including a FEC encoding identifier, data associating a transport session identifier (TSI) with a transport object identifier (TOI) for the repair object, a media type for the repair object, a number of symbols included in the repair object, a uniform resource locator (URL) for the repair object, and an availability start time indicating a time at which the repair object can be retrieved.

Clause 57: The method of clause 52, wherein the manifest file includes data indicating an expiration time at which the manifest file needs to be updated.

Clause 58: The method of clause 52, further comprising receiving feedback packets from a client device for one or more application data units (ADUs) of media data of a media streaming session by which the first segment is sent to the client device.

Clause 59: A device for sending media data, the device comprising: a memory configured to store media data; and a processing system implemented in circuitry and configured to: forward error correction (FEC) encode at least a first portion of a first segment to form a first FEC encoded first portion of the first segment and at least a second portion of a second segment to form a second FEC encoded second portion of the second segment; store the first FEC encoded first portion to a first physical server device; store the second FEC encoded second portion to a second physical server device; and form a manifest file indicating that the first FEC encoded first portion is available from the first physical server device and that the second FEC encoded second portion is available from the second physical server device.

Clause 60: The device of clause 59, wherein the processing system is further configured to send the manifest file to the first physical server device and the second physical server device.

Clause 61: The device of clause 59, wherein to FEC encode the first at least portion of the first segment, the processing system is configured to form an object for the first at least portion of the first segment and a repair object for a third portion of the first segment, and wherein the processing system is further configured to store the repair object to a third physical server device.

Clause 62: The device of clause 61, wherein the manifest file includes source flow information for a media flow including the first at least portion of the first segment, the manifest file further including: an identifier for the source flow, an identifier of an object corresponding to the first at least portion of the first segment and included in the source flow, a transport object identifier (TOI) for the object, a size of the object, a content-type for the object representing a media type for the object, encoding information for the object, a message digest for the object, an associated uniform resource identifier (URI) for the object, a uniform resource locator (URL) for the object, and an availability start time indicating a time at which the object can be retrieved.

Clause 63: The device of clause 61, wherein the manifest file includes repair flow information for a repair flow including the third portion of the first segment, the manifest file further including: an identifier of a source flow corresponding to the repair flow, an identifier of an object of the source flow corresponding to the at least first portion of the first segment, an identifier of a repair object of the repair flow corresponding to the object of the source flow, forward error correction (FEC) object transmission information for the repair object including a FEC encoding identifier, data associating a transport session identifier (TSI) with a transport object identifier (TOI) for the repair object, a media type for the repair object, a number of symbols included in the repair object, a uniform resource locator (URL) for the repair object, and an availability start time indicating a time at which the repair object can be retrieved.

Clause 64: The device of clause 59, wherein the manifest file includes data indicating an expiration time at which the manifest file needs to be updated.

Clause 65: The method of clause 59, wherein the processing system is further configured to receive feedback packets from a client device for one or more application data units (ADUs) of media data of a media streaming session by which the first segment is sent to the client device.

In one or more examples, the functions described may be implemented in hardware, software, firmware, or any combination thereof. If implemented in software, the functions may be stored on or transmitted over as one or more instructions or code on a computer-readable medium and executed by a hardware-based processing unit.

Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media which is non-transitory or (2) a communication medium such as a signal or carrier wave. Data storage media may be any available media that can be accessed by one or more computers or one or more processors to retrieve instructions, code, and/or data structures for implementation of the techniques described in this disclosure. A computer program product may include a computer-readable medium.

By way of example, and not limitation, such computer-readable storage media can comprise RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transitory media, but are instead directed to non-transitory, tangible storage media. Disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media.

Instructions may be executed by one or more processors, such as one or more digital signal processors (DSPs), general purpose microprocessors, application specific integrated circuits (ASICs), field programmable logic arrays (FPGAs), or other equivalent integrated or discrete logic circuitry. Accordingly, the term “processor,” as used herein may refer to any of the foregoing structure or any other structure suitable for implementation of the techniques described herein. In addition, in some aspects, the functionality described herein may be provided within dedicated hardware and/or software modules configured for encoding and decoding, or incorporated in a combined codec. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a codec hardware unit or provided by a collection of interoperative hardware units, including one or more processors as described above, in conjunction with suitable software and/or firmware.

Various examples have been described. These and other examples are within the scope of the following claims.

What is claimed is:

1. A method of retrieving media data, the method comprising:
retrieving a manifest file indicating a plurality of network locations for at least a first segment of media data and a second segment of the media data, each network location among the plurality of network locations being hosted by a separate physical server device;
retrieving at least a first portion of the first segment from a first network location of the plurality of network locations;
retrieving at least a second portion of the second segment from a second network location of the plurality of network locations; and
providing the at least first portion of the first segment and the at least second portion of the second segment to a decoder.

2. The method of claim 1, wherein retrieving the at least first portion of the first segment comprises sending a first request for the first at least portion of the first segment to a first uniform resource location (URL), the method further comprising sending a second request for a third portion of the first segment to a second URL.

3. The method of claim 2, wherein the at least first portion comprises an application object including media data, and wherein the third portion comprises a repair object for repairing the application object in the event of loss of a portion of the application object according to forward error correction (FEC).

4. The method of claim 2, further comprising combining the first at least portion and the third portion using forward error correction (FEC) decoding.

5. The method of claim 2, wherein the manifest file includes source flow information for a media flow including the first at least portion of the first segment, the manifest file further including: an identifier for the source flow, an identifier of an object corresponding to the first at least portion of the first segment and included in the source flow, a transport object identifier (TOI) for the object, a size of the object, a content-type for the object representing a media type for the object, encoding information for the object, a message digest for the object, an associated uniform resource identifier (URI) for the object, a uniform resource locator (URL) for the object, and an availability start time indicating a time at which the object can be retrieved.

6. The method of claim 2, wherein the manifest file includes repair flow information for a repair flow including the third portion of the first segment, the manifest file further including: an identifier of a source flow corresponding to the repair flow, an identifier of an object of the source flow corresponding to the at least first portion of the first segment, an identifier of a repair object of the repair flow corresponding to the object of the source flow, forward error correction (FEC) object transmission information for the repair object including a FEC encoding identifier, data associating a transport session identifier (TSI) with a transport object identifier (TOI) for the repair object, a media type for the repair object, a number of symbols included in the repair object, a uniform resource locator (URL) for the repair object, and an availability start time indicating a time at which the repair object can be retrieved.

7. The method of claim 1, wherein the manifest file includes data indicating an expiration time at which the manifest file needs to be updated, the method further comprising updating the manifest file by the expiration time.

8. The method of claim 1, further comprising sending feedback packets for one or more application data units (ADUs) of media data of a media streaming session by which the first segment was received.

9. A device for retrieving media data, the device comprising:
a memory configured to store media data; and
a processing system including a decoder implemented in circuitry, the processing system being configured to:
retrieve a manifest file indicating a plurality of network locations for at least a first segment of media data and a second segment of the media data, each network location among the plurality of network locations being hosted by a separate physical server device;
retrieve at least a first portion of the first segment from a first network location of the plurality of network locations;
retrieve at least a second portion of the second segment from a second network location of the plurality of network locations; and
provide the at least first portion of the first segment and the at least second portion of the second segment to the decoder.

10. The device of claim 9, wherein to retrieve the at least first portion of the first segment, the processing system is configured to send a first request for the first at least portion of the first segment to a first uniform resource location (URL), the processing system being further configured to send a second request for a third portion of the first segment to a second URL.

11. The device of claim 10, wherein the at least first portion comprises an application object including media data, and wherein the third portion comprises a repair object for repairing the application object in the event of loss of a portion of the application object according to forward error correction (FEC).

12. The device of claim 10, wherein the manifest file includes source flow information for a media flow including the first at least portion of the first segment, the manifest file further including: an identifier for the source flow, an identifier of an object corresponding to the first at least portion of the first segment and included in the source flow, a transport object identifier (TOI) for the object, a size of the object, a content-type for the object representing a media type for the object, encoding information for the object, a message digest for the object, an associated uniform resource identifier (URI) for the object, a uniform resource locator (URL) for the object, and an availability start time indicating a time at which the object can be retrieved.

13. The device of claim 10, wherein the manifest file includes repair flow information for a repair flow including the third portion of the first segment, the manifest file further including: an identifier of a source flow corresponding to the repair flow, an identifier of an object of the source flow corresponding to the at least first portion of the first segment, an identifier of a repair object of the repair flow corresponding to the object of the source flow, forward error correction (FEC) object transmission information for the repair object including a FEC encoding identifier, data associating a transport session identifier (TSI) with a transport object identifier (TOI) for the repair object, a media type for the repair object, a number of symbols included in the repair object, a uniform resource locator (URL) for the repair object, and an availability start time indicating a time at which the repair object can be retrieved.

14. The device of claim 9, wherein the manifest file includes data indicating an expiration time at which the manifest file needs to be updated, and wherein the processing system is further configured to update the manifest file by the expiration time.

15. The device of claim 9, wherein the processing system is further configured to send feedback packets for one or more application data units (ADUs) of media data of a media streaming session by which the first segment was received.

16. A method of sending media data, the method comprising:
forward error correction (FEC) encoding at least a first portion of a first segment to form a first FEC encoded first portion of the first segment and at least a second portion of a second segment to form a second FEC encoded second portion of the second segment;
storing the first FEC encoded first portion to a first physical server device;
storing the second FEC encoded second portion to a second physical server device; and
forming a manifest file indicating that the first FEC encoded first portion is available from the first physical server device and that the second FEC encoded second portion is available from the second physical server device.

17. The method of claim 16, further comprising sending the manifest file to the first physical server device and the second physical server device.

18. The method of claim 16, wherein FEC encoding the first at least portion of the first segment includes forming an object for the first at least portion of the first segment and a repair object for a third portion of the first segment, the method further comprising storing the repair object to a third physical server device.

19. The method of claim 18, wherein the manifest file includes source flow information for a media flow including the first at least portion of the first segment, the manifest file further including: an identifier for the source flow, an identifier of an object corresponding to the first at least portion of the first segment and included in the source flow, a transport object identifier (TOI) for the object, a size of the object, a content-type for the object representing a media type for the object, encoding information for the object, a message digest for the object, an associated uniform resource identifier (URI) for the object, a uniform resource locator (URL) for the object, and an availability start time indicating a time at which the object can be retrieved.

20. The method of claim 18, wherein the manifest file includes repair flow information for a repair flow including the third portion of the first segment, the manifest file further including: an identifier of a source flow corresponding to the repair flow, an identifier of an object of the source flow corresponding to the at least first portion of the first segment, an identifier of a repair object of the repair flow corresponding to the object of the source flow, forward error correction (FEC) object transmission information for the repair object including a FEC encoding identifier, data associating a transport session identifier (TSI) with a transport object identifier (TOI) for the repair object, a media type for the repair object, a number of symbols included in the repair object, a uniform resource locator (URL) for the repair object, and an availability start time indicating a time at which the repair object can be retrieved.

21. The method of claim 16, wherein the manifest file includes data indicating an expiration time at which the manifest file needs to be updated.

22. The method of claim 16, further comprising receiving feedback packets from a client device for one or more application data units (ADUs) of media data of a media streaming session by which the first segment is sent to the client device.

23. A device for sending media data, the device comprising:
a memory configured to store media data; and
a processing system implemented in circuitry and configured to:
forward error correction (FEC) encode at least a first portion of a first segment to form a first FEC encoded first portion of the first segment and at least a second portion of a second segment to form a second FEC encoded second portion of the second segment;
store the first FEC encoded first portion to a first physical server device;
store the second FEC encoded second portion to a second physical server device; and
form a manifest file indicating that the first FEC encoded first portion is available from the first physical server device and that the second FEC encoded second portion is available from the second physical server device.

24. The device of claim 23, wherein the processing system is further configured to send the manifest file to the first physical server device and the second physical server device.

25. The device of claim 23, wherein to FEC encode the first at least portion of the first segment, the processing system is configured to form an object for the first at least portion of the first segment and a repair object for a third portion of the first segment, and wherein the processing system is further configured to store the repair object to a third physical server device.

26. The device of claim 25, wherein the manifest file includes source flow information for a media flow including the first at least portion of the first segment, the manifest file further including: an identifier for the source flow, an identifier of an object corresponding to the first at least portion of the first segment and included in the source flow, a transport object identifier (TOI) for the object, a size of the object, a content-type for the object representing a media type for the object, encoding information for the object, a message digest for the object, an associated uniform resource identifier (URI) for the object, a uniform resource locator (URL) for the object, and an availability start time indicating a time at which the object can be retrieved.

27. The device of claim 25, wherein the manifest file includes repair flow information for a repair flow including the third portion of the first segment, the manifest file further including: an identifier of a source flow corresponding to the repair flow, an identifier of an object of the source flow corresponding to the at least first portion of the first segment, an identifier of a repair object of the repair flow corresponding to the object of the source flow, forward error correction (FEC) object transmission information for the repair object including a FEC encoding identifier, data associating a transport session identifier (TSI) with a transport object identifier (TOI) for the repair object, a media type for the repair object, a number of symbols included in the repair object, a uniform resource locator (URL) for the repair object, and an availability start time indicating a time at which the repair object can be retrieved.

28. The device of claim 23, wherein the manifest file includes data indicating an expiration time at which the manifest file needs to be updated.

29. The method of claim 23, wherein the processing system is further configured to receive feedback packets from a client device for one or more application data units (ADUs) of media data of a media streaming session by which the first segment is sent to the client device.
